(19) United States
(12) Patent Application Publication
(10) Pub. No.: US 2007/0036934 A1
(43) Pub. Date: Feb. 15, 2007

(54) Process for producing optical information recording medium and intialization device

(75) Inventors: Takao Hashizume, Minato-ku (JP); Takashi Ohno, Minato-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Mitsubishi Kagaku Media Co., Ltd., Tokyo (JP)

(21) Appl. No.: 11/584,506

(22) Filed: Oct. 23, 2006

Related U.S. Application Data
(63) Continuation of application No. PCT/JP05/07650, filed on Apr. 21, 2005.

(30) Foreign Application Priority Data
Apr. 23, 2004 (JP) 2004-128538
May 19, 2004 (JP) 2004-149455

(51) Int. Cl. B32B 3/02

(52) U.S. Cl. 428/64.1

(57) ABSTRACT

To obtain an optical information recording medium in a favorable initially crystallized state, by carrying out initial crystallization at a high linear velocity (specifically at least about 25 m/s), i.e. at a linear velocity higher than the erasable linear velocity for the optical information recording medium. A process for producing an optical information recording medium having a phase-change type recording layer on a disk-shape substrate, which comprises a step of obtaining a recording medium having the recording layer formed thereon, and an initial crystallization step of initially crystallizing the recording layer by scanning the recording medium in the circumferential direction with a beam spot formed by irradiating the recording layer with a focused beam, wherein in the initial crystallization step, the linear velocity when the recording medium is scanned in the circumferential direction with the beam spot, is increased toward the outer circumferential portion of the recording medium, and the intensity of the focused beam is increased as the scanning linear velocity is increased, so that the entire initial crystallization area is initially crystallized.

### TECHNICAL FIELD

The present invention relates to a process for producing an optical information recording medium with high productivity and an initialization device capable of high speed initialization.

### BACKGROUND ART

A planar circular optical information recording medium (such as CD-RW or rewritable DVD; in this specification, the optical information recording medium will sometimes be referred to simply as an optical disk, a disk, a phase-change type disk, etc.) having a rewritable phase-change type recording layer is practically used at present. Rewriting of information is carried out on such an optical information recording medium by reversible phase-change of the recording layer between a crystalline state and an amorphous state. Specifically, it is common to employ a method to let the crystalline state of the recording layer in a non-recorded/erased state and to form amorphous recording marks on the recording layer to record information. The amorphous recording marks are erased when they are completely recrystallized. Therefore, the length of time required to completely recrystallize the amorphous recording marks determines the upper limit of the erasable linear velocity and thus the upper limit of the rewritable recording linear velocity.

In recent years, along with a demand for an improvement in the recording linear velocity, a recording medium with an increased upper limit of the erasable linear velocity has been developed. Specifically, with respect to CD-RW, an optical information recording medium rewritable at a linear velocity of from 24× to 32× speed has been realized or is under development. Further, with respect to rewritable DVD, an optical information recording medium rewritable at a linear velocity of 4× or higher speed has been realized or is under development.

In production of such optical information recording media, it is usually required to carry out an initialization step of initializing (letting in a non-recorded state) a recording medium obtained by forming a recording layer (in the present invention, a medium having a recording layer formed on a substrate will be referred to as a recording medium, and as compared with this recording medium, a medium subjected to after-mentioned initialization step will be referred to as an optical information recording medium). Specifically, as the recording layer after formation is usually in an amorphous state, it is required to bring the recording layer in a crystalline state in the initialization step (such initialization will sometimes be referred to as initial crystallization).

The initial crystallization is carried out so that the linear velocity at all the radial positions in the recording medium is constant so as to securely crystallize the recording medium (Patent Documents 1 and 2). Specifically, the recording medium is irradiated with a laser beam for initial crystallization in a state where the recording medium is rotated so that the linear velocity is constant at all the radial positions (constant linear velocity, CLV system). A beam spot formed on the recording medium by this laser beam is relatively moved in the radial direction of the recording medium to crystallize the recording layer.

Patent Document 1: JP-A-2001-236695

Patent Document 2: JP-A-2003-272172

### DISCLOSURE OF THE INVENTION

Problems that the Invention is to Solve

However, in the above conventional initial crystallization method, control of the high rotational speed of an initialization device and the corresponding control of the focus servo tend to be difficult, and a great burden will be imposed on the device in some cases.

That is, in the above conventional initial crystallization method, it is necessary that a planar circular recording medium is rotated at a constant linear velocity from the innermost circumference to the outermost circumference of the recording layer (CLV system). Therefore, the linear velocity determined by the maximum rotational speed at the innermost circumference of the initialization area has been the maximum linear velocity of the device under initialization conditions. However, according to studies by the present inventors, it has been found that with respect to an optical information recording medium on which rewriting is carried out at a high recording linear velocity, the performance of the medium can be improved in some cases by employing initialization conditions at a higher linear velocity (specifically about 25 m/s or higher).

The above initial crystallization conditions mean that initialization may be carried out at a linear velocity higher than the erasable linear velocity of the optical information recording medium in some cases. And when it is attempted to obtain favorable recording characteristics employing such initial crystallization conditions, a great burden or the like will be imposed on the initialization device in some cases. This is because if it is attempted to increase the linear velocity by conventional CLV system in these cases, problems will arise such that mechanical durability of the disk tends to be insufficient, the initialization device tends to be large, or the cost of the initialization device tends to increase.

Namely, in view of the mechanical durability of the disk, the following problem will arise. For example, for CD and DVD, a polycarbonate resin is commonly used for the substrate. From the limit of the mechanical strength of the polycarbonate resin substrate, the upper limit of the rotational speed at the time of recording for CD or DVD is usually at a level of 10,000 rpm (linear velocity at the innermost circumference in the recording area of the disk: 20 to 25 m/s). That is, initialization on the entire disk at a high linear velocity of 25 m/s or higher will be difficult due to the limit of the mechanical strength of the polycarbonate resin substrate.

On the other hand, a recording device (such as a drive for CD-RW or DVD) for carrying out recording/erasing/retrieving on an optical information recording medium is designed to carry out rewriting at a higher linear velocity at an outer circumferential portion, by means of a so-called P-CAV (partial angular velocity) or ZCLV (zoned CLV). Employment of such a means means a change in the recording (erasing) linear velocity at the radial direction of the optical information recording medium. Therefore, an optical information recording medium may be designed so as to obtain optimum recording characteristics relative to different recording (erasing) linear velocities in the radial direction. However, a practical optical information recording medium is not designed so as to intentionally change the medium characteristics in the radial direction but is designed so that rewriting is possible (amorphous marks can be erased) on the entire recording area at the highest rewriting linear velocity (practically 20 to 25 m/s or higher) at the outermost circumferential portion. Therefore, in production of such an optical information recording medium, in a case where the recording medium is initially crystallized, the entire surface of the recording medium has to be initialized by irradiation with a laser beam at a high linear velocity.

Accordingly, an initialization method which can avoid the problem of the upper limit of the initialization linear velocity in the CLV system due to e.g. the limit of the rotational speed of the initialization device, and a process for producing an optical information recording medium and an initialization device, have been desired.

Means of Solving the Problems

Under these circumstances, the present inventors have found an initialization method wherein the relative linear velocity between the laser beam spot for initialization and the recording medium is increased toward the outer circumferential portion, which is different from the conventional initialization method at a constant linear velocity. More specifically, the present inventors have found an initialization method wherein the linear velocity is increased toward the outer circumferential portion of a recording medium, employing CAV (constant angular velocity) system in which the rotational speed is constant over the entire recording area and P-CAV (partial CAV) system. The present inventors have further found an initialization method wherein the linear velocity is increased toward the outer circumferential portion of a recording medium by employing ZCLV (zoned CLV) system in which the recording medium is divided into a plurality of zones, and the linear velocity is constant in each zone, while the rotational speed is constant at the innermost circumferential portion of the respective zones. They have further found that no burden will be imposed on an initialization device or no complicated control will be required by employing such initialization methods.

Namely, the present invention resides in a process for producing an optical information recording medium having a phase-change type recording layer on a disk-shape substrate, which comprises a step of obtaining a recording medium having the recording layer formed thereon, and an initial crystallization step for initially crystallizing the recording layer by scanning the recording medium in the circumferential direction with a beam spot formed by irradiating the recording layer with a focused beam, wherein in the initial crystallization step, the scanning linear velocity when the recording medium is scanned in the circumferential direction with the beam spot, is increased toward the outer circumferential portion, and the intensity of the focused beam is increased as the scanning linear velocity is increased, so that the entire initial crystallization area is initially crystallized.

Further, the present invention resides in an initialization device for initially crystallizing a phase-change type recording layer of a recording medium having the recording layer formed on a disk-shape substrate, characterized in that it is equipped with a controller to scan the recording medium in the circumferential direction with a beam spot formed by irradiating the recording layer with a focused beam, and the controller is constituted in such a manner that the linear velocity when the recording medium is scanned in the circumferential direction with the beam spot is increased toward the outer circumferential portion, and the intensity of the focused beam is increased as the scanning linear velocity is increased, so that the entire initial crystallization area is initially crystallized.

According to the present invention, particularly when applied to an optical information recording medium having a phase-change type recording material for high speed recording (such as CD-RW on which recording is carried out at a linear velocity of at least 24× speed or rewritable DVD on which recording is carried out at a linear velocity of from 6× to 8× speed or higher), an optical information recording medium having a favorable initialized state can be obtained.

Effects of the Invention

The present invention is advantageous in that an optical information recording medium having a favorable initially crystallized state can be obtained by an initial crystallization method which is different from a conventional one. That is, initial crystallization will be carried out at a high linear velocity (for example, a linear velocity higher than the erasable linear velocity for an optical information recording medium, such as about 25 m/s or higher). Accordingly, favorable recording characteristics will be obtained, and it is possible to improve the medium performance. Further, the initial crystallization time will be remarkably shortened, and it is thereby possible to improve productivity of optical information recording media.

Particularly, favorable recording characteristics will be obtained when an optical information recording medium on which rewriting is carried out at a high recording linear velocity is initially crystallized. In such a case, no problems will arise such that mechanical durability of the disk tends to be insufficient, the initialization device tends to be large, or the cost of the initialization device tends to increase.

### BRIEF DESCRIPTION OF THE DRAWINGS

FIG. 1 is a view schematically illustrating a beam spot of a laser beam (focused beam) to be used in an initialization step in a process for producing an optical information recording medium according to one embodiment of the present invention.

FIGS. 2(a) to 2(e) are views schematically illustrating the relation between the radial position of a recording medium and the scanning linear velocity of a laser beam (focused beam) in an initialization step in a process for producing an optical information recording medium according to one embodiment of the present invention.

FIGS. 3(a) to 3(d) are views schematically illustrating the relation between the scanning linear velocity and the initialize power of a laser beam (focused beam) in an initialization step in a process for producing an optical information recording medium according to one embodiment of the present invention.

FIGS. 4 are views schematically illustrating the relation between the radial position of a recording medium and the scanning linear velocity of a laser beam (focused beam) in an initialization step in a process for producing an optical information recording medium according to one embodiment of the present invention.

FIGS. 5 are views schematically illustrating a recording medium to be initially crystallized in an initialization step in a process for producing an optical information recording medium according to one embodiment of the present invention, and FIG. 5(a) is a perspective view, and FIG. 5(b) is a cross section at the A-A′ arrow of FIG. 5(a).

FIG. 6 is a view schematically illustrating the relation between the rotational speed R0 and J2/J10 in an initialization step in a process for producing an optical information recording medium according to one embodiment of the present invention.

FIGS. 7(a) and 7(b) are views schematically illustrating an example for setting the initialize laser intensity in zones in an initialization step in a process for producing an optical information recording medium according to one embodiment of the present invention.

FIGS. 8 are views schematically illustrating a recording medium to be initially crystallized in an initialization step in a process for producing an optical information recording medium according to one embodiment of the present invention, and FIG. 8(a) is a perspective view, and FIG. 8(b) is a cross section at the A-A′ arrow of FIG. 8(a).

FIG. 9 is a cross section schematically illustrating a recording medium to be initially crystallized in an initialization step in a process for producing an optical information recording medium according to one embodiment of the present invention.

FIG. 10 is a cross section schematically illustrating a recording medium to be initially crystallized in an initialization step in a process for producing an optical information recording medium according to one embodiment of the present invention.

FIGS. 11(a) and 11(b) are views schematically illustrating a method of setting the initialize laser intensity in an initialization step in a process for producing an optical information recording medium according to one embodiment of the present invention.

FIGS. 12(a) and 12(b) are views schematically illustrating the relation between the radial position of a recording medium and the scanning linear velocity in an initialization step in a process for producing an optical information recording medium according to one embodiment of the present invention.

FIG. 13 is a cross section schematically illustrating a recording medium to be initially crystallized in an initialization step in a process for producing an optical information recording medium according to one embodiment of the present invention.

FIGS. 14 is a view schematically illustrating a method of setting the initialize laser intensity in an initialization step in a process for producing an optical information recording medium according to one embodiment of the present invention.

FIGS. 15 is a view schematically illustrating a method of setting the initialize laser intensity in an initialization step in a process for producing an optical information recording medium according to one embodiment of the present invention.

FIG. 16 is a view schematically illustrating the structure of an initialization device according to one embodiment of the present invention.

FIG. 17 is a view illustrating an example for setting the initialize laser intensity in one example of the present invention.

FIG. 18 is a view illustrating an example for setting the initialize laser intensity in one example of the present invention.

FIG. 19 is a view illustrating an example for setting the initialize laser intensity in one example of the present invention.

FIG. 20 is a view illustrating an example for setting the initialize laser intensity in one example of the present invention.

FIG. 21 is a view illustrating an example for setting the initialize laser intensity in one example of the present invention.

FIG. 22 is a view illustrating an example for setting the initialize laser intensity in one example of the present invention.

FIG. 23 is a view illustrating an example for setting the initialize laser intensity in one example of the present invention.

FIG. 24 is a view illustrating an example for setting the initialize laser intensity in one example of the present invention.

FIG. 25 is a view illustrating an example for setting the initialize laser intensity in one example of the present invention.

FIG. 26 is a view illustrating the relation between the radial direction of a recording medium and the initialization speed of a recording medium in one example of the present invention.

FIG. 27 is a view illustrating optical recording characteristics at the radial position of an optical information recording medium in one example of the present invention.

### DESCRIPTION OF SYMBOLS

1: Initialization device

2: Recording medium

3: Spindle motor

4: Motor driver

S: Initialize head (laser head)

6: Initialize head driver

7: Controller

### BEST MODE FOR CARRYING OUT THE INVENTION

Now, embodiments of the present invention will be described with reference to drawings. However, the present invention is not limited to the following embodiments, and various modifications are possible within a range of the scope of the invention.

[1] Structure of Optical Information Recording Medium and its Production Process (Step of Obtaining Recording Medium Having Recording Layer Formed Thereon)

As a specific example of a recording medium which has a phase-change type recording layer, a recording medium having a layer structure comprising a disk-shape substrate, and a first protective layer (lower protective layer), a recording layer (phase-change type recording layer), a second protective layer (upper protective layer), a reflective layer and a protective coating layer formed in this order on the substrate, and on which recording and retrieving of signals are carried out by irradiation with a laser beam through the substrate (it is used as a substrate face incidence optical information recording medium after initialization), may be mentioned.

Further, as another specific example of an optical information recording medium having a phase-change type recording layer, a recording medium which has a layer structure comprising a disk-shape substrate, and a reflective layer, a second protective layer (lower protective layer), a recording layer (phase-change type recording layer), a first protective layer (upper protective layer) and a protective coating layer formed in this order on the substrate, and on which recording and retrieving of signals are carried out by irradiation with a laser beam through the upper protective layer (it is used as a film face incidence optical information recording medium after initialization) may be mentioned. On the film face incidence optical information recording medium, recording and retrieving of signals are carried out by irradiation with a laser beam from the upper protective layer side, not through the substrate. Therefore, it is possible to bring the recording layer and the optical head close with a distance of at most several hundred μm. Further, by use of an objective lens with an aperture of at least 0.7, the recording density of the medium can be increased.

Here, the layer structures for the substrate face incidence optical information recording medium and the film face incidence optical information recording medium are merely examples. For example, in each of the substrate face incidence optical information recording medium and the film face incidence optical information recording medium, an interlayer may be provided between the protective layer and the reflective layer. In the film face incidence optical information recording medium, a primer layer may be provided between the substrate and the reflective layer.

Preferred in the present invention is use of a recording medium employing for the recording layer a recording material with a high crystallization rate, by which a high data transfer rate is achieved.

Now, each of the substrate, the recording layer and other layers (protective layer, reflective layer and protective coating layer) will be described below.

(1) Substrate

For the substrate, a resin such as a polycarbonate, an acrylic resin or a polyolefin, or glass may, for example, be used. Among them, a polycarbonate resin has been actually used most widely for e.g. CD-ROM and is available at a low cost, and is thereby most preferred. The thickness of the substrate is usually at least 0.1 mm, preferably at least 0.3 mm, and usually at most 20 mm, preferably at most 15 mm. It is usually from about 0.6 mm to about 1.2 mm. For the substrate face incidence optical information recording medium, the substrate has to transmit a laser beam and thereby has to be transparent to the laser beam. On the other hand, for the film face incidence optical information recording medium, the substrate is not necessarily transparent.

On the substrate, usually concentric or spiral tracks (grooves) are formed. The shape of the substrate is a disk-shape, and the “disk-shape” means a rotatable shape and usually means a planar disk shape, but is not limited to a planar disk shape. For example, for the attractive design of the optical information recording medium, it may have a planar elliptic shape or a planar rectangular shape.

(2) Recording Layer

For the recording layer, for example, a series of compounds such as GeSbTe, InSbTe, AgSbTe and AgInSbTe is selected as a material capable of repeated recording. Among them, a composition containing a pseud binary alloy of Sb₂Te₃ and GeTe as the main component, more specifically either a composition of {(Sb₂Te₃)_{1-α}(GeTe)_{α}}_{1-β}Sb_{β} (wherein 0.2≦α≦0.9, 0≦β≦0.1) or a composition containing Sb as the main component is employed in many cases.

The initialization method (initialization method wherein the scanning linear velocity is increased as the beam spot for initialization moves toward the outer circumference of the recording medium) to be employed in the present invention is applied preferably to a recording medium employing for the recording layer a material with a high crystallization rate. In order to increase the crystallization rate, it is more preferred to employ a composition containing Sb as the main component for the recording layer. In the present invention, “containing Sb as the main component” means that the Sb content is at least 50 atomic % based on the entire recording layer. The reason for containing Sb as the main component is that amorphous Sb can be crystallized at a very high rate, whereby amorphous marks can be crystallized in a short time. Therefore, amorphous recording marks will easily be erased. In this view, the Sb content is preferably at least 60 atomic %, more preferably at least 70 atomic %. However, on the other hand, it is preferred to use an additional element to accelerate formation of an amorphous state and to increase the stability of the amorphous state with time, together with Sb. In order to accelerate formation of an amorphous state of the recording layer and to increase stability of the amorphous state with time, the content of the additional element is usually at least 1 atomic %, preferably at least 5 atomic %, more preferably at least 10 atomic %, and usually at most 30 atomic %.

The above additional element to accelerate formation of an amorphous state and to increase stability of the amorphous state with time also has an effect of increasing the crystallization temperature. Such an additional element may, for example, be Ge, Te, In, Ga, Sn, Pb, Si, Ag, Cu, Au, a rare earth element, Ta, Nb, V, Hf, Zr, W, Mo, Cu, Cr, Co, nitrogen, oxygen or Se. Among these additional elements, preferred is at least one member selected from the group consisting of Ge, Te, In, Ga and Sn with a view to accelerating formation of an amorphous state, improving stability of the amorphous state with time and increasing the crystallization temperature. Particularly preferred is use of Ge and/or Te or use of at least one of In, Ga and Sn.

As described above, for the recording layer of the recording medium to be used for the initialization method, it is particularly preferred to use Sb in combination with Ge and/or Te as a material of the recording layer, for crystallization at a high rate, formation of an amorphous state and improvement in stability of the amorphous state with time. In a case where Ge and/or Te is added to Sb, the content of each of Ge and Te in the recording layer is preferably at least 1 atomic % and at most 30 atomic %. Namely, it is preferred that each of Ge and Te is contained in an amount of at least 1 atomic % and at most 30 atomic % by itself. However, in a case where the main component of the recording layer is Sb, the Sb content is at least 50 atomic %, and thus if Ge and Te are incorporated in the recording layer together with Sb, the total amount of Ge and Te is less than 50 atomic %.

The content of each of Ge and Te in the recording layer is more preferably at least 3 atomic %, furthermore preferably at least 5 atomic %. Within this range, the effect of stabilizing amorphous marks will be sufficiently obtained. On the other hand, the content of each of Ge and Te in the recording layer is more preferably at most 20 atomic %, furthermore preferably at most 15 atomic %. Within this range, such a tendency can be suppressed that the amorphous state is too stable and the crystallization becomes slow. Further, within the above range, noise by light scattering at the crystal grain boundary can be suppressed.

The composition containing Sb as the main component can be classified into two types depending upon the amount of Te contained in the recording layer. One is a composition containing Te in an amount of at least 10 atomic % and the other is a composition containing Te in an amount less than 10 atomic % (including a composition containing no Te).

One composition is such that the recording layer material, while containing Te in an amount of at least about 10 atomic %, contains as the main component an alloy containing Sb in an excess amount over the Sb₇₀Te₃₀ eutectic composition. The recording layer material will be referred to as an SbTe eutectic system. Here, Sb/Te is preferably at least 3, more preferably at least 4.

As the other composition containing Sb as the main component, classified depending upon the amount of Te contained in the recording layer, the following composition may me mentioned. The recording layer, while containing Sb as the main component, contains Te in an amount less than 10 atomic % and further contains Ge as an essential component. As a specific example of the composition of the recording layer, an alloy containing as the main component an eutectic alloy having a composition in the vicinity of Sb₉₀Ge₁₀ and containing Te in an amount less than 10 atomic % (in this specification, this alloy will be referred to as an SbGe eutectic system) may be preferably mentioned.

The composition with a Te addition amount less than 10 atomic % has characteristics as an SbGe eutectic system not as an SbGe eutectic system. With respect to the SbGe eutectic system alloy, the crystalline state tends to be in a single phase since the crystal grain size in a polycrystalline state after initial crystallization is relatively fine even if the Ge content is high at a level of 10 atomic %, and the noise tends to be small. In the SbGe eutectic system alloy, Te is merely additionally added and is not an essential element.

With the SbGe eutectic system alloy, the crystallization rate can be increased by relatively increasing the Sb/Ge ratio, and it is possible to recrystallize amorphous marks by recrystallization.

In a case where a composition containing Sb as the main component is employed for the recording layer, the crystalline state is in a non-recorded/erased state and recording is carried out by formation of amorphous marks, it is very important to improve the cooling efficiency. The reason is as follows.

Namely, the crystallization rate of the recording layer containing Sb as the main component such as the SbTe eutectic system or the SbGe eutectic system is increased by increasing the crystal growth rate, not the crystal nucleus formation rate, by adding Sb in an excess amount over the composition in the vicinity of the Sb₇₀Te₃₀ eutectic point or the Sb₉₀Ge₁₀ eutectic point to cope with high speed recording. Therefore, for such a recording layer, it is preferred to increase the cooling rate of the recording layer thereby to inhibit a change of amorphous marks (amorphous marks being smaller than a desired size) by recrystallization. Accordingly, it is important to rapidly cool the recording layer so as to securely form amorphous marks after the recording layer is melted, and it is very important to improve the cooling efficiency of the recording layer. Therefore, in the case of the above recording layer composition, it is particularly preferred to employ Ag or an Ag alloy with high heat dissipation properties for the reflective layer. The initialization method of the present invention is meaningful to such a recording medium having a recording layer of which the cooling efficiency at the time of recording has to be increased.

The recording layer employing the above composition containing Sb as the main component such as the SbTe eutectic system or the SbGe eutectic system, particularly preferably further contains at least one of In, Ga and Sn, in a content of each of In, Ga and Sn of at least 1 atomic % and at most 30 atomic % in the recording layer.

Now, specific examples of the composition containing Sb as the main component will be further described below.

As the composition containing Sb as the main component, first, an SbTe eutectic system composition containing as the main component a (SbₓTe₁₋ₓ)_{1-y}M_{y} (provided that 0.6≦x≦0.9, 0≦y≦0.3 and M is at least one member selected from Ge, Ag, In, Ga, Zn, Sn, Si, Cu, Au, Pd, Pt, Pb, Cr, Co, O, S, Se, V, Nb and Ta) alloy may be preferably mentioned. The above compositional formula represents the composition by the atomicity ratio. Therefore, x=0 for example means 60 atomic %.

In the above (SbₓTe₁₋ₓ)_{1-y}M_{y} composition, it is particularly preferred to use as M Ge, Ga, Ag or In alone or in combination, from the viewpoint of the recording characteristics such as overwriting characteristics.

In the above (SbₓTe₁₋ₓ)_{1-y}M_{y} composition, x is usually at least 0.6, preferably at least 0.7, more preferably at least 0.75, and usually at most 0.9. Further, y is usually at least 0, preferably at least 0.01, more preferably at least 0.03, and usually at most 0.3, preferably at most 0.2, more preferably at most 0.1. When x and y are within the above ranges, a recording layer capable of high speed recording will be obtained.

A composition employing Ge as M in the above (SbₓTe₁₋ₓ)_{1-y}M_{y} composition will be described in further detail below. As this composition, it is preferred to use a composition represented by Ge_{y}(SbₓTe₁₋ₓ)_{1-y} (wherein 0.01≦y≦0.06 and 0.7≦x≦0.9) which comprises as a host an Sb₇₀Te₃₀ alloy having the Sb₇₀Te₃₀ eutectic point composition as a base and containing Sb in a large excess amount, and which further contains Ge. The Ge amount, as the value y in Ge_{y}(SbₓTe₁₋ₓ)_{1-y}, is preferably at least 0.01, particularly preferably at least 0.02. On the other hand, in the SbTe eutectic composition having such a high Sb content, it is estimated that crystal grains differing in optical constant are mixed in the recording layer since if the Ge amount is too large, the SbGe alloy may precipitate in addition to an intermetallic compound of GeTe or GeSbTe system. This mixture of the crystal grains may increase the noise of the recording layer and thereby increase the jitter. Further, the effect of increasing the stability of amorphous marks with time will no longer improve even when Ge is added in a too large amount. Therefore, the content of Ge, as the value y in Ge_{y}(SbₓTe₁₋ₓ)_{1-y}, is usually at most 0.06, preferably at most 0.05, more preferably at most 0.04.

The GeSbTe eutectic system composition particularly preferably further contains In, Ga or Sn. Namely, it is particularly preferred to employ a composition represented by M1_{z}Ge_{y}(SbₓTe₁₋ₓ)_{1-y-z} (0.01≦z≦0.4, 0.01≦y≦0.06, 0.7≦x≦0.9, and M1 is at least one element selected from the group consisting of In, Ga and Sn). The characteristics will be further improved by the above Ml being at least one member of a series of elements represented by In, Ga and Sn. The elements In, Ga and Sn also have effects of increasing the optical contrast between the crystalline state and the amorphous state and decreasing the jitter. z representing the M1 content is usually at least 0.01, preferably at least 0.02, more preferably at least 0.05, and usually at most 0.15, preferably at most 0.1. Within this range, the above effects of improving the characteristics will be favorably obtained.

With respect to the above GeSbTe alloy containing In or Sn, as another preferred composition, Geₓ(In_{w}Sn_{1-w})_{y}Te_{z}Sb_{1-x-y-z} may be mentioned. The Sb content is higher than any of the Ge content, the In content, the Sn content and the Te content, and x, y, z and w representing the atomicity ratio satisfy the following (i) to (vi).
0≦x≦0.3 (i)
0.07≦y−z (ii)
w×y−z≦0.1 (iii)
0<z (iv)
(1−w)×y≦0.35 (v)
0.35≦1−x−y−z (vi)

With the above recording layer composition, overwriting will be favorably carried out at a linear velocity of at least 20 m/s. Now, the relation between the content of each element and the characteristics in the above recording layer composition will be described in detail below.

(Sb, Formula (vi))

The Sb content is higher than any of the Ge content, the In content, the Sn content and the Te content. Namely, the recording material of the present invention is mainly composed of Sb. Specifically, the Sb content is at least 35 atomic % and is higher than any of contents of the other elements. In order to obtain sufficient effects of the present invention, the Sb content is preferably at least 40 atomic %, more preferably at least 45 atomic %.

(Sn, Formulae (ii) and (v))

The influence of the Sn content over the reflectivity of the crystalline state and the difference (signal amplitude) in the reflectivity between the crystal state and the amorphous state, is substantially equal to the influence of the In content over the reflectivity of the crystalline state and the difference (signal amplitude) in the reflectivity between the crystalline state and the amorphous state. Therefore, one of Sn and In is incorporated in the above recording layer composition. The reflectivity of the crystalline state and the signal amplitude can be increased by increasing the total of the Sn content and the In content than the Te amount within a certain amount. On the other hand, if the Te content is high, the reflectivity of the crystalline state and the signal amplitude tend to decrease. Accordingly, in order to obtain desired reflectivity of the crystalline state and signal amplitude, it is important to control the relation between the Sn and/or In content and the Te content.

Accordingly, the value (y−z) in the above formula is at least 0.07, preferably at least 0.1, more preferably at least 0.13, particularly preferably at least 0.15. The optimum power tends to be small as the value y is larger, such being favorable.

Further, the jitter characteristics tend to deteriorate if the Sn amount is too large. Therefore, the value (1−w)xy in the above formula is at most 0.35, preferably at most 0.3. Therefore, in a case where Te is contained in a large amount, the total of the In content and the Sn content has to be increased with a view to controlling the signal amplitude. On the other hand, considering the jitter characteristics, the Sn amount cannot be increased so much, and accordingly, it is preferred to incorporate In in addition to Sn, when the Te content is high. Specifically, in a case where the Te content is so high that the decrease in the reflectivity of the crystalline state or the signal amplitude by Te cannot be suppressed unless Sn is incorporated in an amount exceeding 35 atomic %, In may be incorporated.

(In, Formula (iii))

By using In, the reflectivity of the crystalline state and the difference (signal amplitude) in the reflectivity between the crystalline state and the amorphous state can be increased. Accordingly, it is preferred to employ In as an element to be incorporated in the recording layer.

By using In, such an advantage can be obtained that the influence over the jitter characteristics can be reduced as compared with Sn, in addition to the increase in the reflectivity of the crystalline state and the difference (signal amplitude) in the reflectivity between the crystalline state and the amorphous state. It is estimated that In has a function to decrease the crystal grain boundary noise as compared with Sn and Te. On the other hand, In will cause a decrease in the reflectivity in a long-term storage, which is considered to be attributable to the quasi-stable crystalline state. On the contrary, Te tends to suppress the decrease in the reflectivity in long-term storage. Accordingly, with a view to suppressing the decrease in the reflectivity of an optical information recording medium in the long-term storage, it is important that the In content and the Te content are in a predetermined relation. Namely, the decrease in the reflectivity in the long-term storage can be suppressed by the value (In content—Te content) being within a predetermined range in the above formula. Specifically, the decreasing rate of the reflectivity in the long-term storage will be low when the value w×y−z in the above formula is small, and thus the w×y−z is preferably at most 0.1, more preferably at most 0.05, furthermore preferably at most 0. Here, w×y−z=0 means that the In content is equal to the Te content. Accordingly, it is more preferred in the present invention that the In content is the same as the Te content or the In content is lower than the Te content.

In cannot be contained in an excess amount over Te if it is desired to reduce the decrease in the reflectivity in the long-term storage as far as possible. Therefore, it is preferred to incorporate Sn in addition to In in the above recording layer composition so as to satisfy the above relational expression 0.07≦y−z. Specifically, when w×y−z<0.07, 0.07≦y−z cannot be satisfied unless Sn is incorporated in addition to In. Further, it is preferred to incorporate both In and Sn also from such a viewpoint that a crystallization rate suitable for high speed recording is less likely to be obtained if the In and Te contents are increased without incorporating Sn. Namely, it is preferred that 0<w<1.

Here, if the In amount is excessively large, the signal quality tends to deteriorate in the long-term storage of the optical information recording medium. Further, if the In amount is increased without incorporating Sn, a stable crystalline layer with a low reflectivity which is observed in the In-Sb system appears in some cases. Therefore, the In content i.e. the value wxy is preferably at most 0.35.

(Te, Formula (iv))

Te is contained in the above recording layer composition. Te can improve repeated recording durability. Therefore, the Te content is preferably high to a certain extent, but as described above, the relation of In and/or Sn with Te and the relation between In and Te must be controlled within predetermined ranges. Specifically, z representing the Te content in the above formula is 0<z, preferably 0.01≦z, more preferably 0.05≦z, furthermore preferably 0.08≦z, particularly preferably 0.1≦z, most preferably 0.1<z.

z representing the Te content is usually less than 0.29, which is necessarily determined by other relational expressions defining the above formula. As described above, the In and Te contents are preferably high to a certain extent, and particularly Te has a function to lower the crystallization rate. Thus, in order to obtain the crystallization rate suitable for high speed recording, z representing the Te content is preferably at most 0.25, more preferably at most 0.20.

(Ge, Formula (i))

Ge may be used so as to adjust the crystallization rate. Namely, Ge is not closely related to characteristics such as the reflectivity, the signal amplitude (the difference in the reflectivity between the crystalline state and the amorphous state) and a decrease in the reflectivity in the long-term storage of a medium. Therefore, Ge can be used so as to obtain a crystallization rate suitable for the recording conditions to be employed. Since the crystallization rate becomes low as the Ge amount increases, it is possible to adjust the crystallization rate by lowering the Ge content for an optical information recording medium for high speed recording for example. However, the crystallization rate is also related to contents of other elements, and the crystallization rate tends to be high when the Sn amount is large, and the crystallization rate tends to be low when the In or Te amount is large. Accordingly, it is preferred to determine the proportion of contents of the elements other than Ge considering the above-described various characteristics and then to adjust the Ge content thereby to adjust the crystallization rate depending upon the recording conditions. Since the crystallization rate becomes too low if the Ge content is too high, x in the above formula is at most 0.3, preferably at most 0.25, more preferably at most 0.2. With respect to the influence of the content over the crystallization rate, Ge and Te have particularly significant influence.

Further, if the Ge content is high, when the recorded amorphous marks are stored for a long term, the amorphous marks are less likely to be crystallized as compared with immediately after the recording before the storage. If this phenomenon is remarkable, the signal quality of the overwritten recording signals will be insufficient when overwriting is carried out after the recorded optical information recording medium has been stored for a long term. Namely, as the old marks after the long-term storage are not sufficiently erased, signal quality of the new recording marks is deteriorated. This phenomenon that the amorphous marks are less likely to be crystallized is problematic only at first recording after the long-term storage, and amorphous marks newly recorded after the long-term storage have a normal crystallization rate. At any rate, this phenomenon will be reduced by decreasing the Ge content. In this view, the Ge content is preferably low, and the value x in the above formula is particularly preferably at most 0.1, most preferably at most 0.07.

As described above, Te and In have an effect to lower the crystallization rate, and thus when it is desired to lower the crystallization rate, in order to obtain the same crystallization rate, the Ge content can be reduced when the Te or In content is high. In this view, the Te content i.e. the value z is preferably at least 0.05, more preferably at least 0.08, most preferably at least 0.1. Further, in such a case, the In content i.e. the value w×y is preferably at least 0.05, more preferably at least 0.08. Further, as mentioned above, in a case where the Te content is high, it is preferred that both In and Sn are contained. Namely, the most preferred composition contains all of Ge, In, Sb, Sn and Te.

On the other hand, if the Ge content is too low, the storage stability of amorphous marks tends to be deteriorated, and the amorphous marks tend to be crystallized in the long-term storage. The storage stability of the amorphous marks tends to be improved by increasing the In amount, but the influence of Ge tends to be stronger. On the other hand, the storage stability of amorphous marks is relatively favorable in some cases due to influences of other elements, even when the Ge content is zero. Accordingly, the value x in the above formula is at least 0, preferably larger than 0, more preferably at least 0.01, furthermore preferably at least 0.02.

In the above GeSbTe eutectic system composition, an element which can be incorporated in addition to In, Ga and Sn may be nitrogen, oxygen or sulfur. These elements have effects of preventing segregation in repeated overwriting and finely adjusting optical characteristics. The content of nitrogen, oxygen and sulfur is preferably at most 5 atomic % relative to the total amount of Sb, Te and Ge.

Further, Cu, Zr, Hf, V, Nb, Ta, Cr or Co may be incorporated in the above GeSbTe eutectic system composition. These elements have effects of increasing the crystallization temperature and further improving the stability with time without decreasing the crystal growth rate by addition in a very small amount. However, if the amount of these elements is too large, segregation of a specific substance with time or segregation by repeated overwriting is likely to occur, and the addition amount is preferably at most 5 atomic %, particularly preferably at most 3 atomic %. The segregation may change the stability of the initial amorphous state of the recording layer, the recrystallization rate, etc. and deteriorate the overwriting characteristics in some cases.

On the other hand, the SbGe eutectic system composition which is a composition containing Sb as the main component, may be a composition containing as the main component a TeSbGe system having Te added to the SbGe eutectic system, or a composition containing as the main component an InGeSb system, GaGeSb system or SnGeSb system ternary alloy having In, Ga or Sn added to the SbGe eutectic system. By adding Te, In, Ga or Sn to the SbGe eutectic system alloy, the effect of increasing the difference in optical characteristics between the crystalline state and the amorphous state will be remarkable, and addition of Sn is particularly preferred.

As a preferred composition of such an SbGe eutectic system alloy, Te_{γ}M2_{δ}(Ge_{∈}Sb_{1-∈})_{1-δ-γ} (wherein 0.01≦∈≦0.3, 0≦δ≦0.3, 0≦γ<0.1, 2≦δ/γ, 0<δ+γ≦0.4, and M2 is at least one member selected from the group consisting of In, Ga and Sn). By adding In, Ga or Sn to the SbGe eutectic system alloy, the effect of increasing the difference in optical characteristics between the crystalline state and the amorphous state will be remarkable.

By using In or Ga as the element M2, the jitter at a very high speed recording will be improved, and the optical contrast can be increased. Therefore, δ representing the content of In and/or Ga is usually at least 0, preferably at least 0.01, more preferably at least 0.05. However, if the In or Ga amount is excessively large, another InSb system or Ga-Sb system crystalline phase having a very low reflectivity may be formed in addition to the crystalline phase to be used for an erased state in some cases. Accordingly, δ is usually at most 0.3, preferably at most 0.2. In comparison between In and Ga, In is more likely to realized low jitter characteristics, and thus the above M2 is preferably In.

On the other hand, by using Sn as the element M2, the jitter in very high speed recording will be improved, and the optical contrast (the difference in reflectivity between the crystalline state and the amorphous state) can be increased. Thus, δ representing the Sn content is usually at least 0, preferably at least 0.01, more preferably at least 0.05. However, if the Sn amount is excessively large, the amorphous phase immediately after recording is changed to another amorphous phase having a low reflectivity in some cases. Particularly after the long-term storage, the stabilized amorphous phase tends to precipitate, whereby the erasing performance decreases. Accordingly, δ is usually at most 0.3, preferably at most 0.2.

It is possible to use a plurality of elements among In, Ga and Sn as the element M2, but it is particularly preferred to incorporate In and Sn. When In and Sn are incorporated, the total content of these elements is usually at least 1 atomic %, preferably at least 5 atomic %, and usually at most 40 atomic %, preferably at most 30 atomic %, more preferably at most 25 atomic %.

By incorporating Te in the above TeM2 GeSb system composition, the change of the erase ratio at very high speed recording with time can be improved. Accordingly, y representing the Te content is usually at least 0, preferably at least 0.01, particularly preferably at least 0.05. However, if the Te amount is excessively large, the noise tends to be significant in some cases, and thus γ is usually smaller than 0.1.

In a case where Te and the element M2 are incorporated in the above TeM2 GeSb system composition, it is effective to control their total content. Accordingly, δ+γ representing the contents of Te and the element M2 is usually larger than 0, preferably at least 0.01, more preferably at least 0.05. When δ+γ is within the above range, the effect by incorporating Te and the element M2 simultaneously will be favorably obtained. On the other hand, in order that the effect by employing the GeSb system eutectic alloy as the main component is favorably obtained, δ+γ is usually at most 0.4., preferably at most 0.35, more preferably at most 0.3.. Further, δ/γ representing the atomicity ratio of the element M2 to Te is preferably at least 2. Since the optical contrast tends to decrease by incorporating Te, in a case where Te is incorporated, it is preferred to slightly increase the content of the element M2 (slightly increase δ).

As an element which can be added to the above TeM2 GeSb system composition, Au, Ag, Pd, Pt, Si, Pb, Bi, Ta, Nb, V, Mo, a rare earth element, N or O may, for example, be mentioned, and they are employed to finely adjust the optical characteristics or the crystallization rate or for another purpose, and their addition amount is at a level of 10 atomic % at the highest.

Among the above-described composition, one of the most preferred compositions is a composition containing as the main component an alloy system represented by InₚSn_{q}TeᵣGeₛSbₜ (wherein 0≦p≦0.3., 0≦q≦0.3, 0<p+q≦0.3., 0r≦0.1., 0≦s≦0.2., 0.5.≦t≦0.9.and p+q+r+s+t=1). In a case where Te and In and/or Sn are employed in combination, it is preferred that (p+q)/r>2.

The film thickness of the recording layer is preferably at least 5 nm so as to obtain a sufficient optical contrast, to increase the crystallization rate and to achieve erasing of the record in a short time. Further, it is more preferably at least 10 nm in order that the reflectivity is sufficiently high.

On the other hand, the film thickness of the recording layer is preferably at most 100 nm in order that cracks are less likely to form and a sufficient optical contrast will be obtained. It is more preferably at most 50 nm, so as to reduce the thermal capacity and to increase the recording sensitivity. Further, within the above range, the volume change due to the phase change can be reduced. Accordingly, the influence of the repeated volume change due to the repeated overwriting over the protective layer formed on or below the recording layer can be reduced. Consequently, accumulation of irreversible microscopic deformation can be suppressed and noises will be reduced, and the repeated overwriting durability will improve.

For a high density recording medium such as a rewritable DVD, the requirement against noises is stricter, and the recording layer film thickness is more preferably at most 30 nm.

The above recording layer can be obtained usually by DC or RF sputtering of a predetermined alloy target in an inert gas, particularly in an Ar gas.

Further, the density of the recording layer is usually at least 80%, preferably at least 90% of the bulk density. As the bulk density p, an approximate value from the following mathematical formula (1) is usually employed, but it may be actually measured by preparing a mass having an alloy composition constituting the recording layer:
ρ=Σmᵢρi (1)
wherein mᵢ is the molar concentration of each element i, and mᵢρi is the atomic weight of the element i.

In the sputtering deposition method, the high energy Ar amount to be irradiated on the recording layer is increased by lowering the pressure of the sputtering gas (usually rare gas such as Ar, hereinafter explanation will be made with reference to the case of Ar) at the time of deposition, or by disposing the substrate in the vicinity of the front of the target, thereby to increase the density of the recording layer. The high energy Ar is usually either part of Ar ions to be irradiated on the target for sputtering which are bounced off and reach the substrate side, or the Ar ions in the plasma which are accelerated by the sheath voltage of the entire substrate face and reach the substrate.

Such an irradiation effect of the high energy rare gas is referred to as an atomic peening effect, and in the sputtering by an Ar gas which is commonly employed, Ar is incorporated into the sputtering film by the atomic peening effect. Accordingly, the atomic peening effect can be appraised by the Ar amount in the film. Namely, the small Ar amount indicates a small high energy Ar irradiation effect, and a film with a low density is likely to form.

On the other hand, if the Ar amount is large, irradiation of the high energy Ar tends to be intense, and the density of the film tends to be high. However, Ar incorporated in the film is likely to precipitate as a void at the time of repeated overwriting, and is likely to deteriorate the repeated recording durability. Accordingly, the discharge is carried out under an appropriate pressure, usually between the order of from 10⁻² to 10⁻¹ Pa.

(3) Other Layers

(Protective Layer)

A protective layer is formed usually on one or both sides of the recording layer, preferably on both sides, in order to prevent evaporation and deformation due to the phase change of the recording layer, thereby to control the thermal diffusion at that time. The material of the protective layer is determined taking into consideration the refractive index, the thermal conductivity, the chemical stability, the mechanical strength, the adhesive properties, etc. Usually, a dielectric such as an oxide, sulfide, nitride or carbide of a metal or semiconductor, having high transparency and high melting point, or a fluoride of Ca, Mg, Li or the like may be employed.

In this case, such an oxide, sulfide, nitride, carbide or fluoride may not necessarily take a stoichiometrical composition, and the composition may be controlled to adjust the refractive index, etc., and it is effective to use them as mixed. When repeated recording characteristics are taken into consideration, a mixture of dielectrics is preferred. More specifically, a mixture of ZnS or a chalcogen compound such as a rare earth sulfide with a heat resistant compound such as an oxide, nitride, carbide or fluoride may be mentioned. For example, a mixture of heat resistant compounds containing ZnS as the main component, or a mixture of heat resistant compounds containing an oxysulfide of the rare earth, particularly Y₂O₂S as the main component is an example of the preferred protective layer composition.

As a material of the protective layer, usually a dielectric material may be mentioned. The dielectric material may, for example, be an oxide of e.g. Sc, Y, Ce, La, Ti, Zr, Hf, V, Nb, Ta, Zn, Al, Cr, In, Si, Ge, Sn, Sb or Te, a nitride of e.g. Ti, Zr, Hf, V, Nb, Ta, Cr, Mo, W, Zn, B, Al, Ga, In, Si, Ge, Sn, Sb or Pb, a carbide of e.g. Ti, Zr, Hf, V, Nb, Ta, Cr, Mo, W, Zn, B, Al, Ga, In or Si, or a mixture thereof. Further, as the dielectric material, a sulfide, selenide or telluride of e.g. Zn, Y, Cd, Ga, In, Si, Ge, Sn, Pb, Sb or Bi, a fluoride of e.g. Mg, Ca or Li, or a mixture thereof may be mentioned.

Further, as a specific example of the dielectric material, ZnS—SiO₂, SiN, SiO₂, TiO₂, CrN, TaS₂ or Y₂O₂S may, for example, be mentioned. Among these materials, ZnS—SiO₂ is widely used in view of the high film deposition rate, the small film stress, the low rate of change of the volume due to the change in the temperature and the excellent weather resistance. In a case where ZnS—SiO₂ is used, the compositional ratio of ZnS to SiO₂ i.e. ZnS:SiO₂ is usually from 0:1 to 1:0, preferably from 0.5:0.5 to 0.95:0.05, more preferably from 0.7:0.3 to 0.9:0.1. Most preferably ZnS:SiO₂ is 0.8:0.2.

More specifically, preferred is a composite dielectric containing a sulfide or an oxysulfide of a rare earth such as La, Ce, Nd or Y in an amount of at least 50 mol% and at most 90 mol%, or a composite dielectric containing ZnS and TaS₂ in an amount of at least 70 mol% and at most 90 mol%.

Taking the repeated recording characteristics into consideration, the film density of the protective layer is preferably at least 80% of the bulk state in view of the mechanical strength. In a case where a mixture of dielectrics is used, the theoretical density of the above-described mathematical formula (1) is employed as the bulk density.

The thickness of the protective layer is usually at least 1 nm and at most 500 nm in general. When it is at least 1 nm, the effect of preventing the deformation of the substrate or the recording layer can be secured, and a role as the protective layer can be fulfilled. Further, when it is at most 500 nm, while the role as the protective layer can be fulfilled, such a phenomenon can be prevented that the internal stress of the protective layer itself, the difference in the elastic characteristics with the substrate or the like will be remarkable, and thus cracks are formed.

Particularly when a first protective layer located at the light incidence side as observed from the recording layer is formed, the first protective layer is required to suppress deformation of the substrate due to heat, and thus its thickness is usually at least 1 nm, preferably at least 5 nm, more preferably at least 10 nm, furthermore preferably at least 20 nm, particularly preferably at least 40 nm. With such a thickness, accumulation of the microscopic deformation of the substrate during the repeated recording can be suppressed, and remarkable noise increase by scattering of the retrieving laser beam is less likely to occur.

On the other hand, the thickness of the first protective layer is usually at most 400 nm, preferably at most 300 nm, more preferably at most 200 nm, furthermore preferably at most 150 nm, particularly preferably at most 100 nm, with relation to the time required for film formation. With such a thickness, the change of the groove shape of the substrate as viewed on the recording layer plane is less likely to occur. Namely, such a phenomenon that the depth or width of the grooves is smaller than the intended shape on the substrate surface is less likely to take place.

Further, in a case where a second protective layer located at a position opposite to the light incidence side as viewed from the recording layer is formed, the thickness of the second protective layer is usually at least 1 nm, preferably at least 5 nm, more preferably at least 10 nm, furthermore preferably at least 15 nm so as to suppress the deformation of the recording layer. Further, in order to prevent accumulation of the microscopic plastic reformation in the interior of the upper protective layer which occurs due to the repeated recording and to suppress the noise increase due to the scattering of the retrieving laser beam, the film thickness of the second protective layer is preferably at most 200 nm, more preferably at most 150 nm, more preferably at most 100 nm, furthermore preferably at most 60 nm, particularly preferably at most 50 nm, most preferably at most 30 nm.

The thickness of the recording layer and the protective layers are selected taking into consideration the interference effects attributable to the multilayer structure in addition to the restrictions from the viewpoint of the mechanical strength and reliability, so that the efficiency for absorption of the laser beam will be good, and the amplitude of recording signals will be large (that is, the contrast between the recorded state and the non-recorded state will be large).

The protective layer is produced usually by a sputtering method. The total amount of impurities including the amount of impurities from the target itself and the amount of moisture and oxygen included at the time of deposition, is preferably less than 2 atomic %. Therefore, when the protective layer is formed by sputtering, the ultimate vacuum of a process chamber is preferably less than 1×10⁻³ Pa.

(Reflective Layer)

In the optical information recording medium, a reflective layer may further be formed. The position at which the reflective layer is formed usually depends on the incident direction of the retrieving laser beam, and it is formed on the opposite side of the recording layer from the incidence side. Namely, in a case where the retrieving laser beam enters from the substrate side, the reflective layer is formed usually on the opposite side of the recording layer from the substrate, and in a case where the retrieving laser beam enters from the recording layer side, the reflective layer is formed usually between the recording layer and the substrate.

As the material to be used for the reflective layer, a substance having a high reflectivity is preferred, and particularly preferred is a metal such as Au, Ag or Al which can be expected to have a heat dissipation effect also. The heat dissipation properties are determined by the film thickness and the thermal conductivity, and since the thermal conductivity is substantially in proportion to the volume resistivity in the case of such a metal, the heat dissipation performance may be represented by the sheet resistivity. The sheet resistivity is usually at least 0.05 Ω/□, preferably at least 0.1 Ω/□, and on the other hand, it is usually at most 0.6 Ω/□, preferably at most 0.5 Ω/□.

This is to guarantee particularly high heat dissipation properties, and is necessary to suppress recrystallization to a certain extent in a case where competition between the formation of an amorphous phase and the recrystallization is remarkable in the formation of amorphous marks, as in the composition to be used for the recording layer. In order to control the thermal conductivity of the reflective layer itself or to improve the corrosion resistance, e.g. Ta, Ti, Cr, Mo, Mg, V, Nb, Zr or Si may be added in a small amount to the above metal. The addition amount is usually at least 0.01 atomic % and at most 20 atomic %.

More specifically, the material of the reflective layer suitable in the present invention may be an Al alloy containing at least one element selected from the group consisting of Ta, Ti, Co, Cr, Si, Sc, Hf, Pd, Pt, Mg, Zr, Mo and Mn in Al. Such an alloy has improved hillock resistance and can be used considering durability, the volume resistivity, the deposition rate, etc. The content of the above element is usually at least 0.1 atomic %, preferably at least 0.2 atomic % and usually at most 2 atomic %, preferably at most 1 atomic %. Regarding the Al alloy, the hillock resistance tends to be insufficient in many cases if the amount of added impurities is too small, depending upon the deposition conditions. Further, if the amount of added impurities is too large, no sufficient heat dissipation effect will be obtained.

As a specific example of the aluminum alloy, an aluminum alloy containing at least one of Ta and Ti in an amount of at most 15 atomic % is excellent in corrosion resistance. Therefore, this Al alloy is a reflective layer material particularly preferred with a view to improving reliability of the optical information recording medium.

As a preferred example of the reflective layer material, pure Ag or an Ag alloy containing at least one element selected from the group consisting of Ti, V, Ta, Nb, W, Co, Cr, Si, Ge, Sn, Sc, Hf, Pd, Rh, Au, Pt, Mg, Zr, Mo, Cu, Zn, Mn and a rare earth element in Ag may be mentioned. In a case where greater emphasis is put on the stability with time, the additive component is preferably Ti, Mg or Pd. The content of the above elements is usually at least 0.01 atomic %, preferably at least 0.2 atomic %, and usually at most 10 atomic %, preferably at most 5 atomic %.

Particularly, an Ag alloy containing any one of Mg, Ti, Au, Cu, Pd, Pt, Zn, Cr, Si, Ge and a rare earth element in an amount of at least 0.01 atomic % and at most 10 atomic % in Ag has a high reflectivity and a high coefficient of thermal conductivity, is excellent in heat resistance and is preferred.

Particularly in a case where the film thickness of the upper protective layer is at least 40 nm and at most 50 nm, the amount of the additive element contained is preferably at most 2 atomic % so as to make the reflective layer have a high thermal conductivity.

Particularly preferred as the material of the reflective layer is one containing Ag as the main component, and most preferred is pure Ag. The reason why Ag is preferably contained as the main component is as follows. Namely, recording is carried out again on recording marks which are stored for a long time, such a phenomenon may take place in some cases that the recrystallization rate of the phase-change recording layer is high only at first recording immediately after the storage. The reason why such a phenomenon takes place is not clear, but is supposed to be because the size of the amorphous marks formed by the first recording immediately after the storage is smaller than the desired size of the marks due to increase in the recrystallization rate of the recording layer immediately after the storage. Accordingly, in a case where such a phenomenon takes place, Ag having extremely high heat dissipation properties may be used for the reflective layer to increase the cooling rate of the recording layer, whereby recrystallization of the recording layer at the first recording immediately after the storage can be suppressed and the size of the amorphous marks can be maintained to the desired size.

The film thickness of the reflective layer is usually at least 10 nm so that the incident laser beam is completely reflected so that there is no transmitted light, and it is preferably at least 20 nm, more preferably at least 40 nm, furthermore preferably at least 50 nm. Further, when it is too thick, there is no change in the heat dissipation effect, the productivity is unnecessarily deteriorated, and the cracks are likely to occur, and accordingly the film thickness of the reflective layer is usually at most 500 nm, preferably at most 400 nm, more preferably at most 300 nm, furthermore preferably at most 200 nm.

The reflective layer is produced usually by a sputtering method or a vacuum deposition method. In the reflective layer, the total amount of impurities including the amount of impurities from the target and the deposition material themselves and the amount of moisture and oxygen included at the time of deposition, is preferably less than 2 atomic %. In a case where the reflective layer is formed by sputtering, the ultimate vacuum of a process chamber is preferably less than 1×10³ Pa.

Further, in a case where deposition is carried out at an ultimate vacuum higher then 10⁴ Pa, it is desirable to prevent impurities from being contained by adjusting the deposition rate at 1 nm/sec or higher, preferably 10 nm/sec or higher. Further, in a case where an intentional additive element is contained in an amount larger than 1 atomic %, it is desirable to prevent inclusion of additional impurities as far as possible by adjusting the deposition rate at 10 nm/sec or higher.

Further, it is also effective to make the reflective layer have a multilayer structure so as to obtain a higher thermal conductivity and higher reliability. In such a case, preferably at least one layer is made of the above layer with a film thickness of at least 50% of the entire film thickness of the reflective layer. The reflective layer is constituted so that the above layer significantly has a heat dissipation effect, and other layers will contribute to the corrosion resistance, adhesive properties to the protective layer and improvement in the hillock resistance. Particularly in a case where a reflective layer made of pure Ag or containing Ag as the main component is provided in contact with a protective layer containing e.g. ZnS containing sulfur, usually an interfacial layer containing no sulfur is provided so as to prevent corrosion caused by the reaction of Ag with sulfur. In such a case, the interfacial layer is preferably made of a metal so that the interfacial layer can function as a reflective layer. The material of the interfacial layer may be Ta or Nb.

Deposition of each of the respective layers is carried out preferably in an in-line apparatus having a recording layer target, a protective layer target and, if necessary, a reflective layer material target provided in the same vacuum chamber, with a view to preventing oxidation or contamination among the respective layers. Further, it is excellent in view of the productivity also.

(Protective Coating Layer)

It is preferred to form a protective coating layer comprising a ultraviolet-curing resin or a thermosetting resin on the outermost surface side of the optical information recording medium, so as to prevent direct contact with the air or to prevent scars by the contact with foreign materials. The protective coating layer has a thickness of usually from 1 μm to several hundred μm. Further, a dielectric protective layer having high hardness may further be formed, or a resin layer may further be formed thereon.

(Others) In the above, the recording medium is explained with reference to one having a one layer structure such as CD-RW, but the recording medium is not limited thereto, and the present invention is applicable to one having another structure (such as a two-layer structure or a multilayer structure with three or more layers, a two-layer structure of one side incidence type or both sides incidence type).

Further, in general, a recording medium has a recording area on which recording and retrieving of data are practically carried out, and on the recording area, pultrusions and recesses to guide the light beam for recording and retrieving are formed, and the recesses and pultrusions function as tracks. For example, in the case of CD and DVD, an area from a radius of about 23 mm to a radius of about 58 mm corresponds to the recording area. On the recording medium, thin films of the above layer structure are formed on the entire recording area and a small area outside thereof (these areas will sometimes be referred to as a film formation area).

Initialization is usually carried out on the entire film formation area or the entire area excluding its edge. Where the area on which the initialization operation is carried out is referred to as the initial crystallization area (initialization area), usually the following relation is satisfied: film formation area≧initial crystallization area≧recording area.

[2] Initial Crystallization Step in Process for Producing Optical Information Recording Medium

[A] Meaning of Initial Crystallization Step

The recording layer is formed usually by a physical deposition method in vacuum such as a sputtering method. In a state immediately after the deposition (as-deposited state), the recording layer is usually amorphous. Therefore, it is required to crystallize the recording layer to form a non-recorded or erased state. This operation is referred to as an initialization step (or an initial crystallization step, initial crystallization operation).

The initial crystallization operation is achieved by locally applying a focused energy beam (particularly light energy) at a crystallization temperature (usually from 150 to 300° C.) or higher in a very short time to heat the recording layer in a very short time so that the layer structure will not physically be destroyed (hereinafter this initialization method will sometimes be referred to as “bulk erasing”).

Particularly in the case of employing for the recording layer a phase-change recording material with small crystal nucleus formation, it is particularly preferred to employ melt initialization of heating the recording layer at a temperature of at least the melting point of the recording layer in a short time, among the above initial crystallization operations. This is because in the case of the phase-change recording material with small crystal nucleus formation, crystallization in a solid phase tends to be long, whereby the production efficiency tends to be poor, and heating for a long time may cause thermal damage on the film formation area.

In the melt initialization, if the crystallization rate is too low, there is time to achieve thermal equilibrium, whereby another crystalline phase may be formed. Therefore, it is preferred to increase the cooling rate to a certain extent. Further, if the recording medium is held in a molten state for a long time, the recording layer may flow, a thin film such as the protective layer may be separated by the stress, or the resin substrate or the like may be deformed, thus leading to the destruction of the recording medium.

For example, the time in which the recording medium is held at the melting point or higher is usually at most 10 μs, preferably at most 1 μs.

An energy beam light source for the focused beam is preferably a laser beam with a view to obtaining pulse irradiation in a short time and a high energy density simultaneously. As the laser beam source, various ones such as a semiconductor laser and a gas laser may be employed. The laser beam power is usually from about 100 mW to 10 W. It is also possible to employ another focused beam source may be used so long as the same power density and focused beam shape are obtained. Specifically, a Xe lamp beam may, for example, be mentioned. The shape of the focused beam focused on the recording layer face, on the focused face, will be referred to as a spot, a beam spot, a spot shape or a beam spot shape.

The beam spot shape of the focused beam is particularly preferably an elliptic shape having its 5 minor axis substantially in parallel with the scanning direction. Hereinafter, a focused beam which forms an elliptic beam spot will sometimes be referred to simply as an elliptic beam. In such a case, the length of the major axis is usually from 10 to 1,000 μm, and the length of the minor axis is usually from 0.1 to 5 μm.

Here, the lengths of the major axis and the minor axis of the beam are defined from the half value width in a case where the light energy intensity distribution within the beam is measured. With respect to the beam shape also, the minor axis length is preferably at most 5 μm, more preferably at most 2 μm, furthermore preferably at most 1.5 μm, so as to easily realize local heating and rapid cooling in the minor axis direction. The minor axis direction is preferably at least 0.1 μm, more preferably at least 0.5 μm, so as to maintain the depth of focus to a certain extent.

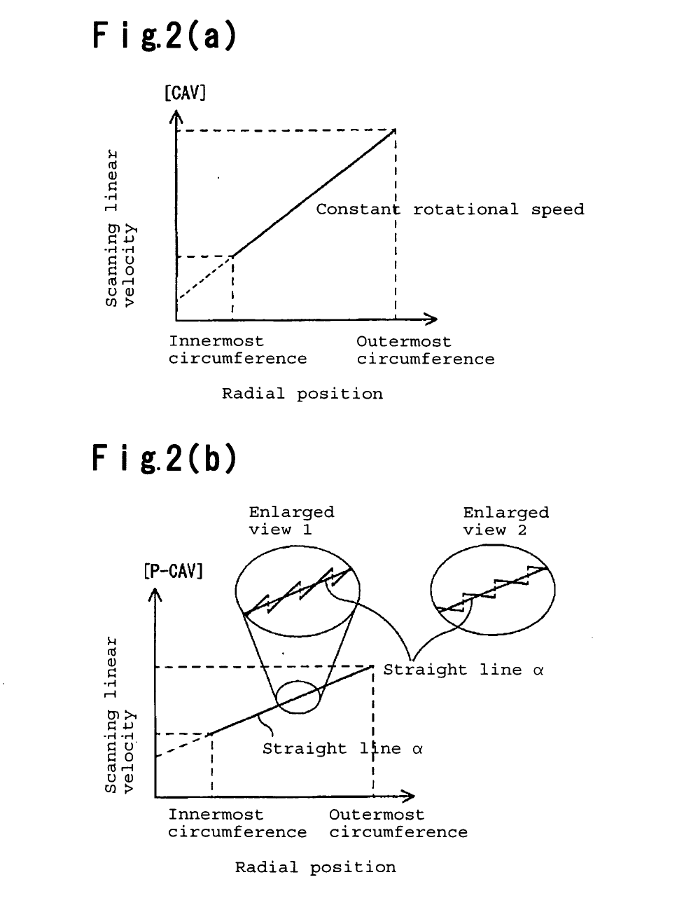

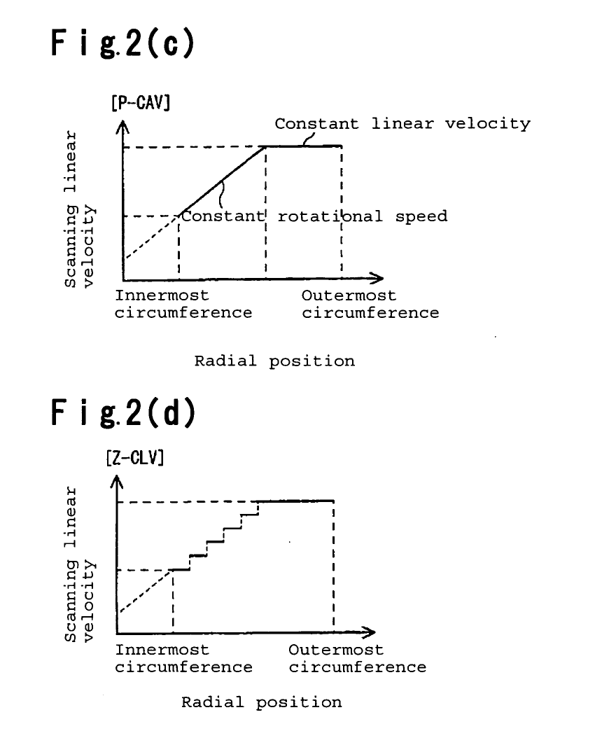

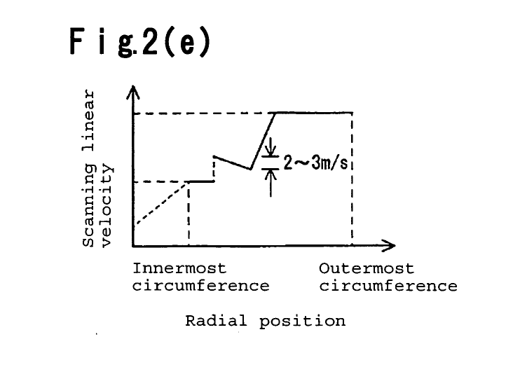

In the initialization by bulk erasing, when a disk-shape (planar circular shape) recording medium is used for example, the minor axis direction of an elliptic beam is brought substantially into line with the circumferential direction, and by rotating the disk, the minor axis is moved in the circumferential direction of the disk, while the major axis is moved in the radial direction every one revolution (one rotation), whereby initialization can be carried out over the entire surface. By doing this, a polycrystal structure aligned in a specific direction relative to the beam spot of the focused beam for recording and retrieving moved along the track in the circumferential direction, can be realized (for apparatus therefor, see JP-A-2002-208143, FIG. 2 for example). The beam may be moved in the radial direction continuously in one rotation, or may be moved every one rotation or every certain moving distance in the circumferential direction.

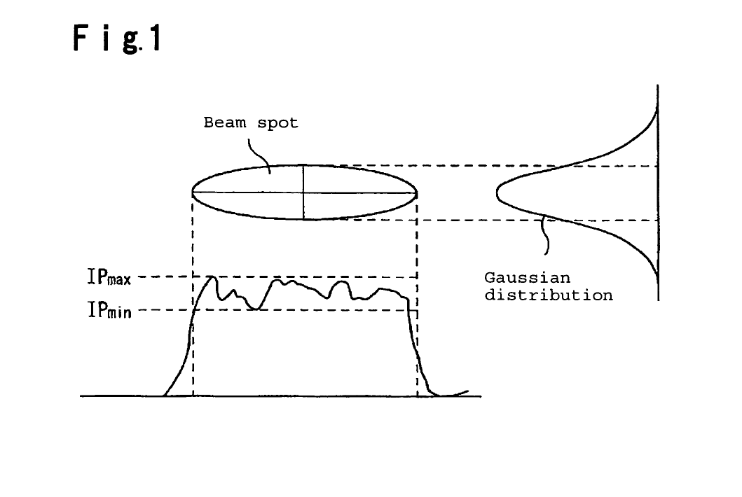

For formation of an elliptic beam spot, a semiconductor laser and a cylindrical lens may be used, as disclosed in JP-A-2002-208143 (particularly FIG. 1 (a view schematically illustrating a beam spot formation apparatus) and description regarding it).

The semiconductor laser is usually edge emission type, and emits a laser beam in a hyperelliptic shape. The beam intensity distribution in the focused beam spot substantially agrees with the Gaussian distribution in the minor axis direction, and it is a trapezoidal distribution in the major axis direction, as shown in FIG. 1. The laser beam intensity of the beam spot in the major axis direction usually has an intensity distribution which is inevitable in view of nature of the semiconductor laser. In FIG. 1 illustrating the inevitable intensity distribution, where the maximum value is represented as IPmax and the minimum value as IPmin, the relation between IPmax and IPmin preferably satisfies (IPmax−IPmin)/(IPmax+IPmin)≦0.2, more preferably (IPmax−IPmin)/(IPmax+IPmin)≦0.1. (IPmax−IPmix)/(IPmax+IP min) is ideally 0.

The beam spot moving distance in the radial direction per one rotation is preferably set to be shorter than the major axis of the beam spot, so that the irradiated areas overlap, and the same radial area will be irradiated a plurality of times with the laser beam. The optical axis of the elliptic beam may be tilted at an angle of from about 0 to about 45° to the radial direction. In such a case, the length of the major axis projected on the recording medium in the radial direction is taken as the length of the major axis (radial direction). And as described above, the moving distance in the radial direction per one rotation is set to be at most the length of the projected major axis of the beam spot, tracings of spots of continuous two revolution overlap, whereby non-initialization due to a gap between spots can be prevented, and secure initialization becomes possible. Further, non-uniformity of the initialized state attributable to the energy distribution (usually from 10 to 20%) in the major axis direction will be avoided. On the other hand, if the moving distance of the beam spot in the radial direction per one rotation is too short, the same position will be repeatedly irradiated with the beam spot a few dozen times. In this case, the above-mentioned other undesirable crystalline phases tend to be formed in some cases. Accordingly, the moving distance of the beam spot in the radial direction per one revolution is usually preferably about ½ of the major axis of the beam spot, or at least ½ of the major axis of the beam spot. Further, the moving distance of the beam spot in the radial direction is set to be about ½ of the major axis of the beam spot, whereby the same position on the recording medium will be irradiated with the light beam twice on the average. Accordingly, unevenness of the crystalline state after initialization can be suppressed and further, it is possible to reduce the risk of thermal damage on the recording medium by irradiating the same position of the recording medium twice or more.

Further, the relative scanning linear velocity (in the present invention, the scanning linear velocity (hereinafter referred to simply as linear velocity) in the initial crystallization means the linear velocity in the circumferential direction) of the beam spot to the recording medium is set to be different depending upon the radial position in the recording area of the optical information recording medium.

Namely, in the initial crystallization step, the scanning linear velocity at the time of scanning the recording medium in the circumferential direction with a beam spot is higher at the outer circumferential portion of the recording medium, and in the initial crystallization step, the intensity of the focused beam is increased as the scanning linear velocity increases. And the entire initial crystallization area is initialized. In other words, along with movement of the beam spot in the radial direction, the relative scanning linear velocity of the beam spot in the circumferential direction relative to the recording medium is increased toward the outer circumferential portion of the recording medium. “The scanning linear velocity is increased toward the outer circumferential portion” means that although the linear scanning velocity may be substantially constant in a certain area, at least in comparison between the innermost circumference and the outermost circumference of the area on a recording layer to be initially crystallized, the scanning linear velocity at the outer circumferential portion is higher. Further, the scanning linear velocity at the outermost circumference is preferably at least 20 m/s, more preferably at least 25 m/s.

The scanning linear velocity is preferably at least 15 m/s, more preferably at least 20 m/s, furthermore preferably at least 25 m/s, in the entire initialization area of the disk. Particularly at the outermost circumferential portion, the scanning linear velocity is preferably at least 20 m/s, more preferably at least 25 m/s.

In the conventional initialization device, which has employed CLV system, the linear velocity is determined by the limit (about 10,000 rpm) of the rotational speed of the disk, but according to the present invention, although the linear velocity at the innermost circumference of the initial crystallization area is determined by the limit of the rotational speed of the disk, the linear velocity at the outermost circumference of the initial crystallization area can be made higher. The upper limit of the linear velocity at the outermost circumference of the initial crystallization area is determined by the design (particularly the composition of the recording layer) of the recording medium.

As specific examples illustrating the relation between the radial position and the scanning linear velocity of the recording medium, FIGS. 2 may be mentioned. FIG. 2(a) illustrates the relation in the case of CAV system, FIGS. 2(b) and (c) illustrate the relation in the case of P-CAV system, FIG. 2(d) illustrates the relation in the case of ZCLV system, and FIG. 2(e) illustrates a combination of P-CAV system and ZCLV system.

More particularly, FIG. 2(a) illustrates a specific example in the case of CAV system, and illustrates a case where the rotational speed per unit time of a circular recording medium is constant at R0 over the entire initialization area.

FIG. 2(b) illustrates a specific example in a case of P-CAV system, and illustrates a case where the scanning linear velocity increases in proportion with the radial position in the same manner as in FIG. 2(a), but the increasing rate is different from a case where the rotational speed is constant. This P-CAV system is realized, for example, by a method as shown in enlarged views shown in FIG. 2(b). Namely, a recording medium is divided into a plurality of areas in the radial direction. While the rotational speed is substantially constant in one area, the rotational speed (scanning linear velocity) is decreased at the next region located in the outer circumferential direction (see enlarged view 1 in FIG. 2(b)). Further, this P-CAV system may be realized, for example, by a method as shown in an enlarged view in FIG. 2(b). Namely, the recording medium is divided into a plurality of areas in a radial direction. The scanning linear velocity is somewhat decreased toward the outer circumference in one area, and the scanning linear velocity is increased when the beam spot moves to the next area located in the outer circumferential direction (see enlarged view 2 in FIG. 2 (b)). The P-CAV system in the enlarged view 2 in FIG. 2(b) may be considered as Z-CLV system.

FIG. 2(c) illustrates another specific example of the P-CAV system. In an inner circumferential area, the CAV system with a constant rotational speed is employed, and in an outer circumferential area, the CLV system with a certain constant scanning linear velocity is employed.

FIG. 2(d) illustrates a specific example of the Z-CLV system. The Z-CLV system is realized by repeatedly carrying out the following operation. Namely, the recording medium is divided into a plurality of areas in a radial direction, and in one area, the scanning linear velocity is substantially constant. When the beam spot moves to the next area located in the outer circumferential direction, the scanning linear velocity is increased, and the scanning linear velocity is maintained constant. This operation is repeated.

FIG. 2(e) illustrates one example specifically illustrating the scope such that the scanning linear velocity is generally higher at the outer circumferential portion, although it is a special example. Namely, it is acceptable to somewhat (e.g. 2 to 3 m/s) decrease the scanning linear velocity within a predetermined range (for example, a range of several mm) in the radial direction of the recording medium, within a range not to exceed the scope of the present invention.

The movement of the beam spot in the radial direction of the recording medium is preferably movement in one direction from the inner circumference to the outer circumference of the area of the recording layer to be initially crystallized, or movement in one direction from the outer circumference to the inner circumference in the area of the recording layer to be initially crystallized, in view of easy mechanical control. However, in movement of the beam spot, a little moving back is acceptable of course. For example, in the case of FIG. 2(c), the following method may be employed. For example, the beam spot is moved in one direction from the inner circumference to the outer circumference in the CAV area in the inner circumferential portion, and then the beam spot is returned to the inner circumference again and the same operation is carried out. Then, the beam spot is moved from the inner circumference to the outer circumference twice in the CLV area at the outer circumferential portion. Such two (or a plurality of) movements are carried out when it is desired to make the crystalline state after initialization be more uniform. Once the beam spot and its movement in the radial direction are determined, the initialization conditions are determined by the scanning velocity of the beam spot in the circumferential direction and the power of the focused beam.

In the present invention, the intensity (focused beam power) of the focused beam is increased as the scanning linear velocity increases along with the movement of the beam spot in the radial direction.

Once the scanning linear velocity is determined, the optimum intensity Po of the focused beam (in this specification, the intensity of the focused beam will sometimes be referred to as initialize power) is determined. The lower limit Pomin of Po is the power required to heat the recording layer at the crystallization temperature or higher to crystallize the recording layer or at the melting point or higher in the melt initialization. On the other hand, the upper limit Pomax of Po is a power not to impart excessive thermal damage on the recording medium. Pomax/Pomin is usually at least 1 and at most 1.5, preferably at most 1.2. The optimum initialize power Po thus determined is considered to be substantially in proportion with the scanning linear velocity.

Po is determined considering the recording characteristics of the optical recording medium after the initial crystallization within a range of from Pomin to Pomax. The recording characteristics of the optical information recording medium to be considered in determination of Po, the following (1) to (3) may, for example, be mentioned.

(1) Po is determined so that the difference between the reflectivity of the optical information recording medium in a non-recorded state after the initial crystallization and the reflectivity at an erased portion after repeated rewriting several times, is as small as possible. The reflectivity is measured as the beam intensity of the retrieving focused beam applied to the optical information recording medium, reflected and returning to the retrieving optical system. The reflectivity is practically the amount substantially in proportion with the level of the voltage output of a photodetector. Further, Po is preferably determined so that there will be no local dispersion of the reflectivity by non-initialization.

(2) The reflected light on the optical information recording medium in a non-recorded state after the initialization is detected by the above photodetector. Po is determined so that noises measured by e.g. a spectrum analyzer will be as small as possible.

(3) Po is determined so that the jitter is controlled to be within a predetermined range in second recording (the second recording is overwriting on an optical information recoding medium on which recording is carried out once).

The jitter is the deviation in time of the detection timing of the mark position in the mark position recording or the mark edge position in the mark length (modulation) recording. The jitter is usually represented by the standard deviation a of the deviation in time with the average of the detection timing as the center. In the present invention, the jitter corresponds to the general conception illustrated in the reference “Optical Disk Technology” (Radio Technology, Co., Ltd., Chapter 1, Section 1.7 Jitter). The jitter is measured in accordance with standard definition and means as disclosed in Orange Book which is the standard for CD, CD-R and CD-RW or a standard for DVD, DVD-R and DVD-RW.

The conditions to restrict the range of Po become stricter in the order of (1), (2) and (3) with (3) strictest. Further, specifically, to carry out measurement (3), a method and a mode determined depending upon a more specific recording format such as CD or DVD are employed. The range of Po as determined by the above method (1) to (3) is usually narrower than the range of from Pomin to Pomax as determined by the above-described physical description. Here, the lower limit of Po determined by the above (1) to (3) is represented as Pimin+, and the upper limit of Po is represented as Pimax+. Further, the range of the initialize power determined by the difference between Pimin+and Pimax+in a certain scanning linear velocity is referred to as the initialize power margin and represented as δPi.

In the present invention, it is preferred to substantially continuously change the scanning linear velocity and the intensity of the focused beam. Here, “to substantially continuously change the scanning linear velocity and the intensity of the focused beam” means Via=Vib+ΔVi where Vib and Via are the scanning linear velocities before and after the change of the scanning linear velocity, and usually means that the intensity of the focused beam is constant within a range of ΔVi/Via≦0.2. Here, ΔVi/Via is preferably at most 0.1. By changing the scanning linear velocity in a small range as mentioned above, crystallization of the recording medium will be carried out uniformly. Further, ΔVi/Via is usually at least 0.001.

In a case where the beam spot is moved while the amount of movement of the beam spot in the radial direction is less than the length of the major axis of the beam spot in the radial direction and the tracings of the beam spot are overlapped so that there will be no non-initialized portion on the recording medium, the overlap of the tracings of the beam spot is at a level of a few dozens μm to several hundred μm. If the initialization conditions are significantly changed in such a very small area at a level of from few dozens μm to several hundred μm, it is highly possible that the initialization state greatly varies in the middle of the recording track, and the recording quality varies in the middle of the track. If there is such a sudden change in the recording track in one rotation, the risk of malfunction (and thus misrecording) of the recording and retrieving device (drive) will increase. Therefore, it is preferred to change the scanning linear velocity in a narrow range as described above.

Even when the ZCLV system as illustrated in FIG. 2(d) is employed, it is preferred to change the scanning linear velocity little by little so that the ΔVi satisfies the above requirement.

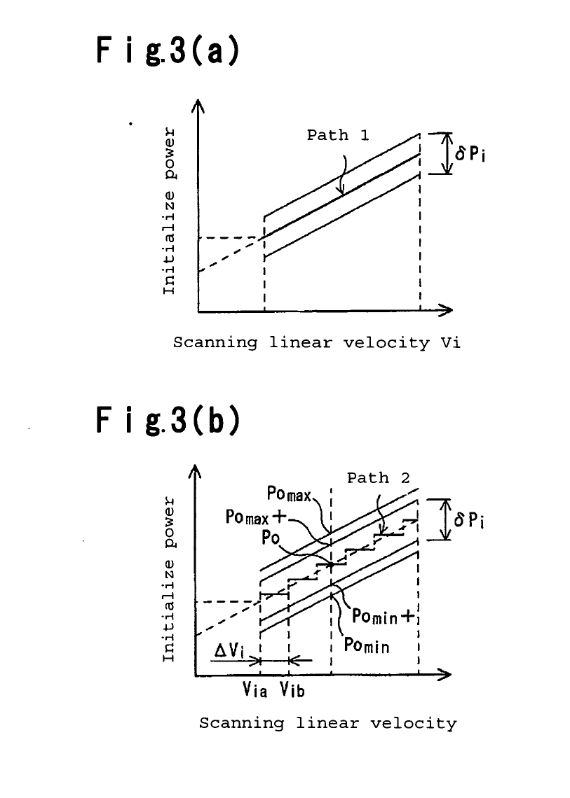

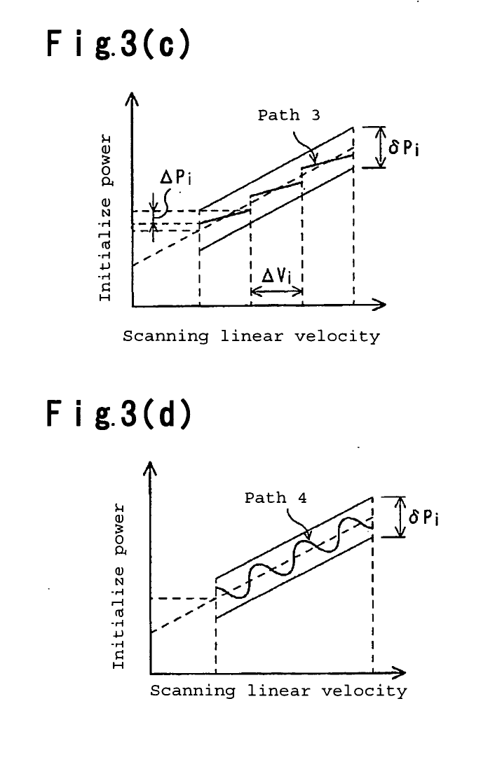

The relation between the scanning linear velocity and the initialize power is schematically illustrated in FIGS. 3. In FIGS. 3, it is preferred to change the scanning linear velocity Vi and the initialize power Pi within a strip range determined by δPi. Ideally, it is preferred to change Po linearly at each Vi (path 1, FIG. 3 (a)). Further, for example, it is possible that Pi is constant to the change ΔVi of Vi, as illustrated in path 2 (FIG. 3(b)), or Pi may be changed by ΔPi in accordance with ΔVi, as illustrated in path 3 (FIG. 3(c)). The path can be freely selected so long as the path is within the strip range of δPi in FIGS. 3. Thus, it is possible to change Pi in accordance with Vi as illustrated in path 4 (FIG. 3(d)).

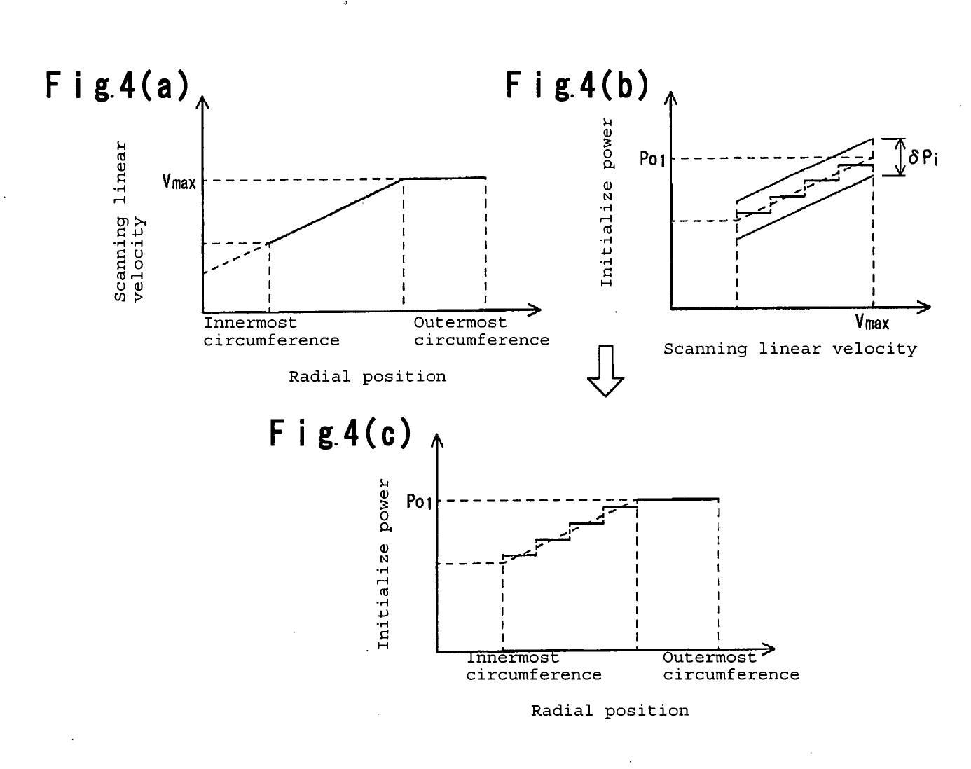

By combining FIGS. 2 and 3, the setting method (relation) for the position of the beam spot, the scanning linear velocity and the initialize power, along with the movement of the beam spot in the radial direction of the recording medium, is determined. For example, in a case where the scanning linear velocity in the radial direction of the recording medium is determined (see FIG. 4(a)) by the P-CAV system as illustrated in FIG. 2(c) and the initialize power is changed (see FIG. 4(b)) relative to the scanning linear velocity as illustrated in FIG. 3(b), the initialize power at the radial position of the recording medium is as shown in FIG. 4(c).

Now, a more specific method for the initialization step will be explained below.

[B] Specific Method of Initial Crystallization in the Case of CAV System

In the present invention, the rotational speed (speed of rotation) R0 per unit time of the recording medium in the initialization step is preferably constant.

R0 is not particularly limited so long as the recording characteristics of the optical information recording medium to be obtained by means of the initialization step satisfy predetermined performance. R0 is preferably the maximum rotational speed Rmax set so as to satisfy the following requirements.

(Conditions which the maximum rotational speed Rmax should satisfy and setting method)

(i) A plurality of recording media is prepared. Using one of the recording media, initialization is carried out by rotating the recording medium at an optional rotational speed in the innermost circumference in the recording area of the recording medium. That is, a plurality of recording media are prepared, and one of the recording media is rotated at an optional rotational speed, so that at least the recording layer formed on the innermost circumferential track in the recording area is initially crystallized.

(ii) Then, recording is carried out twice on the above initially crystallized innermost circumferential track. The second recording corresponds to overwriting on the optical information recording medium on which recording is carried out once.

(iii) The jitter J2 of recording marks formed on the innermost circumferential track after the second recording is measured.

(iv) Then, recording is further carried out eight times (totally ten recordings including previous two recordings), and the jitter J10 of recording marks formed on the innermost circumferential track is measured.

(v) On another recording medium, initial crystallization is carried out at a rotational speed different from the rotational speed in the above (i), and the above operations (ii) to (iv) are carried out.

(vi) The operation (v) is carried out on the other recording media.

(vii) The relation between J2/J10 determined from the jitters J2 and J10 obtained with respect to the recording medium initially crystallized at the respective rotational speeds, and the rotational speed at the time of initial crystallization, is determined. Then, rotational speed R0 is set so that J2/J10 will be at most 1.6.

Rmax as described hereinafter can be selected within a range of the rotational speed R0 within which J2/J10 will be at most 1.6.

In the above method, the jitters are evaluated in the innermost circumferential track in the recording area from the following reason. That is, in initialization by the CAV system, usually the scanning linear velocity at the innermost circumference in the recording area is smallest, and favorable initial crystallization is less likely to be carried out. Therefore, when the recording quality after initialization is sufficient at the innermost circumferential track, favorable recording quality tends to be obtained at the recording area located at the outer circumference (an area on which initialization is carried out at a higher scanning linear velocity).

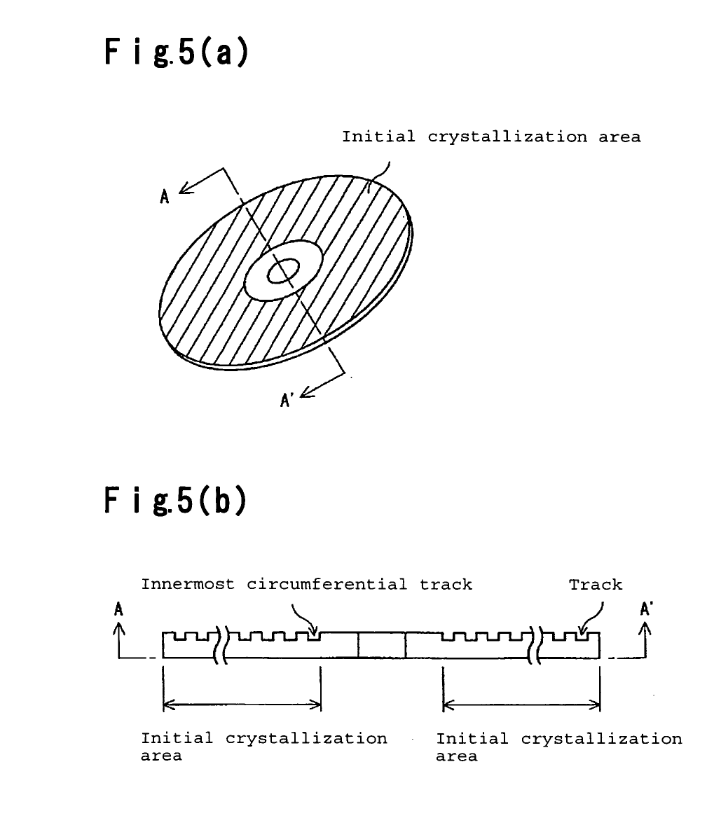

As a specific example of the innermost circumferential track, the innermost circumferential track in the recording area in an area on which initial crystallization is carried out, as illustrated in A-A′ cross section of FIG. 5(a) may be mentioned. In FIG. 5(b) A-A′ cross section, the cross section of the substrate alone is illustrated for easy understanding of the innermost circumferential track position.

Further, the ratio (J2/J10) of the jitter J2 after the second recording to the jitter J10 after the tenth recording at the innermost circumferential track is employed as an index for evaluation from the following reason. Namely, in a usual optical information recording medium, such a phenomenon is observed that the jitter after the second recording is high. Further, such a phenomenon is observed that the jitter gradually decreases as the number or recording (overwriting) is increased, and after recording is repeatedly carried out about ten times, the jitter is decreased to a certain value and is stabilized. Therefore, from the practical viewpoint, it is judged that favorable initialization is carried out when the jitter which is high after the second recording can be controlled to be within a predetermined range (specifically, such a range that the jitter after the second recording is not excessively high as compared with the jitter which is decreased and once stabilized. In the present invention, the optimum rotational speed Rmax to be employed in the initial crystallization step is selected within a range of the rotational speed R0 with which J2/J10 is usually at most 1.6, preferably at most 1.3. Ideally, J2/J10 is preferably 1.

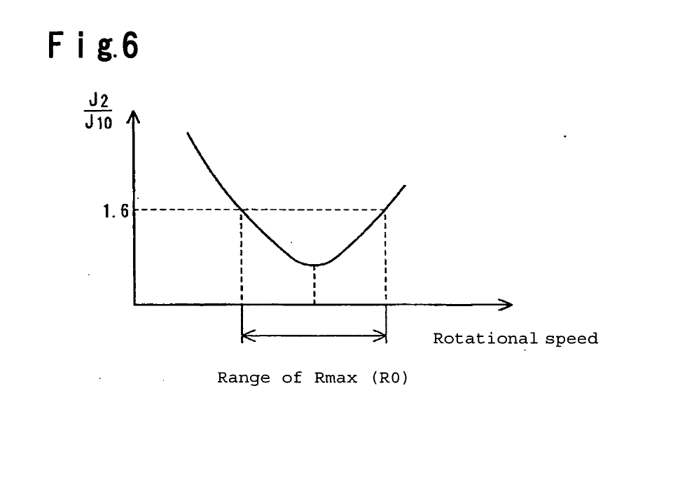

The change of J2/J10 obtained by changing the rotational speed R0 is schematically shown in FIG. 6. As shown in FIG. 6, Rmax can be optionally determined within a range of R0 at which J2/J10 will be at most 1.6. Most preferably, in FIG. 6, Rmax is R0 at which J2/J10 will be smallest.

[C] Specific Method of Initial Crystallization in the Case of ZCAV System

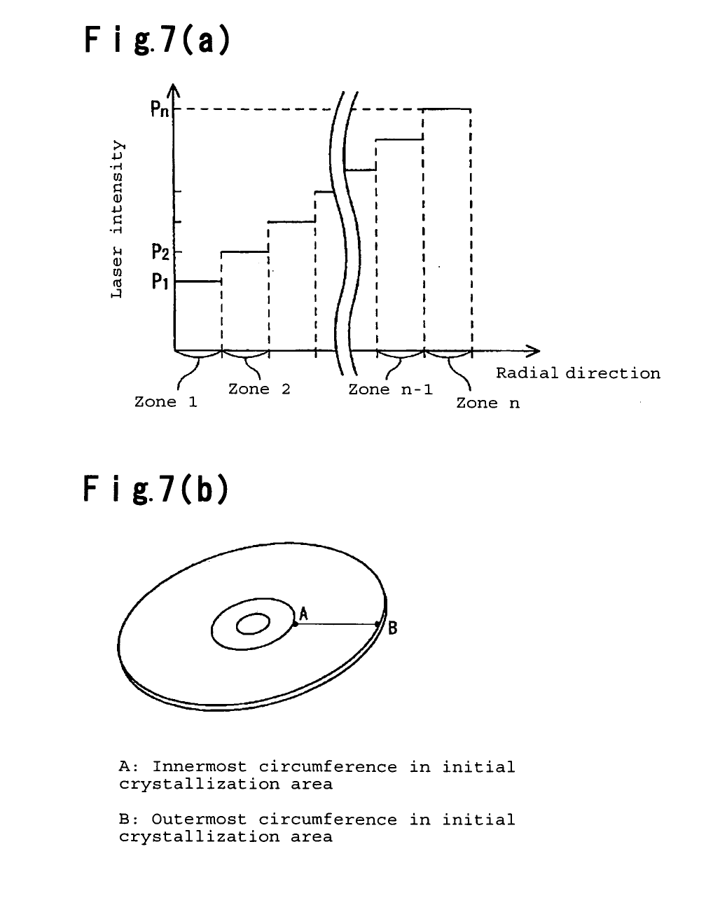

As a specific example of a case where initialization of a recording medium is carried out by ZCAV system, the area from the innermost circumference to the outermost circumference to the initial crystallization area of the recording medium is divided into a plurality of zones along the radial direction of the recording medium (see FIG. 7(b)), and the intensity of the focused beam to be applied in each zone is kept constant. As the beam spot moves toward the outermost circumferential zone, the intensity of the focused beam is gradually increased (the intensity of the focused beam is higher at the outer circumferential side of the recording medium). Namely, the scanning linear velocity gradually increases as the beam spot moves toward the outermost circumference, it is preferred to increase the intensity of the focused beam to be applied so as to securely conduct initial crystallization of the recording layer.

As a method of gradually increasing the intensity of the laser beam toward the outermost circumferential zone, the following method may, for example, be mentioned. Namely, initialization is carried out by changing the initialize laser intensity in the respective divided zones. By measuring the jitter, the reflectivity, etc. after the initialization, the relation between the intensity of the initialize laser beam and the recording quality can be confirmed. As a result, the optimum initialize laser intensity and the upper and lower limits (allowable range to control the recording characteristics within a predetermined range) of the initialize laser intensity in each zone are determined. From the optimum initialize laser intensity and its upper and lower limits in each zone, the initialize laser intensity in each zone is set. An example for setting the initialize laser intensity in each zone is shown in FIG. 7(a).

In the present invention, in the initial crystallization employing the above ZCAV system, it is preferred to set the intensity of the focused beam in each zone so that the jitter in each zone after the initial crystallization satisfies the following requirements.

(Requirements which the Jitter Should Satisfy)

(i) In an optical information recording medium obtained by means of the initial crystallization, an optional zone in the recording area is selected. In this zone, recording is carried out twice on each of one track in the vicinity of the innermost circumference, one track in the vicinity of the center portion and one track in the vicinity of the outermost circumference. The jitter J2inzcav after the second recording at the one track in the vicinity of the innermost circumference, J2outzcav after the second recording at the one track in the vicinity of the outermost circumference, and the jitter J2midzcav after the second recording on the one track in the vicinity of the center portion, are measured.

(ii) Recording is further carried out eight times (totally ten recordings including the previous two recordings) on the one track in the vicinity of the center portion on which recording was carried out twice, s and the jitter J10midzcav after the tenth recording at the one track in the vicinity of the center portion is measured.

(iii) J2inzcav, J2outzcav, J2midzcan and J10midzcav measured in the above (i) and (ii) satisfy
J2inzcav/J10midzcav≦1.6
J2midzcav/J10midzcav≦1.6
J2outzcav/J10midzcav≦1.6

It is understood that uniform initialization is carried out in one zone, when the jitter after the second recording is within a predetermined range relative to the jitter after the tenth recording over the whole area of the one zone. Further, it is understood that uniform initialization is carried out over the whole area in the recording area when the above three formulae are satisfied in the respective zones present in the recording area.

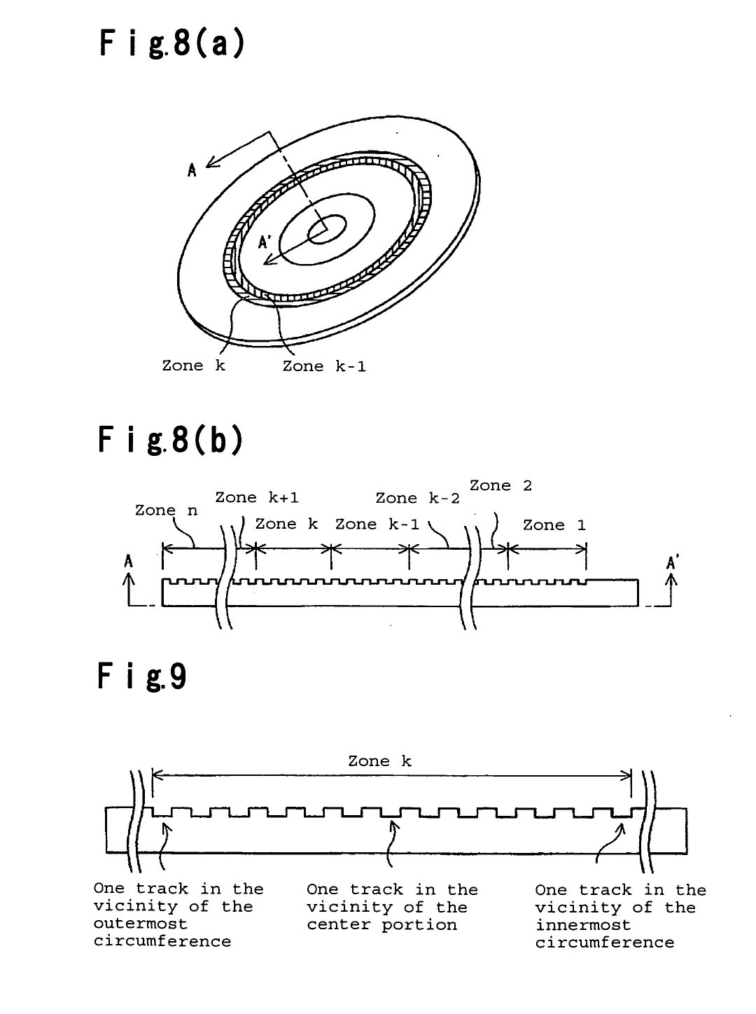

As one example of how the zones are determined, zones 1 to n as shown in FIGS. 8(a) and 8(b) may be mentioned. Predetermined recording is carried out, and jitters are measured at one track in the vicinity of the outermost circumference, one track in the vicinity of the center portion and one track in the vicinity of the innermost circumference in a zone k, for example (see FIG. 9).

Further, as one example of how the intensity of the focused beam in the zone k is determined, the following method may be mentioned. That is, a plurality of recording media are prepared, and initial crystallization is carried out on the respective recording media by changing the intensity of the focused beam at a rotational speed of Rmax. J2inzcav, J2outzcav, J2midzcav and J10midzcav in the zone k in each of the obtained plurality of optical information recording media are measured to calculate
J2inzcav/J10midzcav
J2outzcav/J10midzcav
J2midzcav/J10midzcav
(values calculated from the above three formulae will sometimes be referred to as jitter characteristics). From the above measurement, the relation between the intensity (the initialize power) of the focused beam and the jitter characteristics in the zone k will be obtained. From the result, the initial crystallization step for the zone k will be carried out within a range of the intensity of the focused beam within which the following formulae are satisfied:
J2inzcav/J10midzcav≦1.6
J2outzcav/J10midzcav≦1.6
J2midzcav/J10midzcav≦1.6

In the present invention, in the initial crystallization employing the above ZCAV system, it is also preferred to set the intensity of the focused beam in each zone so that the reflectivity in each zone after s the initial crystallization satisfies the following requirements.

(Requirements which the Reflectivity Should Satisfy)

(i) In the above optical information recording medium obtained by means of the initial crystallization, an optional zone is selected in the recording area, and in this zone, recording is carried out once on each of one track in the vicinity of the innermost circumference, one track in the vicinity of the center portion and on one track in the vicinity of the outermost circumference. The reflectivity Ref1inzcav at the one track in the vicinity of the innermost circumference, the reflectivity Ref1midzcav at the one track in the vicinity of the center portion, and the reflectivity Ref1outzcav at the one track in the vicinity of the outermost circumference after the first recording are measured.

(ii) Recording is further carried out nine times (totally ten recordings including the previous one recording) on each of the tracks on which recording is carried out once. The reflectivity Ref10inzcav at the one track in the vicinity of the innermost circumference, the reflectivity Ref10midzcav at the one track in the vicinity of the center portion and the reflectivity Ref10outzcav at the one track in the vicinity of the outermost circumference after the tenth recording are measured.

(iii) Ref1inzcav, Ref1midzcav, Ref1outzcav, Ref10inzcav, Ref10midzcav and Ref10outzcav measured in the above (i) and (ii) satisfy the following formulae:
|Ref1inzcav-Ref1outzcav|/Ref1midzcav≦0.05
|Ref10inzcav-Ref1inzcav|/Ref10inzcav≦0.05
|Ref10midzcav-Ref1midzcav|/Ref10midzcav≦0.05
|Ref10outzcav-Ref1outzcav|/Ref10outzcav≦0.05

It is understood that when the reflectivities after the first recording are relatively close to one another in the whole area of the one zone, and when the reflectivities after the first recording and the reflectivities after the tenth recording are relatively close to each other in the whole area in the zone, uniform initialization is carried out in this zone. Further, it is understood that when the above four formulae are satisfied in the respective zones present in the recording area, uniform initialization is carried out over the whole area in the recording area.

As one example of how the zones are determined, zones 1 to n as shown in FIGS. 8(a) and 8(b) may be mentioned. Predetermined recording is carried out and the reflectivity is measured in each of one track in the vicinity of the innermost circumference, one track in the vicinity of the center portion and one track in the vicinity of the outermost circumference in the zone k (see FIG. 9).

Further, as one example of how the intensity of the focused beam in the zone k is determined, the following s method may be mentioned. Namely, a plurality of recording media are prepared, and initial crystallization is carried out on the respective recording media by changing the focused beam intensity at the rotational speed of Rmax. Ref1inzcav, Ref1midzcav, Ref1outzcav, Ref10inzcav, Ref10midzcav and Ref10outzcav in the zone k in each of the obtained plurality of optical information recording media, are measured to calculate
|Ref1inzcav−Ref1outzcav|/Ref1midzcav
|Ref10inzcav−Ref1inzcav|/Ref10inzcav
|Ref10midzcav−Ref1midzcav|/Ref10midzcav
|Ref10outzcav−Ref1outzcav|/Ref10outzcav
(values calculated from the above four formulae will sometimes be referred to as reflectivity characteristics). From the above measurement, the relation between the intensity (initialize power) of the focused beam and the reflectivity characteristics in the zone k can be obtained. From this result, the initial crystallization step for the zone k may be carried out within a range of the intensity of the focused beam within which the following formulae are satisfied:
|Ref1inzcav−Ref1outzcav|/Ref1midzcav≦0.05
|Ref10inzcav−Ref1inzcav|/Ref10inzcav≦0.05
|Ref10midzcav−Ref1midzcav|/Ref10midzcav≦0.05
|Ref10outzcav−Ref1outzcav|/Ref10outzcav≦0.05

It is preferred to employ the initialization conditions determined by both the jitter and the reflectivity, but it is possible to employ the initialization conditions determined by one of them.

[D] Change of Laser Beam in Zones in Initial Crystallization by ZCAV System

In the initialization by the ZCAV system, it is preferred to increase the initialize laser intensity toward the outer circumferential zone. The laser intensity may be continuously increased as the beam spot moves toward the outer circumferential direction (for example, see FIG. 3(a)). Further, the laser intensity may be gradually increased toward the outer zone while it is kept constant in each zone (for example, see FIG. 3 (b)). Further, it is possible to employ a method of continuously increasing the laser intensity in each zone while increasing the initialize laser intensity in a predetermined amount among the respective zones (for example, see FIG. 3 (c)). Further, in a case where the laser intensity changes among the respective zones (for example, in the case of FIGS. 3(b) and 3(c)), it is preferred to control the initialize laser intensity as follows.

Specifically, for example, the following two methods may be mentioned.

In a first method, among adjacent two zones in the recording area, the zone at the inner circumferential side is represented as zone A and the zone at the outer circumferential side is represented as zone B. The initialize laser intensity in the zone A is represented as Pin and the initialize laser intensity in the zone B is represented as Pout. For initial crystallization, the above Pin and Pout, and the minimum initialize laser intensity PJmin and the maximum initialize laser intensity PJmax measured by the following method are set to satisfy the formula:
PJmin≦Pin≦Pout≦PJmax

Here, PJmin and PJmax are set preferably by the following method.

(Method for Setting the Maximum Initialize Laser Intensity PJmax and the Minimum Initialize Laser Intensity Pjmin)

The minimum value and the maximum value of the laser intensity are taken as PJmin and PJmax, respectively, at which J2zoneAout, J2zoneBin and J10zoneAmid, where J2zoneAout is the jitter when recording is carried out twice on one track in the vicinity of the outermost circumference in the zone A in the optical information recording medium, J10zoneAmid is the jitter when recording is carried out ten times on one track in the vicinity of the center portion in the zone A in the optical information recording medium, and J2zoneBin is the jitter when recording is carried out twice on one track in the vicinity of the innermost circumference in the zone B in the optical information recording medium, satisfy the following formulae
J2zoneAout/J10zoneAmid≦1.6
J2zoneBin/J10zoneAmid≦1.6

It is judged that substantially the same initialization can be carried out on both the zones when the jitters after the second recording are relatively close to each other at the boundary area between the two zones.

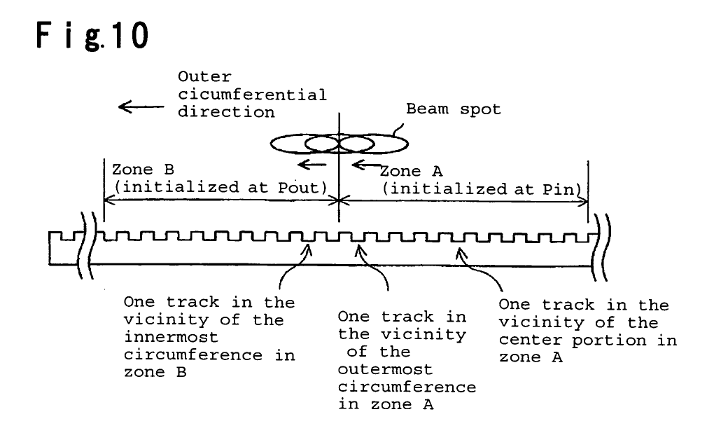

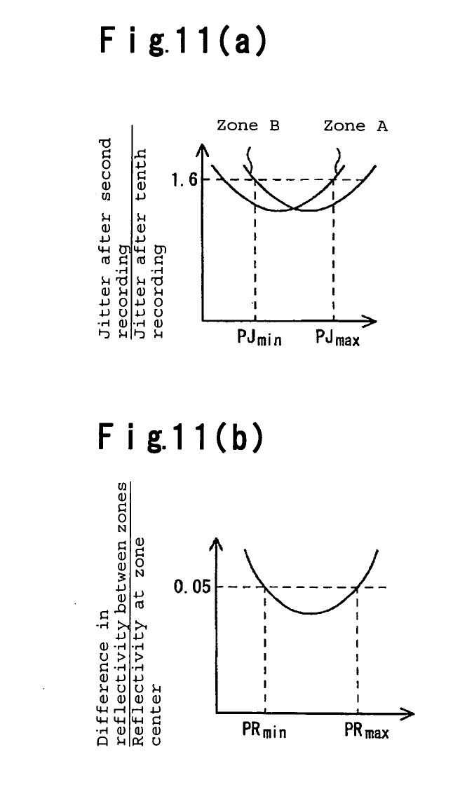

As a specific example of the zone A, the zone B, the track in the vicinity of the outermost circumference in the zone A, the track in the vicinity of the center portion in the zone A and the track in the vicinity of the innermost circumference in the zone B, FIG. 10 may be mentioned. As a specific method of setting the above PJmin and PJmax, the following method may be mentioned. For example, a plurality of recording media having the same layer structure are prepared, and the zones A and B of one recording medium are initialized at the same initialize laser intensity, to determine “J2zoneAout/J10zoneAmid” and “J2zoneBin/J10zoneAmid” of the optical information recording medium. Then, using another recording medium, the zones A and B are initialized at the initialize laser intensity different from that for the above recording medium to determine “J2zoneAout/J10zoneAmid” and “J2zoneBin/J10zoneAmid” of the optical information recording medium. The above operation is repeated to determine “J2zoneAout/J10zoneAmid” and “J2zoneBin/J10zoneAmid” of the respective optical information recording media. Then, the relation of the initialize laser intensity with “J2zoneAout/J10zoneAmid” and “J2zoneBin/J10zoneAmid” is plotted. From the result, the minimum value and the maximum value of the initialize laser intensity at which both “J2zoneAout/J10zoneAmid” and “J2zoneBin/J10zoneAmid” are at most 1.6, are taken as PJmin and Pjmax, respectively, and Pin and Pout are changed within a range of from PJmin to PJmax while the relation Pin≦Pout is maintained (see FIG. 11(a)).

In a second method, among adjacent two zones in the recording area, the zone located at the inner circumferential side is represented as zone A, and the zone located at the outer circumferential side is represented as zone B. The initialize laser intensity in the zone A is represented as Pin, and the initialize laser intensity in the zone B is represented as Pout. For the initial crystallization, the above Pin and Pout, and the minimum initialize laser intensity PRmin and the maximum initialize laser intensity PRmax measured by the following method are set to satisfy the formula:
PRmin≦Pin≦Pout≦PRmax

Here, PRmin and PRmax are preferably set to satisfy the following requirements.

(Requirements which the Maximum Initialize Laser Intensity PRmax and the Minimum Initialize Laser Intensity PRmin Should Satisfy (Setting Method))

The minimum value and the maximum value of the laser intensity are taken as PRmin and PRmax, respectively, at which the following formula is satisfied:
|RefzoneAout−RefzoneBin|/RefzoneAmid≦0.05
where RefzoneAout is the reflectivity when recording is carried out once on one track in the vicinity of the outermost circumference in the zone A in the optical information recording medium, RefzoneAmid is the reflectivity when the recording is carried out once on one track in the vicinity of the center portion in the zone A in the optical information recording medium, and RefzoneBin is the reflectivity when recording is carried out once on one track in the vicinity of the innermost circumference in the zone B in the optical information recording medium.

It is judged that substantially the same initialization can be carried out on both the zones, when the reflectivities after the first recording are relatively close to each other at the boundary area between the two zones.

As a specific example of the zone A, the zone B, the track in the vicinity of the outermost circumference in the zone A, the track in the vicinity of the center portion in the zone A and the track in the vicinity of the innermost circumference in the zone B, FIG. 10 may be mentioned. As a specific method of setting the above PRmin and PRmax, the following method may be mentioned. For example, a plurality of recording media having the same layer structure are prepared, and the zones A and B in one recording medium are initialized at the same initialize laser intensity to determine “|RefzoneAout−RefzoneBin|/RefzoneAmid” of the optical information recording medium. Then, in another recording medium, the zones A and B are initialized at the initialize laser intensity different from that for the above recording medium to determine “|RefzoneAout−RefzoneBin|/RefzoneAmid” of the optical information recording medium. The above operation is repeated to determine “|RefzoneAout−RefzoneBin|/RefzoneAmid” of the respective optical information recording media. Then, the relation between the initialize laser intensity and “|RefzoneAout−RefzoneBin|/RefzoneAmid”, is plotted. From the result, the minimum value and the maximum value of the initialize laser intensity at which “|RefzoneAout−RefzoneBin|/RefzoneAmid” will be at most 0.05 are taken as PRmin and PRmax, respectively, and Pin and Pout are changed within a range of from PRmin to PRmax while the relation Pin≦Pout is maintained (see FIG. 11(b)).

As described above, the initialization laser is usually elliptic, it is set so that the major axis will be in parallel with the radial direction, and the length of the major axis is set to cover a plurality of tracks. Further, usually the moving distance of the laser in one rotation in the radial direction is set to be shorter than the length of the major axis of the laser, so that the same portion of the recording medium is irradiated with the initialization laser several times. Here, the track position of the recording medium and the initialization laser position control are not necessarily synchronized in some cases. Therefore, depending upon the timing of changing the laser intensity from Pin to Pout, the area in the vicinity of the boundary between the zones A and B in the outer zone B may be initialized at the initialize laser intensity for the zone A, or the area in the vicinity of the boundary between the zones A and B in the inner zone A may be initialized at the initialize laser intensity for the zone B in some cases. Further, depending upon the timing of changing the laser intensity from Pin to Pout, the boundary area between the zones A and B may be initialized at the initialization laser intensities for both zones in some cases (see FIG. 10).

[E] Initial Crystallization Method in ZCLV System and Determination of Initialize Laser Intensity in Zones

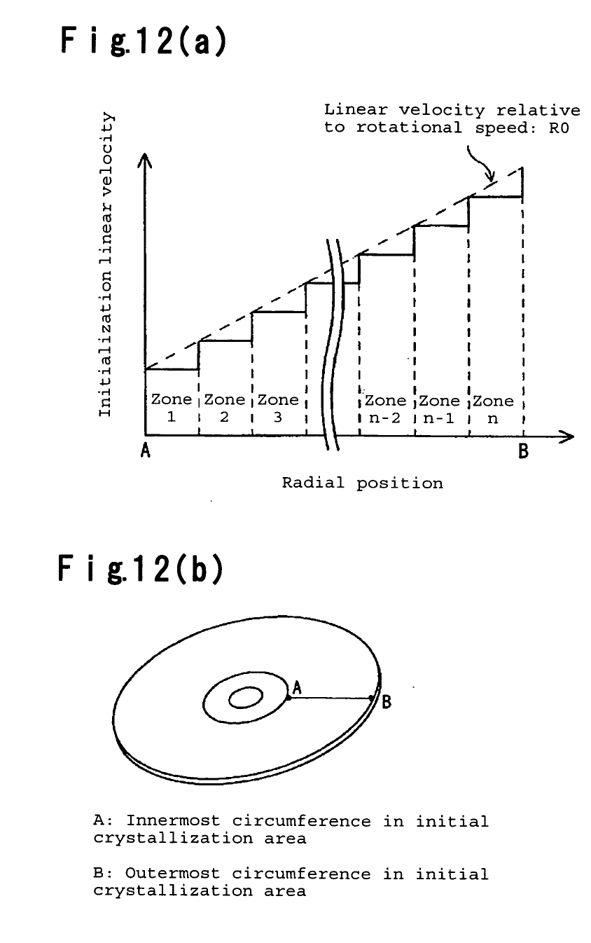

In the case of initialization by the ZCLV system, it is preferred to divide the area from the innermost circumference to the outermost circumference in the initial crystallization area in the recording medium (see FIG. 12(b)) into a plurality of zones, and to keep the rotational speed at the innermost circumferential position in the respective zones constant. Namely, in this initialization method, as shown in FIG. 12(a) for example, a plurality of zones (zones 1 to n in FIG. 12(a)) are provided in the radial direction in the recording medium, and at the innermost circumferences in the respective zones, the rotational speed is set to be constant at R0. Further, initial crystallization is carried out at a constant linear velocity from the innermost circumference to the outermost circumference in each zone (see FIG. 12(a)).

Further, in this initialization method, it is preferred to set the laser beam intensity in each zone so that the jitter in each zone of the initially crystallized optical information recording medium satisfies the following requirements.

(Requirements which the Jitter Should Satisfy)

(i) In the above optical information recording medium, an optional zone in the recording area is selected. Recording is carried out twice on one track in the vicinity of the center portion of the above zone, and the jitter J2midzclv after the second recording is measured.

(ii) Recording is further carried out 8 times (totally ten recordings including the previous two recordings) on the one track in the vicinity of the center portion and the jitter J10midzclv after the tenth recording is measured.

(iii) J2midzclv and J10midzclv measured in the above (i) and (ii) satisfy the formula:
J2midzclv/J10midzclv≦1.6

The ZCLV system has such an advantage that uniformity in initialization in the zone is likely to be secured since initialization is carried out at a constant linear velocity in each zone. Therefore, when the jitter after the second recording is within a predetermined range relative to the jitter after the tenth recording in a track in the vicinity of the center portion in each zone, it is considered that initialization is carried out uniformly in that zone. Further, it is understood that the whole recording area is uniformly initialized when the above formula is satisfied in the respective zones in the recording area.

Further, in the present invention, it is also preferred to set the intensity of the laser beam in each zone so that the reflectivity in each zone after initial crystallization satisfies the following requirements.

(Requirements which the Reflectivities Should Satisfy)

(i) An optional zone in the recording area in the optical information recording medium is selected. Recording is carried out once on one track in the vicinity of the center portion in the zone, and the reflectivity Ref1midzclv in the one track in the vicinity of the center portion is measured.

(ii) Recording is further carried out nine times (totally ten recordings including the previous one recording) on the one track in the vicinity of the center portion, and the reflectivity Ref10midzclv on the one track in the vicinity of the center portion after the tenth recording is measured.

(iii) Ref1midzclv and Ref10midzclv measured in the above (i) and (ii) satisfy the formula:
|Ref10midzclv−Ref1midzclv|/Ref10midzclv≦0.05

As described above, the ZCLV system has such an advantage that the uniformity in initialization in each zone is likely to be secured since initialization is carried out at a constant linear velocity in each zone.

Therefore, when the reflectivity after the first recording and the reflectivity after the tenth recording at the zone center portion are relatively close to each other, it is considered that uniform initialization is carried out in the zone. Further, it is understood that the entire recording area is uniformly initialized when the above formula is satisfied in the respective zones present in the recording area.

It is preferred to employ the initialization conditions determined by both the jitter and the reflectivity, but it is possible to employ the initialization conditions determined by one of them.

[F] Specific Example 1 of Method for Changing Laser Beam

In the initialization by the ZCLV system, it is preferred to increase the initialize laser intensity toward the outer circumferential zone. The laser intensity may be continuously increased as the beam spot moves toward the outer circumferential direction (for example, see FIG. 3(a)). Further, the laser intensity may be gradually increased toward the outer zone, while it is kept constant in each zone (for example, FIG. 3 (b)). Further, it is possible to employ a method of continuously increasing the laser intensity in each zone while increasing the initialize laser intensity in a predetermined amount among the respective zones (for example, FIG. 3(c)). In a case where the laser intensity is changed among the respective zones (for example, in the case of FIG. 3(b)), it is preferred to control the initialize laser intensity as follows.

Now, two specific examples of a method for setting the amount of change of the initialize laser intensity among the respective zones in the case of FIG. 3(b) will be described below.

In a first method, among adjacent two zones in the recording area, the zone located at the inner circumferential side is represented as zone A, and the zone located at the outer circumferential side is represented as zone B. The initialize laser intensity for the zone A is represented as Pin, and the initialize laser intensity for the zone B is represented as Pout. For the initial crystallization, it is preferred that the above Pin and Pout satisfy the following requirements.

(Requirement which Pin and Pout Should Satisfy)

(i) Two of the above recording media are prepared.

(ii) Using one of the above two recording media, the zone A is initially crystallized at the initialize laser intensity Pin, and the zone B is initially crystallized at the initialize laser intensity Pout. The jitter J10zoneAPin after recording is carried out ten times on one track in the vicinity of the center portion in the zone A, and the jitter J10zoneBPout after recording is carried out ten times on one track in the vicinity of the center portion in the above zone B, are measured.

(iii) On the other recording medium among the above two recording media, the zone A is initially crystallized at the initialize laser intensity Pout, and the zone B is initially crystallized at the initialize laser intensity Pin. The jitter J2zoneAPout after recording is carried out twice on one track in the vicinity of the center portion in the zone A, and the jitter J2zoneBPin after recording is carried out twice on one track in the vicinity of the center portion in the zone B, are measured.

(iv) J10zoneAPin and J2zoneAPout measured in the above (ii) and (iii) satisfy the relation:
J2zoneAPout/J10zoneAPin≦1.6
and J10zoneBPout and J2zoneBPin measured in the above (ii) and (iii) satisfy the relation:
J2zoneBPin/J10zoneBPout≦1.6

As described above, depending upon the timing of changing the laser intensity from Pin to Pout, the area in the vicinity of the boundary between the zones A and B in the outer zone B may be initialized at the initialize laser intensity for the zone A, or the area in the vicinity of the boundary between the zones A and B in the inner zone A may be initialized at the initialize laser intensity for the zone B in some cases. Further, depending upon the timing of changing the laser intensity from Pin to Pout, the boundary area between the zones A and B may be initialized at the initialize laser intensities for both zones in some cases.

Therefore, the jitter after second recording (it tends to increase relative to that after first recording after initialization) in each of the zones A and B in the vicinity of the boundary between the zones A and B, may be high as compared with the jitter (desired jitter after second recording in the zone A) after second recording in the zone A in the vicinity of the boundary between the zones A and B when the zone A is initialized only at Pin, or the jitter (the desired jitter after second recording in the zone B) after second recording in the zone B in the vicinity of the boundary between the zones A and B when the zone B is initialized only at Pout.

Accordingly, the jitter after second recording at a portion in the vicinity of the center in the zone A when the zone A is initialized at Pout is set to be within a predetermined range relative to the jitter (the jitter decreased and once stabilized) after tenth recording at a portion in the vicinity of the center in the zone A when the zone A is initialized at Pin. Further, the jitter after second recording at a portion in the vicinity of the center in the zone B when the zone B is initialized at Pin is set to be within a predetermined range relative to the jitter (the jitter decreased and once stabilized) after tenth recording at a portion in the vicinity of the center in the zone B when the zone B is initialized at Pout. In such a case, it is judged that substantially the same initialization is carried out in both the zone A and B.

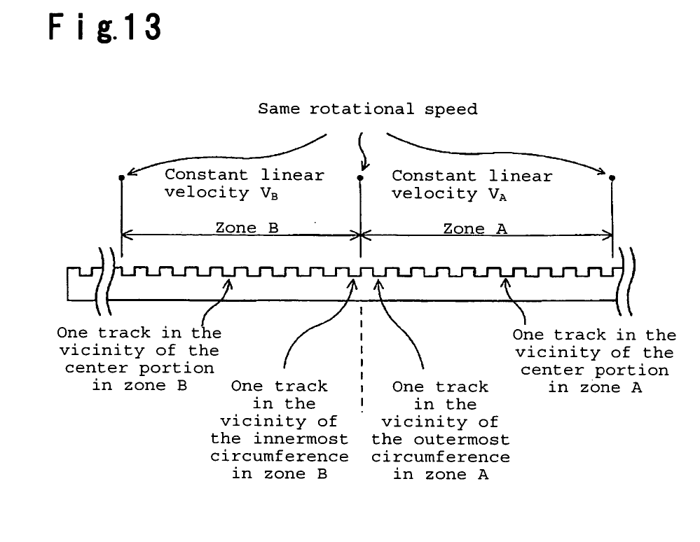

As a specific example of the zone A, the zone B, the track in the vicinity of the center portion in the zone A and the track in the vicinity of the center portion in the zone B is shown in FIG. 13. As a specific method of setting the above Pin and Pout, the following method may be mentioned.

First, the range of the initialize laser intensity to be satisfied for each of the zones is determined from the above “[E] Initial crystallization method in ZCLV system and determination of initialize laser intensity in zones”. Therefore, there are tentative desired initialize laser intensities Pin and Pout for the zones A and B. The tentative (temporary) Pin for initialization of the zone A is referred to as Pin′ and the tentative (temporary) Pout for initialization of the zone B is represented as Pout′. The zones A and B in one recording medium are initialized at these initialize laser intensities Pin′ and Pout′, respectively, to determine J10zoneAPin and J10zoneBPout.

Then, a plurality of recording media having the same layer structure as that of the above recording medium are prepared. The zones A and B in each of the recording media are initialized at the same initialize laser intensity (the initialize laser intensities for the respective recording media are different from one another), and the jitter (the jitter after second recording) after second recording at a portion in the vicinity of the center in each of the zones A and B is measured. Then, the values “jitter after second recording/J10zoneAPin” and “jitter after second recording/J10zoneBPout” relative to the initialize laser intensity are plotted (see FIG. 14). FIG. 14 is a view schematically illustrating the relation of the initialize laser intensity with “jitter after second recording/J10zoneAPin” and “jitter after second recording/J10zoneBPout”. Considering the zone A alone, the initialize laser intensity can be set within a range β in the drawing. On the other hand, considering the zone B alone, the initialize laser intensity can be set within a range γ in the drawing. Considering favorable initialization of both the zones A and B, it is required to set Pin and Pout within a range a in the drawing (α represents a range which Pin and Pout should satisfy). Therefore, in a case where the above Pin′ and Pout′ are out of the range α in the drawing, they may be set within a range α.

In a second method, it is preferred to carry out the initial crystallization as follows. Namely, among adjacent two zones in the recording area, the zone at the inner circumferential side is represented as zone A, and the zone at the outer circumferential side is represented as zone B. The initialize laser intensity for the zone A is represented as Pin, and the initialize laser intensity for the zone B is represented as Pout. The above Pin and Pout satisfy the following requirements.

(Requirements which Pin and Pout should satisfy)

(i) Two of the above recording media are prepared.

(ii) Using one of the above two recording media, the zones A and B are initially crystallized at the initialize laser intensity Pin. Then, the reflectivity Ref1zoneAPin after recording is carried out once on one track in the vicinity of the center portion in the zone A and the reflectivity Ref1zoneBPin after recording is carried out once on one track in the vicinity of the center portion in the zone B are measured.

(iii) On the other recording medium among the above two recording media, the zone A is initially crystallized at the initialize laser intensity Pout. Then, the reflectivity Ref1zoneAPout after recording is carried out one on one track in the vicinity of the center portion in the zone A is measured.

(iv) Ref1zoneAPin, Ref1zoneBPin and Ref1zoneAPout measured in the above (ii) and (iii) satisfy the following relation:
|Ref1zoneAPout−Ref1zoneBPin|/Ref1zoneAPin≦0.05

As described above, depending upon the timing of changing the laser intensity from Pin to Pout, the area in the vicinity of the boundary between the zones A and B in the outer zone B may be initialized at the initialize laser intensity for the zone A, or the area in the vicinity of the boundary between the zones A and B in the inner zone A may be initialized at the initialize laser intensity for the zone B in some cases. Further, depending upon the timing of changing the laser intensity from Pin to Pout, the boundary area between the zones A and B may be initialized at the initialize laser intensities for both zones in some cases.

Therefore, the reflectivity in each of the zones A and B in the vicinity of the boundary between the zones A and B, may be high or low as compared with the reflectivity in the zone A in the vicinity of the boundary between the zones A and B when the zone A is initialized only at Pin, or the reflectivity in the zone B in the vicinity of the boundary between the zones A and B when the zone B is initialized only at Pout.

Accordingly, when the reflectivity when the zone A is initialized at Pout and the reflectivity when the zone B is initialized at Pin are set to be within predetermined ranges relative to the reflectivity when the zone A is initialized at Pin, it is judged that substantially the same initialization is carried out in both the zones A and B even if the reflectivities in the zones A and B are changed along with the change in the intensity of the initialize laser at a portion in the vicinity of the boundary between the zones A and B.

As a specific example of the zone A, the zone B, the track in the vicinity of the center portion in the zone A and the track in the vicinity of the center portion in the zone B is shown in FIG. 13. As a specific method of setting the above Pin and Pout, the following method may be mentioned.

First, the range of the initialize laser intensity to be satisfied for each of the zones is determined from the above “[E] Initial crystallization method in ZCLV system and determination of initialize laser intensity in zones”. Therefore, there is a tentative predetermined initialize laser intensity Pin for the zone A. The tentative (temporary) Pin for initialization of the zone A is referred to as Pin′. The zone A in one recording medium is initialized at the initialize laser intensity Pin′, and the reflectivity Ref1zoneAPin after first recording in a track in the vicinity of the center portion in the zone A is measured.

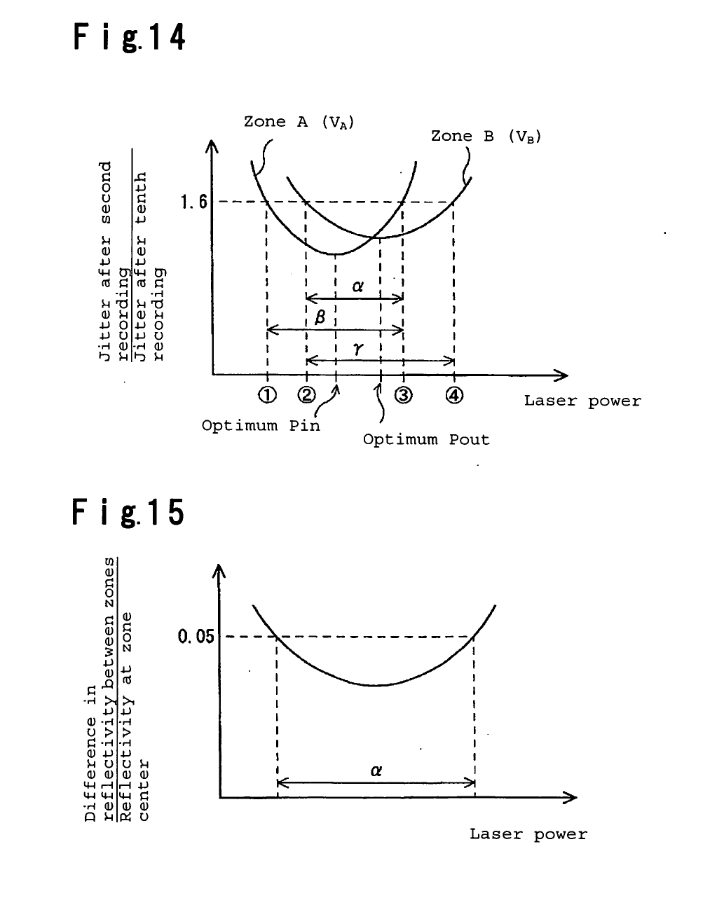

Then, a plurality of recording media having the same layer structure as that of the above recording media are prepared. Initialization is carried out at different initialize laser intensities on the respective recording media. Then, the reflectivity after first recording in each of the zones A and B is measured at a center portion of each zone. Then, values “|(reflectivities after first recording in zone A)−(reflectivity after first recording in zone B)|/Ref1zoneAPin” relative to the initialize laser intensity in the zone A is plotted (see FIG. 15). FIG. 15 is a view schematically illustrating the relation between the initialize laser intensity and “|(reflectivity after first recording in zone A)−(reflectivity after first recording in zone B) |/Ref1zoneAPin”. Pout is required to be set within a range α in the drawing (α represents a range which Pout should satisfy relative to Pin′ which is the temporary Pin).

As described above, the initialize laser is usually elliptic and it is set so that the major axis will be in parallel with the radial direction. Further, the length of the major axis is set to cover a plurality of tracks. Further, the moving distance of the laser in one rotation in the radial direction is set to be shorter than the length of the major axis of the laser, so that the same portion on the recording medium is irradiated with the initialize laser several times. Here, the track position of the recording medium and the initialize laser position control are not necessarily synchronized in some cases. Therefore, depending upon the timing of changing the laser intensity from Pin to Pout, the area in the vicinity of the boundary between the zones A and B in the outer zone B may be initialized at the initialize laser intensity for the zone A, or the area in the vicinity of the boundary between the zones A and B in the inner zone A may be initialized at the initialize laser intensity for the zone B in some cases. Further, depending upon the timing of changing the laser intensity from Pin to Pout, the boundary area between the zones A and B may be initialized at the initialize laser intensities for both zones in some cases (see FIG. 10). This is similar to the initialization in the ZCAV system.

[G] Specific Example 2 of Method for Changing Laser Beam

Now, two specific examples of a method for setting the amount of change of the initialize laser intensity among the respective zones in the case of FIG. 3(c) will be described below.

Here, among adjacent two zones in the recording area of the recording layer, the zone at the inner circumferential side is represented as zone A, the zone at the outer circumferential side is represented as zone B, the focused beam (initialize laser) intensity for the zone A is represented as Pin, and the focused beam (initialize laser) intensity for the zone B is represented as Pout.

In a first method, the minimum value of Pin is represented as Pinmin, and the maximum value is represented as Pinmax, and the minimum value of Pout is represented as Poutmin, and the maximum value is represented as Poutmax. In the initialization step, Pin is gradually increased within a range of from the above Pinmin to the above Pinmax as the initialize laser moves toward the outer circumferential direction in the zone A. The value of Pin at the outermost circumference in the zone A is taken as PinzoneAout. Further, Pout is gradually increased within a range of from the above Poutmin to the above Poutmax as the initialize laser moves toward the outermost circumferential direction in the zone B. The value of Pout at the outermost circumference in the zone B is taken as PoutzoneBin.

The above PoutzoneBin and PinzoneAout preferably satisfy the relation:
PoutzoneBin=PinzoneAout
This control method is advantageous in that initialization at a portion in the vicinity of the boundary between the respective zones will be easily carried out since there is no change of the initialize laser intensity among the zones. As a particularly preferred control method, the method of continuously (linearly) changing the initialize laser intensity as the scanning linear velocity increases, as shown in FIG. 3 (a), may be mentioned. However, although the relation “PoutzoneBin=PinzoneAout” is satisfied, an error of about ±10% between PoutzoneBin and PinzoneAout is allowable.

Even in a case where the above PoutzoneBin and PinzoneAout are not the same intensity, it is preferred that PoutzoneBin>PinzoneAout and the difference-between PoutzoneBin and PinzoneAout is as small as possible. When the difference between PoutzoneBin and PinzoneAout is as small as possible, the boundary area between the zones A and B is likely to be uniformly initialized.

[H] Initial Crystallization by P-CAV System

As described above, the initialization in the present invention may also be carried out by a P-CAV system (see FIGS. 2(b) and 2(c) and FIGS. 4). As a specific method by the P-CAV system, for example, an initialization method may be mentioned wherein the rotational speed is constant at R0 from the innermost circumferential position in the initial crystallization area in the recording layer of a recording medium toward the outer circumferential direction to a predetermined radial direction position of the recording medium, and the scanning linear velocity is constant from the above predetermined radial direction position to the outermost circumferential position in the initial crystallization area in the recording layer (see FIG. 2(c) and FIGS. 4)

Further, the linear velocity V1 of the beam spot at the above predetermined radial direction position on the optical information recording medium is preferably the maximum linear velocity Vmax as defined to satisfy the following requirements.

(Requirements which Maximum Linear Velocity Should Satisfy)

(i) A recording layer formed on an optional track in the initial crystallization area is initially crystallized at an optional linear velocity.

(ii) Recording is carried out twice on the above track. Here, the second recording corresponds to overwriting on the optical information recording medium on which recording is carried out once.

(iii) The jitter J2 of recording marks formed after the second recording is measured.

(iv) Recording is further carried out 8 times (totally 10 recordings including the previous two recordings), and the jitter J10 of recording marks formed after the eighth recording is measured.

(v) The above (i) to (iv) are repeatedly carried out by changing the linear velocity.

(vi) The linear velocity at which J2/J10 as determined from the jitters J2 and J10 obtained at the respective linear velocities will be at most 1.6, is taken as the maximum linear velocity Vmax.

Vmax can be set in accordance with the above method of setting the maximum rotational speed Rmax. Vmax is preferably set to be a value at which J2/J10 will be smallest within a range of J2/J10≦1.6.

As a specific example of the above P-CAV system, the following method may be mentioned. Namely, the rotational speed is set to be the maximum rotational speed of an initialization device at the innermost circumference, and by maintaining the rotational speed constant in a certain area, the linear velocity is increased toward the outer circumference. In a case where the linear velocity reaches a linear velocity at which J2/J10 is smallest within the radius of the disk, the CLV system is employed after the radial position to keep the minimum value of J2/J10.

[I] Initial Crystallization at Velocity Exceeding the Upper Limit of Erasing Linear Velocity of Optical Information Recording Medium

In the present invention, in the initial crystallization step, the maximum linear velocity employed when the recording layer is initially crystallized is preferably at least the maximum linear velocity at which recording marks in an amorphous state formed on the optical information recording medium can be erased. That is, the maximum linear velocity at which the recording medium is initially crystallized is preferably at least the maximum linear velocity at which the amorphous marks on the medium can be erased.

Heretofore, for setting the scanning linear velocity at the time of initial crystallization, it has been S common to set the scanning linear velocity at the time of initial crystallization to be the same as LVmax or slightly lower, which is the maximum linear velocity at which amorphous marks of the optical information recording medium after initialization can be erased.

Here, LVmax is the maximum linear velocity at which the erase ratio exceeds 20 dB, in a case where amorphous marks are recorded on an optical information recording medium and then a recording focused light beam set at the erasing power is applied in a direct current fashion by changing the linear velocity. When overwriting is carried out at a recording linear velocity higher than LVmax, unerased marks will remain, thus remarkably decreasing the recording quality. Thus, LVmax can be said to be the maximum linear velocity at which overwriting is possible.

The unerased marks indicate two phenomena i.e. a phenomenon that amorphous marks cannot completely be recrystallized and remain, and a phenomenon that the recording layer is melted by the erasing power, whereby it cannot completely be recrystallized and an amorphous region is formed again. Particularly, the latter phenomenon is called re-formation of amorphous state, which is a phenomenon that no recrystallization takes place but an amorphous state is formed by application of a recording focused beam at an erasing power intended for erasing by recrystallization.

Heretofore, for initialization of a disk-shape recording medium, it has been common that the scanning linear velocity at the time of initial crystallization is at most LVmax over the entire area of the disk. With respect to melt initialization also, no re-formation of an amorphous state has occurred, and recrystallization has occurred over the entire area and a favorable initially crystalline state has been obtained so long as the requirement is satisfied. On the other hand, if the scanning linear velocity at the time of initial crystallization is higher than LVmax, re-formation of an amorphous state has tended to occur.

On the other hand, it was found that in the recording method of the present invention, no re-formation of an amorphous state takes place, and a better initially crystalline state can be obtained even when the scanning linear velocity at the time of initial crystallization is LVmax or higher, particularly on an optical information recording medium of which LVmax is substantially 20 m/s.

As a specific example of the optical information recording medium of which the LVmax is substantially 20 m/s, an example may be mentioned wherein the composition of the recording layer is the above-described Geₓ(In_{w}Sn_{1-w})_{y}Te_{z}Sb_{1-x-y-z}. Here, the Sb content is higher than any of the Ge content, the In content, the Sn content and the Te content, and x, y, z and w representing the atomicity ratio satisfy the following (i) to (vi):
0≦x≦0.3 (i)
0.07≦y−z (ii)
w×y−z≦0.1 (iii)
0≦z (iv)
(1−w)×y≦0.35 (v)
0.35≦1−x−y−z (vi)
[J] Number and Width of Zones

In a case where initialization is carried out employing zones in e.g. the above-explained CAV, ZCAV or ZCLV system, setting of zones is carried out as follows.

Namely, the number of zones is usually at least 2, preferably at least 3. Further, the number of zones is usually at most 50, preferably at most 30, more preferably at most 10. Within the above range, initialization can be carried out without complicated control.

Further, the width of one zone is usually at least 1 mm, preferably at least 2 mm, and it is usually at most 20 mm, preferably at most 10 mm, depending upon the size of the recording medium. Within the above range, initialization can be carried out without complicated control.

However, in the case of the P-CAV system, since there is an area in which the linear velocity is constant, setting of zones is carried out as follows.

Namely, the number of zones is usually at least 2, preferably at least 3. Further, the number of zones is usually at most 50, preferably at most 30, more preferably at most 10. Within the above range, initialization can be carried out without complicated control.

Further, the width of one zone is usually at least 1 mm, preferably at least 2 mm, and it is usually at most 35 mm, depending upon the size of the recording medium. Within the above range, initialization can be carried out without complicated control.

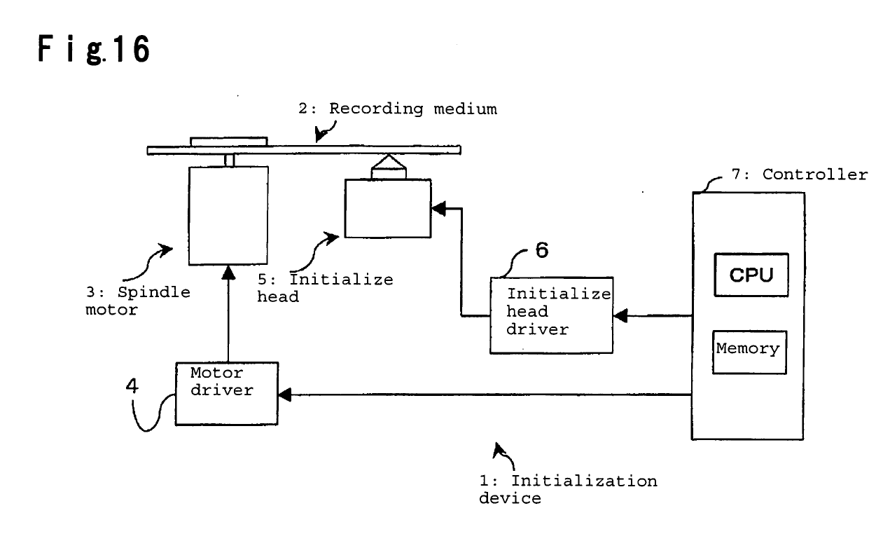

(3) Initialization Device

[A] Now, the initialization device of the present invention will be described with reference to FIG. 16.

As shown in FIG. 16, the present initialization device 1 is a device to initially crystallize a recording layer on a recording medium 2 having a phase-change type recording layer on a disk-shape substrate, and comprises a spindle motor 3 for rotatingly driving the recording medium 2, a motor drive 4 for driving the spindle motor 3, an initialize head (laser head) 5, an initialize head driver 6 for driving the initialize head 5, and a controller 7 (which is provided with CPU and a memory, for example) for controlling each device.

Here, the initialize head 5 is constituted to be equipped with e.g. a laser diode, or an actuator employed for focusing and tracking. Further, the initialize head driver 6 is constituted to have a laser driver (laser diode driver) for driving laser diode and a driver for driving the actuator.

Further, the controller 7 executes control of the scanning linear velocity in the above-described initial crystallization step, the control of the intensity of the focused beam (laser beam), the control of the rotational speed of the spindle motor, etc.

[B] Specifically, the controller 7 controls the spindle motor 3 and the initialize head 5 to scan the recording medium in the circumferential direction with a beam spot formed by irradiating the recording layer with a laser beam (focused beam). Particularly in the present invention, the controller 7 controls the scanning linear velocity at the time of scanning the recording medium in the circumferential direction with a beam spot to increase toward an outer circumferential portion of the recording medium 2.

Here, the controller 7 is constituted so that the intensity of the focused beam is increased as the scanning linear velocity is increased. And the entire initial crystallization area is crystallized.

Further, it is also preferred to constitute the controller 7 so that the rotational speed R0 per unit time of the recording medium will be constant. The requirements which R0 should satisfy are as described above.

[C] Further, it is also preferred to constitute the controller 7 so that the recording medium is rotated based on the rotational speed R0 set to satisfy the following requirements.

(i) A plurality of recording media are prepared, and one of the recording media is rotated at an optional rotational speed to initially crystallize at least the recording layer formed on the innermost circumferential track in the recording area of the recording medium.

(ii) Recording is carried out twice on the innermost circumferential track.

(iii) The jitter J2 of recording marks formed after the second recording is measured.

(iv) Recording is further carried out eight times, and the jitter J10 of recording marks formed after the eighth recording is measured.

(v) On another recording medium, initial crystallization is carried out at a rotational speed different from the rotational speed in the above (i), and then the above (ii) to (iv) are carried out.

(vi) The operation (v) is carried out on the other recording media.

(vii) The relation between the rotational speed at the time of initial crystallization and J2/J10 determined from the jitters J2 and J10 obtained from the recording media initially crystallized at the respective rotational speeds, is obtained. Then, R0 is set so that J2/J10 will be at most 1.6.

[D] Further, it is preferred that the initial crystallization area is divided into a plurality of zones along the radial direction of the recording medium, and that the controller 7 is constituted so that the intensity of the focused beam to be applied in each zone is constant and the intensity of the focused beam is increased toward the outer circumferential zone of the recording medium. In a case where initial crystallization of the recording layer is carried out, it is also preferred to constitute the controller 7 so that the intensity of the focused beam in each zone is controlled based on the intensity of the focused beam in each zone set to satisfy the following requirements.

(i) In each zone in the recording area of an optical information recording medium obtained by means of initial crystallization, recording is carried out twice on each of one track in the vicinity of the innermost circumference, one track in the vicinity of the center portion and one track in the vicinity of the outermost circumference, and the jitter J2inzcav after the second recording at the one track in the vicinity of the innermost circumference, the jitter J2outzcav after the second recording at the one track in the vicinity of the outermost circumference and the jitter J2midzcav after the second recording at the one track in the vicinity of the center portion are measured.

(ii) Recording is further carried out eight times on the one track in the vicinity of the center portion, and the jitter J10midzcav after the tenth recording is measured.

(iii) J2inzcav, J2outzcav, J2midzcav and J10midzcav measured in the above (i) and (ii) satisfy the following requirements:
J2inzcav/J10midzcav≦1.6
J2midzcav/J10midzcav≦1.6
J2outzcav/J10midzcav≦1.6

[E] Further, it is preferred that the initial crystallization area is divided into a plurality of zones along the radial direction of the recording medium, and that the controller 7 is constituted so that the intensity of the focused beam to be applied to each zone is constant and the intensity of the focused beam is increased toward the outer circumferential zone of the recording medium. Here, it is preferred to control the intensity of the focused beam in each zone based on the intensity of the focused beam in each zone set to satisfy the following requirements.

(i) In each zone in the recording area of an optical information recording medium obtained by means of initial crystallization, recording is carried out once on each of one track in the vicinity of the innermost circumference, one track in the vicinity of the center portion and one track in the vicinity of the outermost circumference, and the reflectivity Ref1inzcav at the one track in the vicinity of the innermost circumference, the reflectivity Ref1midzcav at the one track in the vicinity of the center portion and the reflectivity Ref1outzcav at the one track in the vicinity of the outermost circumference after the first recording are measured.

(ii) Recording is further carried out nine times on each track, and the reflectivity Ref10inzcav at the one track in the vicinity of the innermost circumference, the reflectivity Ref10midzcav at the one track in the vicinity of the center portion and the reflectivity Ref10outzcav at the one track in the vicinity of the outermost circumference after the tenth recording are measured.

(iii) Ref1inzcav, Ref1midzcav, Ref1outzcav, Ref10inzcav, Ref10midzcav and Ref10outzcav measured in the above (i) and (ii) satisfy the following requirements:
|Ref1inzcav−Ref1outzcav|/Ref1midzcav≦0.05
|Ref10inzcav−Ref1inzcav|/Ref10inzcav≦0.05
|Ref10midzcav−Ref1midzcav|/Ref1midzcav≦0.05
|Ref10outzcav−Ref1outzcav|/Ref10outzcav≦0.05

[F] Further, it is also preferred to constitute the controller 7 as follows. Namely, with respect to adjacent two zones, the zone at the inner circumferential side is represented as zone A and the zone at the outer circumferential side is represented as zone B. Further, the initialize focused beam intensity for the zone A is represented as Pin and the initialize focused beam intensity for the zone B is represented as Pout. Further, the intensity of the focused beam is set so that the above Pin and Pout, and the minimum initialize laser intensity Pjmin and the maximum initialize laser intensity PJmax measured by the following method satisfy the following relation:
Pjmin≦Pin≦Pout≦PJmax

The controller 7 is constituted to control the intensity of the focused beam based on the above setting.

(Requirements which Maximum Initialize Laser Intensity PJmax and Minimum Initialize Laser Intensity Pjmin Should Satisfy)

The minimum value and the maximum value of the laser intensity at which J2zoneAout, J2zoneBin and J10zoneAmid satisfy the following relations are taken as Pjmin and Pjmax, respectively:
J2zoneAout/J10zoneAmid≦1.6
J2zoneBin/J10zoneAmid≦1.6
where J2zoneAout is the jitter when recording is carried out twice on one track in the vicinity of the outermost circumference in the zone A in the above optical information recording medium, J10zoneAmid is the jitter when recording is carried out ten times on one track in the vicinity of the center portion in the zone A in the above optical information recording medium, and J2zoneBin s is the jitter when recording is carried out twice on one track in the vicinity of the innermost circumference in the zone B in the above optical information recording medium.

[G] It is also preferred to constitute the controller 7 as follows. Namely, with respect to adjacent two zones, the zone at the inner circumferential side is represented as zone A, and the zone at the outer circumferential side is represented as the zone B. Further, the initialize focused beam intensity for the zone A is represented as Pin, and the initialize focused beam intensity for the zone B is represented as Pout. The intensity of the focused beam is set so that the above Pin and Pout, and the minimum initialize laser intensity PRmin and the maximum initialize laser intensity PRmax measured by the following method satisfy the following relation:
PRmin≦Pin≦Pout≦PRmax
The controller 7 is constituted to control the intensity of the focused beam based on the above setting.
(Requirements which Maximum Initialize Laser Intensity PRmax and Minimum Initialize Laser Intensity PRmin Should Satisfy)

The minimum value and the maximum value of the laser intensity at which the following relation is satisfied, are taken as PRmin and Prmax, respectively:
|RefzoneAout−RefzoneBin|/RefzoneAmid≦0.05
where RefzoneAout is the reflectivity when recording is carried out once on one track in the vicinity of the outermost circumference in the zone A in the above optical information recording medium, RefzoneAmid is the reflectivity when recording is carried out once on one track in the vicinity of the center portion in the zone A in the above optical information recording medium, and RefzoneBin is the reflectivity when recording is carried out once on one track in the vicinity of the innermost circumference in the zone B in the above optical information recording medium.

[H] It is also preferred that the initial crystallization area is divided into a plurality of zones along the radial direction of the recording medium, and that the controller 7 is constituted so that the rotational speed at the innermost circumferential position at the respective zones is constant, and the scanning linear velocity is constant from the innermost circumference and the outermost circumference in each zone. It is also preferred to constitute the controller 7 so that in a case where the recording layer is initially crystallized, the intensity of the focused beam in each zone is controlled based on the intensity of the focused beam in each zone set to satisfy the following requirements.

(i) In each zone in the recording area of an optical information recording medium obtained by means of initial crystallization, recording is carried out twice on one track in the vicinity of the center portion, and the jitter J2midzclv after the second recording is measured.

(ii) Recording is further carried out eight times on the one track in the vicinity of the center portion, and the jitter J10midzclv after the tenth recording is measured.

(iii) The intensity of the focused beam in each zone is set so that J2midzclv and J10midzclv measured in the above (i) and (ii) satisfy the following requirement:
J2midzclv/J10midzclv≦1.6

[I] Further, it is preferred that the initial crystallization area is divided into a plurality of zones along the radial direction of the recording medium, and that the controller 7 is constituted so that the rotational speed at the innermost circumferential position in the respective zones is constant, and the scanning linear velocity is constant from the innermost circumference to the outermost circumference in each zone. It is preferred to control the intensity of the focused beam in each zone based on the intensity of the focused beam in each zone set to satisfy the following requirements.

(i) In each zone in the recording area of the optical information recording medium obtained by means of initial crystallization, recording is carried out once on one track in the vicinity of the center portion, and the reflectivity Ref1midzclv is measured.

(ii) Recording is further carried out nine times on the one track in the vicinity of the center portion, and the reflectivity Ref10midzclv after the tenth recording is measured.

(iii) Ref1midzclv and Ref10midzclv measured in the above (i) and (ii) satisfy the following requirement:
|Ref10midzclv−Ref1midzclv|/Ref10midzclv≦0.05

[J] It is also preferred to constitute the controller 7 as follows. Namely, with respect to adjacent two zones among the plurality of zones, the zone at the inner circumferential side is represented as zone A, and the zone at the outer circumferential side is represented as zone B. Further, the initialize focused beam intensity for the zone A is represented as Pin and the initialized focused beam intensity for the zone B is represented as Pout. The controller 7 is constituted so as to control the intensity of the focused beam based on the intensity of the focused beam set to satisfy the following requirements.

(i) Two recording media are prepared. Using one recording medium, the zone A is initially crystallized at the initialize focused beam intensity Pin and the Zone B is initially crystallized at the initialize focused beam intensity Pout to obtain an optical information recording medium. Recording is carried out ten times on one track in the vicinity of the center portion of the zone A in the optical information recording medium and the jitter J10zoneAPin after the tenth recording is measured, and recording is carried out ten times on one track in the vicinity of the center portion in the zone B is carried out and the jitter J10zoneBPout after the tenth recording is measured.

(ii) Using the other recording medium, the zone A is initially crystallized at the initialize focused beam intensity Pout and the zone B is initially crystallized at the initialize focused beam intensity Pin to obtain an optical information recording medium. Recording is carried out twice on the one track in the vicinity of the center portion in the zone A of the optical information recording medium and the jitter J2zoneAPout after the second recording is measured, and recording is carried out twice on the one track in the vicinity of the center portion of the zone B and the jitter J2zoneBPin after the second recording is measured.

(iii) J10zoneAPin and J2zoneAPout measured in the above (i) and (ii) satisfy the following requirement:
J2zoneAPout/J10zoneAPin≦1.6
and J10zoneBPout and J2zoneBPin measured in the above (i) and (ii) satisfy the following requirement:
J2zoneBPin/J10zoneBPout≦1.6

[K] Further, it is also preferred to constitute the controller 7 as follows. Namely, with respect to adjacent two zones among the above plurality of zones, the zone at the inner circumferential side is represented as zone A, and the zone at the outer circumferential side is represented as zone B. Further, the initialize focused beam intensity for the zone A is represented as Pin, and the initialize focused beam intensity for the zone B is represented as Pout. The controller 7 is constituted to control the intensity of the focused beam based on the intensity of the focused beam set to satisfy the following requirements.

(i) Two recording media are prepared, and using one recording medium, the zones A and B are initially crystallized at the initialize focused beam intensity Pin to obtain an optical information recording medium. Further, recording is carried out once on one track in the vicinity of the center portion in the zone A of the optical information recording medium and the reflectivity Ref1zoneAPin after the first recording is measured, and recording is carried out once on one track in the vicinity of the center portion in the zone B and the reflectivity Ref1zoneBPin after the first recording is measured.

(ii) Using the other recording medium, the zone A is initially crystallized at the initialize focused beam intensity Pout to obtain an optical information recording medium. Further, recording is carried out once on one track in the vicinity of the center portion in the zone A of the optical information recording medium and the reflectivity Ref1zoneAPout after the first recording is measured.

(iii) Ref1zoneAPin, Ref1zoneBPin and Ref1zoneAPout measured in the above (i) and (ii) satisfy the following relation:
|Ref1zoneAPout−Ref1zoneBPin|/Ref1zoneAPin≦0.05

[L] Further, it is also preferred to constitute the controller 7 as follows. Namely, the minimum value and the maximum value of the focused beam intensity Pin for the zone A are represented as Pinmin and Pinmax, respectively, and the minimum value and the maximum value of the focused beam intensity Pout for the zone B are represented as Poutmin and Poutmax, respectively. The focused beam intensity Pin is gradually increased within a range of from Pinmin to Pinmax toward the outer circumferential side in the zone A. The focused beam intensity Pin at the outermost circumference in the zone A is represented as PinzoneAout. Similarly, the focused beam intensity Pout is gradually increased within a range of from Poutmin to Poutmax toward the outer circumferential side in the zone B. The focused beam intensity Pout at the innermost circumference in the zone B is represented as PoutzoneBin. The controller 7 is constituted to control the intensity of the focused beam based on the intensity of the focused beam set so that PoutzoneBin and PinzoneAout satisfy the following relation:
PoutzoneBin=PinzoneAout
However, although the relation “PoutzoneBin=PinzoneAout”is satisfied, an error of about±10% between PoutzoneBin and PinzoneAout is allowable.

[M] Further, it is also preferred to constitute the controller 7 as follows. Namely, the minimum value and the maximum value of the focused beam intensity Pin for the zone A are represented as Pinmin and Pinmax, respectively, and the minimum value and the maximum value of the focused beam intensity Pout for the zone B are represented as Poutmin and Poutmax, respectively. The focused beam intensity Pin is gradually increased within a range of from Pinmin to Pinmax toward the outer circumferential side in the zone A. The focused beam intensity Pin at the outermost circumference in the zone A is represented as PinzoneAout. Similarly, the focused beam intensity Pout is gradually increased within a range of from Poutmin to Poutmax toward the outer circumferential side in the zone B. The focused beam intensity Pout at the innermost circumference in the zone B is represented as PoutzoneBin. The controller 7 is constituted to control the intensity of the focused beam based on the intensity of the focused beam set so that PoutzoneBin and PinzoneAout satisfy the following relation:
PoutzoneBin>PinzoneAout
and the difference between PoutzoneBin and PinzoneAout will be smallest.

[N] Further, it is also preferred to constitute the controller 7 as follows. The rotational speed R0 per unit time is constant from the innermost circumferential position in the initial crystallization area toward the outer circumferential side of the recording medium to a predetermined radial direction position, and the scanning linear velocity is constant from the predetermined radial direction position to the outermost circumferential position in the initial crystallization area of the recording media. The requirements which R0 should satisfy are as described above.

[O] Here, it is preferred to set the maximum linear velocity Vmax at the above predetermined radial direction position to satisfy the following requirements.

(i) The recording layer formed on an optional track in the initial crystallization area is initially crystallized at an optional linear velocity.

(ii) Recording is carried out twice on the track.

(iii) The jitter J2 of recording marks formed after the second recording is measured.

(iv) Recording is further carried out eight times, and the jitter J10 of recording marks formed after the eighth recording is measured.

(v) The above (i) to (iv) are repeated by changing the linear velocity. (vi) The linear velocity at which J2/J10 determined from the jitters J2 and J10 obtained at the respective linear velocities will be at most 1.6, is taken as the maximum linear velocity Vmax.

[P] Further, it is also preferred that the maximum linear velocity to be employed when the recording layer is initially crystallized is at least the maximum linear velocity at which amorphous marks on the optical information recording medium can be erased.

[Q] Further, for the initialization device of the present invention, the focused beam is preferably a laser beam.

[R] Others

The setting of the rotational speed, the setting of the intensity of the focused beam and the setting of the linear velocity at the predetermined radial direction position in the above [C] to [M] and [O] may be preliminarily carried out before the initial crystallization step, the results are stored in the memory of the controller 7, and they are read from the memory in the initial crystallization step to carry out control of the rotational speed of the spindle motor, the control of the intensity of the focused beam (preferably laser beam) and control of the velocity of the scanning line.

Here, in the initial crystallization step, the setting of the rotational speed, the setting of the intensity of the focused beam and the setting of the linear velocity in the predetermined radial direction position in the above [C] to [M], [O] and [P] may be carried out, for example, by the following method. Namely, the setting of the rotational speed and the like is carried out by another device such as an evaluation device, and the results are input into the initialization device. Based on the results, the controller 7 carries out control of the rotational speed of the spindle motor, the control of the intensity of the focused beam (laser beam) and the control of the velocity of the scanning line. Further, as another method, the following method may, for example, be mentioned. Namely, the rotational speed, the intensity of the focused beam and the linear velocity at the predetermined radial direction position of the above [C] to [M] and [O] set by another device such as an evaluation device, are transmitted to the initialization device. Based on these values, the controller 7 carries out the control of the rotational number of the spindle motor, the control of the intensity of the focused beam (laser beam) and the control of the velocity of the scanning line. In such a case, the initial crystallization step is automatically carried out by cooperative processing of the initialization device with another device such as an evaluation device.

### EXAMPLES

Now, the present invention will be described in further detail with reference to Examples. However, the present invention is not limited to the following Examples.

### Example 1

(A) Step of Obtaining Recording Medium

As a substrate, a disk-shape polycarbonate substrate having the following shape was employed.

Track pitch: 0.74 μm

Groove width: 0.32 μm

Groove depth: 32 nm

Track shape: spiral

Thickness: 0.6 mm

On this substrate, by sputtering employing an Ar gas, a 60 nm (ZnS)₈₀(SiO₂)₂₀ protective layer, a 2 nm Y₂O₂S layer, a 12 nm Ge_{4.7}In_{10.1}Sb_{50.1}Sn_{21.2}Te_{13.9} recording layer, a 14 nm Y₂O₂S layer, a 2 nm Ta interfacial layer, a 200 nm Ag reflective layer and an about 4 μm ultraviolet-curable resin layer were formed in this order. The Ta layer is an interfacial layer to prevent S from being diffused into the Ag reflective layer.

For deposition of the respective layers, the layers were laminated in order by sputtering without releasing the vacuum. Here, the ultraviolet-curable resin layer was formed by spin coating. Then, the same substrate having a thickness of 0.6 mm having no layer formed thereon, was bonded to the above substrate by means of an adhesive so that the above recording layer side faced inside to obtain a disk (recording medium) having a thickness of 1.2 mm.

For the recording medium, the composition and the layer structure are selected so that overwriting is possible at from about 8× to about 10× speed of the standard linear velocity for DVD of 3.49 m/s (1× speed), in a case where it is used as a rewritable DVD after initial crystallization step. Namely, the upper limit of the linear velocity at which the erase ratio is at least 20 dB at the time of irradiation with an erasing power in a direct current fashion, is from 8× to 10× speed.

In the present Example, a plurality of such recording media were prepared, and initialization was carried out under various initialization conditions, and the performance of the obtained optical information recording media were evaluated.

(B) Initialization Step

The following initialization conditions and initialization method were employed.

(Initialization Conditions)

An elliptic laser beam having a wavelength of 810 nm, a major axis of about 75 μm and a minor axis of about 1 μm was employed as a focused beam. The laser beam intensity at the time of the initialization step was changed within a range of from 1,000 to 4,000 mW. The maximum rotational speed of the initialization device employed was 8,200 rpm.

(Initialization Method)

CAV Initialization

Initialization was carried out on a recording medium divided into a plurality of zones in the radial direction, at a constant rotational speed (R0) from the inner circumference to the outer circumference with a feed of the laser head to each zone of 50 μm per one rotation of the disk by changing the laser intensity within a range of from 1,200 to 3,600 mW. ZCLV initialization

Initialization was carried out on a recording medium divided into a plurality of zones in the radial direction at a constant rotational speed R0 at the innermost circumference in the respective zones, at a constant linear velocity in each zone, with a feed of the laser head to each zone of 50 μm per one rotation of the disk, by changing the laser intensity within a range of from 1,200 to 3,600 mW.

The scanning linear velocity V (m/s) at the time of initialization can be calculated from the formula:
V(m/s)=(R0/60)×2×3.14×(r/1,000)
where R0 (rpm) is the disk rotational speed, and the r (mm) is the radial position for initialization.

As specific examples, under the following conditions,
12.3 m/s at 5,000 rpm at 23 mm
19.7 m/s at 8,200 rpm at 23 mm
15.0 m/s at 8,200 rpm at 35 mm
34.3 m/s at 8,200 rpm at 40 mm
36.9 m/s at 8,200 rpm at 43 mm
41.2 m/s at 8,200 rpm at 48 mm
42.9 m/s at 8,200 rpm at 50 mm
49.8 m/s at 8,200 rpm at 58 mm

In the case of 8,200 rpm, at a portion outside the radius of about 40 mm, the scanning linear velocity is at least about 10× speed of the standard linear velocity for DVD. The present recording medium provides favorable recording characteristics when initialized at a linear velocity of at least 10× speed for DVD, as described hereinafter.

(C) Method of Evaluating Optical Information Recording Medium

(Evaluation Device)

Device: ODU1000 (manufactured by Pulstec Industrial Co., Ltd.)

Focused beam: Laser beam having a wavelength of 650 nm and NA=0.65.

(Evaluation Method)

At a standard linear velocity of 3.49 m/s which is the standard linear velocity for DVD, at a reference clock frequency of 26.2 MHz (reference clock period Tₛ=38.2 ns), recording of EFM+modulation signal was carried out at 8× speed, and then the clock jitter was measured at the standard linear velocity.

Here, the clock jitter is a value determined as follows. Namely, retrieving signals are made to pass through an equalizer and an LPF, followed by conversion to binary signals by a slicer. A standard deviation (jitter) of the difference in time against PLL clock of the leading edge and the trailing edge of the binary signals is obtained. The standard deviation is normalized by the clock period T to obtain a clock jitter.

The reflectivity was determined as follows. Namely, the recording waveform recorded by the above method was output to an oscilloscope. The average of the maximum 14T signal amplitude at the standard linear velocity was directly read from the oscilloscope to determine the reflectivity.

(D) Determination of Maximum Rotational Speed (Rmax, R0)

CAV initialization was carried out on a recording medium at a rotational speed R0 of the initialization device of 5,000 rpm. The jitter (J2) after second recording and the jitter (J10) after tenth recording in a track at a radius of 23 mm (the innermost circumferential track in a recording area in the initial crystallization area to be initially crystallized of the recording medium) of the obtained optical information recording medium were measured.
J2=Dow1jitter=15.19%
J10=Dow10jitter=8.26%
J2/J10=1.84

Then, another recording medium was prepared, and CAV initialization was carried out on this recording medium at a rotational speed R0 of the initialization device of 8,200 rpm (maximum rotational speed of the initialization device). The jitter (J2) after second recording and the jitter (J10) after tenth recording in a track at a radius of 23 mm (the innermost circumferential track in a recording area in the initial crystallization area to be initially crystallized of the recording medium) of the obtained optical information recording medium were measured.
J2=Dow1jitter=11.07%
J10=Dow10jitter=8.22%
J2/J10=1.35

By the initialization device used in this Example, the rotational speed could not be made higher than 8,200 rpm, but there is a possibility that J2/J10 will be smaller (recording characteristics of an optical information recording medium will be favorable) if CAV initialization is carried out at a higher rotational speed than 8,200 rpm. However, considering recording quality in practical use, J2/J10 of at most 1.6 is sufficient, and accordingly the maximum rotational speed Rmax (R0) was set at 8,200 rpm in the present invention.

(E) Setting of initialize laser intensity in ZCAV zone (setting by jitter)

Nine recording media were prepared, and CAV initialization was carried out on the respective recording media at different initialize laser intensities at a rotational speed R0 of the initialization device of 8,200 rpm. The initialize laser intensity was changed within a range of from 1,200 to 3,600 mW.

A position at a radius of from 40 to 50 mm in each of the obtained nine optical information recording media (recording media initialized under initialization conditions differing in the initialize laser intensity) was employed as one zone. The jitter J2inzcav after second recording in one track in the vicinity of the innermost circumference, the jitter J2outzcav after second recording in one track in the vicinity of the outermost circumference and the jitter J2midzcav after second recording in one track in the vicinity of the center portion in this zone were measured.

Further, recording was further carried out eight times (totally ten recordings) on the one track in the vicinity of the center portion, and the jitter J10midzcav after the tenth recording was measured.

Then, Jinzcav/J10midzcav, J2midzcav/J10midzcav and J2outzcav/J10midzcav of each of the optical information recording media were calculated.

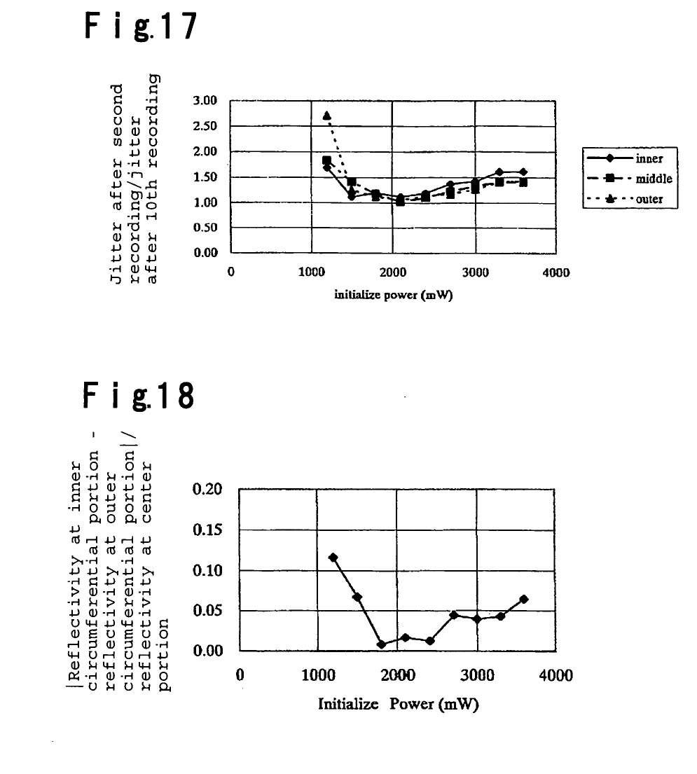

The relation between the calculation results thus obtained and the initialize laser intensity is shown in FIG. 17. In the drawing, the experimental results indicated by “inner” represent the change of “J2inzcav/J10midzcav” relative to the initialize laser intensity. Further, in the drawing, the experimental results indicated by “middle” represent the change of “J2midzcav/J10midzcav” relative to the initialize laser intensity. Likewise, the experimental results indicated by “outer” in the drawing represent the change of “J2outzcav/J10midzcav” relative to the initialize laser intensity.

From the results shown in the drawing, it is understood that the following relations:
J2inzcav/J10midzcav≦1.6
J2midzcav/J10midzcav≦1.6
J2outzcav/J10midzcav≦1.6
are securely satisfied when the initialize laser intensity is set at from 1,500 to 3,000 mW. Further, it is understood that the following relations:
J2inzcav/J10midzcav≦1.3
J2midzcav/J10midzcav≦1.3
J2outzcav/J10midzcav≦1.3
are securely satisfied when the initialize laser intensity is set at from 1,800 to 2,400 mW.
(F) Setting of Initialize Laser Intensity in ZCAV Zone (Setting by Reflectivity)

Nine recording media were prepared, and CAV initialization was carried out on the respective recording media at different initialize laser intensities at a rotational speed R0 of the initialization device of 8,200 rpm. The initialize laser intensity was changed within a range of from 1,200 to 3,600 mW.

A position at a radius of from 40 to 50 mm in each of the obtained nine optical information recording media (recording media initialized under initialization conditions differing in the initialize laser intensity) was employed as one zone. The reflectivity Ref1inzcav in one track in the vicinity of the innermost circumference, the reflectivity Ref1midzcav in one track in the vicinity of the center portion and the reflectivity Ref1outzcav in the vicinity of the outermost circumference after first recording in the above zone were measured. Then, recording was further carried out nine times (totally ten recordings) on each of the tracks, and the reflectivity Ref10inzcav in one track in the vicinity of the innermost circumference, the reflectivity Ref10midzcav in one track in the vicinity of the center portion and the reflectivity Ref10outzcav in one track in the vicinity of the outermost circumference were measured.

Then, |Ref1inzcav−Ref1outzcav|Ref1midzcav of each of the optical information recording media was calculated. The relation between the calculation results thus obtained and the initialize laser intensity is shown in FIG. 18.

From the results shown in the drawing, it is understood that the following relation:
|Ref1inzcav−Ref1outzcav|/Ref1midzcav≦0.05
is securely satisfied when the initialize laser intensity is set within a range of from 1,800 to 3,300 mW. Further, it is understood that the following relation:
|Ref1inzcav−Ref1outzcav|/Ref1midzcav≦0.03
is securely satisfied when the initialize laser intensity is set at from 1,800 to 2,400 mW.

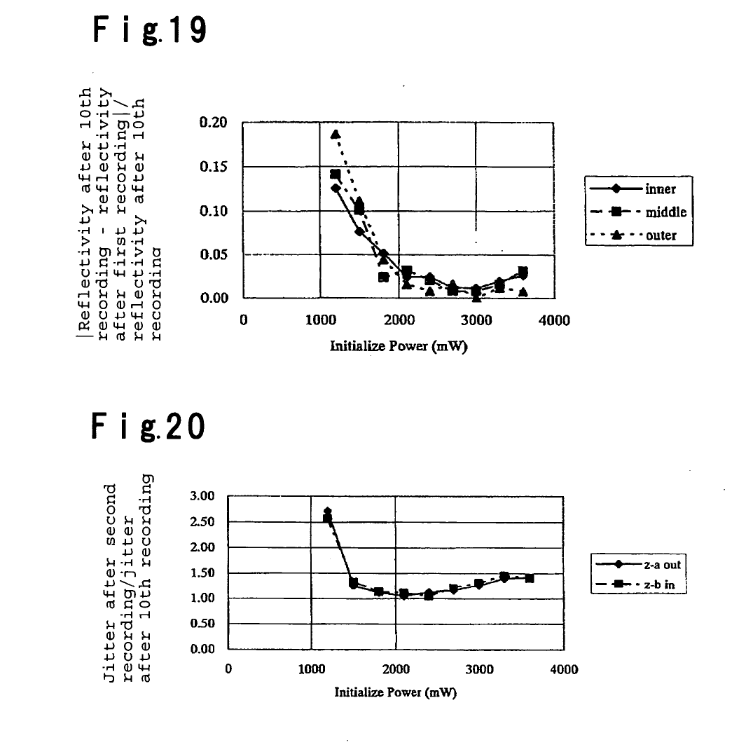

Further, |Ref10inzcav−Ref1inzcav|/Ref10inzcav, |Ref10midzcav−Ref1midzcav|/Ref10midzcav and |Ref10outzcav−Ref1outzcav|/Ref10outzcav of the respective optical information recording media were calculated. The relation between the calculation results thus obtained and the initialize laser intensity is shown in FIG. 19. In the drawing, the experimental results indicated by “inner” mean the change of “|Ref10inzcav−Ref1inzcav|/Ref10inzcav” relative to the initialize laser intensity. Further, in the drawing, the experimental results indicated by “middle” represent the change of “|Ref10midzcav−Ref1midzcav|/Ref10midzcav” relative to the initialize laser intensity. Likewise, the experimental results indicated by “outer” in the drawing represent the change of “|Ref10outzcav−Ref1outzcav|/Ref10outzcav”relative to the initialize laser intensity.

From the results shown in the drawing, it is understood that the following relations:
|Ref10inzcav−Ref1inzcav|/Ref10inzcav≦0.05
|Ref10midzcav−Ref1midzcav|/Ref10midzcav≦0.05
|Ref10outzcav−Ref1outzcav|/Ref10outzcav≦0.05
are securely satisfied when the initialize laser intensity is set at from 2,100 to 3,600 mW.
(G) Setting of Initialize Laser Intensity in Zones in ZCAV (Setting by Jitter and Reflectivity)
(G-1) Setting by Jitter

Nine recording media were prepared, and CAV initialization was carried out on the respective recording media at different initialize laser intensities at a rotational speed R0 of the initialization device of 8,200 rpm. At the time of initialization, a position at a radius of from 40 to 50 mm of each recording medium was employed as zone A, and a position at a radius of from 50 to 58 mm was employed as zone B. The initialize laser intensity Pin at the zone A and the initialize laser intensity Pout in the zone B were changed among the recording media within a range of from 1,200 to 3,600 mW.

With respect to each of the obtained nine optical information recording media, the jitter J2zoneAout when recording was carried out twice on one track in the vicinity of the outermost circumference in the zone A, the jitter J10zoneAmid after recording was carried out ten times on one track in the vicinity of the center portion of the zone A and the jitter J2zoneBin after recording was carried out twice on one track in the vicinity of the innermost circumference in the zone B were measured.

Then, J2zoneAout/J10zoneAmid and J2zoneBin/J10zoneAmid of each of the optical information recording media were calculated. The relation between the calculation results thus obtained and the initialize laser intensity is shown in FIG. 20.

In the drawing, the experimental results indicated by “z-aout” represent the change of “J2zoneAout/J10zoneAmid” relative to the initialize laser intensity. Likewise, the experimental results indicated by “z-bin” in the drawing represent the change of “J2zoneBin/J10zoneAmid” relative to the initialize laser intensity.

From the results shown in the drawing, it is understood that Pjmin at which the following relations:
J2zoneAout/J10zoneAmid≦1.6
J2zoneBin/J10zoneAmid≦1.6
are securely satisfied is 1,500 mW. Further, it is found that PJmax at which the above requirements are securely satisfied is 3,600 mW.

Further, from the results shown in the drawing, it is understood that Pjmin at which the following relations:
J2zoneAout/J10zoneAmid≦1.3
J2zoneBin/J10zoneAmid≦1.3
are securely satisfied is 1,800 mW. Further, it is understood that PJmax at which the above requirements are securely satisfied is 2,700 mW.

From the above results, it is understood that recording quality of an optical information recording medium in the vicinity of the boundary between the zones A and B will be favorable when the initialize laser intensity Pin for the zone A and the initialize laser intensity Pout for the zone B are set so that Pin≦Pout within a range of from PJmin (1,500 mW, preferably 1,800 mW) and PJmax (3,600 mW, preferably 2,700 mW).

(G-2) Setting by Reflectivity

Nine recording media were prepared, and CAV initialization was carried out on the respective recording media at different initialize laser intensities at a rotational speed R0 of the initialization device of 8,200 rpm. At the time of initialization, a position at a radius of from 40 to 50 mm of each recording medium was employed as zone A. Further, a position at a radius of from 50 to 58 mm was employed as zone B, and the initialize laser intensity Pin at the zone A and the initialize laser intensity Pout at the zone B were changed among the recording media within a range of from 1,200 to 3,600 mW.

With respect to each of the obtained nine optical information recording media, the reflectivity RefzoneAout after recording was carried out once on one track in the vicinity of the outermost circumference in the zone A, the reflectivity RefzoneAmid after recording was carried out once on one track in the vicinity of the center portion in the zone A, and the reflectivity RefzoneBin after recording was carried out once on one track in the vicinity of the innermost circumference in the zone B were measured.

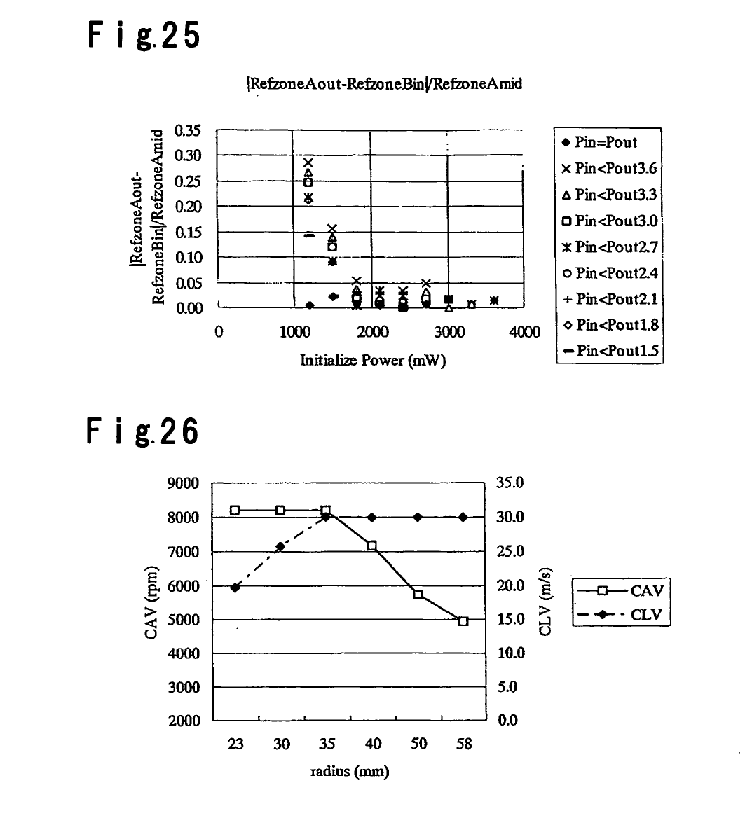

Then, |RefzoneAout−RefzoneBin|/RefzoneAmid within a range of Pin≦Pout of each of the optical information recording media was calculated. The relation between the calculation results thus obtained and the initialize laser intensity is shown in FIG. 25.

In the drawing, the experimental results indicated by “Pin=Pout” represent the change of “|RefzoneAout−RefzoneBin|/RefzoneAmid” in a case where the initialize laser intensities in the respective zones are equal to each other. Likewise, in the drawing, the experimental results indicated by “Pin<Pout3.6” for example represent the change of “|RefzoneAout−RefzoneBin|/RefzoneAmid” in a case where the initialize laser intensity for the zone B is 3,600 mW and the initialize laser intensity Pin is at most 3,600 mW.

From the results shown in the drawing, it is understood that the following relation:
|RefzoneAout−RefzoneBin|/RefzoneAmid≦0.05
is securely satisfied at the entire initialize laser intensity of from 1,200 to 3,600 mW in a case where Pin=Pout.

Further, in the case of Pin≦Pout, it is understood that PRmin at which the following relation:
|RefzoneAout−RefzoneBin|/RefzoneAmid≦0.05
is securely satisfied is at least 2,100 mW.

Further, from the results shown in the drawing, it is understood that PRmin at which the following relation:
RefzoneAout−RefzoneBin|/RefzoneAmid≦0.03
is securely satisfied is at least 3,000 mW.

From the results in the drawing, PRmax seems to be at least 3,600 mW. However, in this Example, PRmax is tentatively considered to be 3,600 mW.

From the above results, it is understood that the recording quality of an optical information recording medium in the vicinity of the boundary between the zones A and B will be favorable when the initialize laser intensity Pin for the zone A and the initialize laser intensity Pout for the zone B are set to be Pin=Pout, or set to satisfy PRmin≦Pin≦Pout≦PRmax relative to PRmin (2,100 mw, preferably 3,000 mW) and PRmax (tentatively 3,600 mW).

(H) Setting of Initialize Laser Intensity in Zone in ZCLV (Setting by Jitter and Reflectivity)

Nine recording media were prepared, and ZCLV initialization was carried out on the respective recording media at different initialize laser intensities at a rotational speed R0 of the initialization device of 8,200 rpm. Specific initialization conditions were as follows.

A position at a radius of from 35 to 43 mm of each recording medium was employed as the zone A, and a position at a radius of from 43 to 48 mm was employed as zone B. The scanning linear velocity for initialization of the zone A was set at 30 m/s, and the scanning linear velocity for initialization of the zone B was set at 37 m/s. By setting these scanning linear velocities, the rotational speed at the innermost circumference in the zone A was 8,200 rpm, the rotational speed at the innermost circumference in the zone B was also 8,200 rpm, and the rotational speed at the innermost circumferential position in the respective zones was constant.

While the scanning linear velocities in the zones A and B were set as mentioned above, initialization was carried out on the prepared nine recording media at different initialize laser intensities within a range of from 1,200 to 3,600 mW.

With respect to each of the obtained optical information recording media, the reflectivity (Ref1midzclv) after first recording, the jitter (J2midzclv) after second recording, the jitter (J10midzclv) after tenth recording and the reflectivity (Ref10midzclv) after tenth recording at a portion in the vicinity of the center portion in each zone were measured.

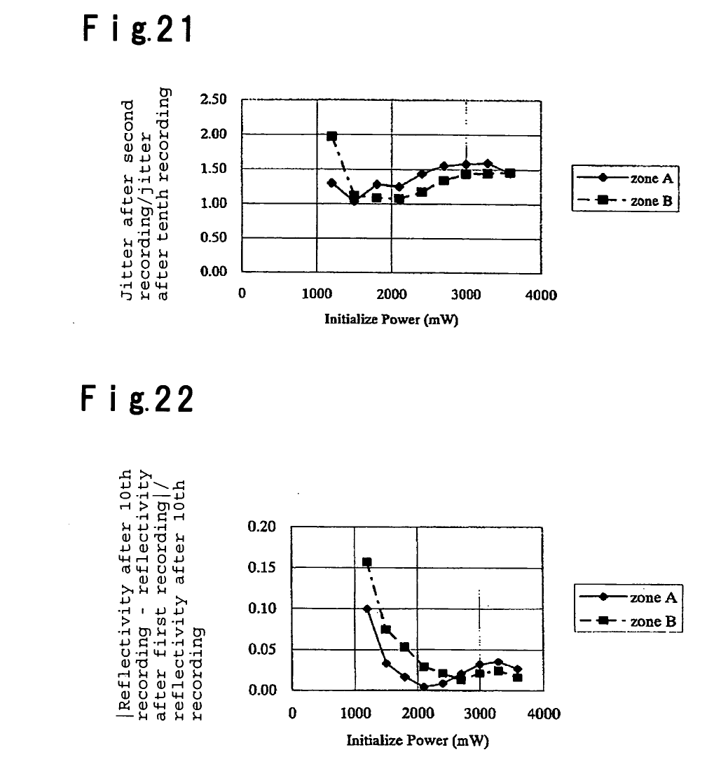

From the obtained data, J2midzclv/J10midzclv and |Ref10midzclv−Ref1midzclv|/Ref10midzclv of each of the optical information recording media were calculated. The relation between the calculation results thus obtained and the initialize laser intensity is shown in FIGS. 21 and 22.

From the results shown in FIG. 21, it is understood that the initialize laser intensity at which the following relation:
J2midzclv/J10midzclv≦1.6
is securely satisfied, is within a range of from 1,200 to 3,300 mW in the zone A and within a range of 1,500 to 3,600 mW in the zone B. Further, it is understood that the initialize laser intensity at which the following relation:
J2midzclv/J10midzclv≦1.3
is securely satisfied, is within a range of from 1,200 to 2,100 mW in the zone A and within a range of from 1,500 to 2,400 mW in the zone B.

Further, from the results shown in FIG. 22, it is understood that the initialize laser intensity at which the following relation:
|Ref10midzclv−Ref1midzclv|/Ref10midzclv≦0.05
is securely satisfied, is within a range of from 1,500 to 3,600 mW in the zone A and within a range of from 1,800 to 3,600 mW in the zone B. Further it is understood that the initialize laser intensity at which the following relation:
|Ref10midzclv−Refmidzclv|/Ref10midzclv≦0.03
is securely satisfied, is within a range of from 1,500 to 3,000 mw in the zone A and within a range of from 2,100 to 3,600 mW in the zone B.

From the results shown in FIGS. 21 and 22, the optimum initialize laser intensity (a value at which the jitter proportion can be made low and at which the reflectivity proportion can also be made low) for the zone A can be estimated at 1,500 mW. Likewise, the optimum initialize laser intensity (a value at which the jitter proportion can be made low and the reflectivity proportion can also be made low) for the zone B can be estimated at 2,100 mW.

(I) Setting of Initialize Laser Intensity in Zones in ZCLV (Setting by Jitter)

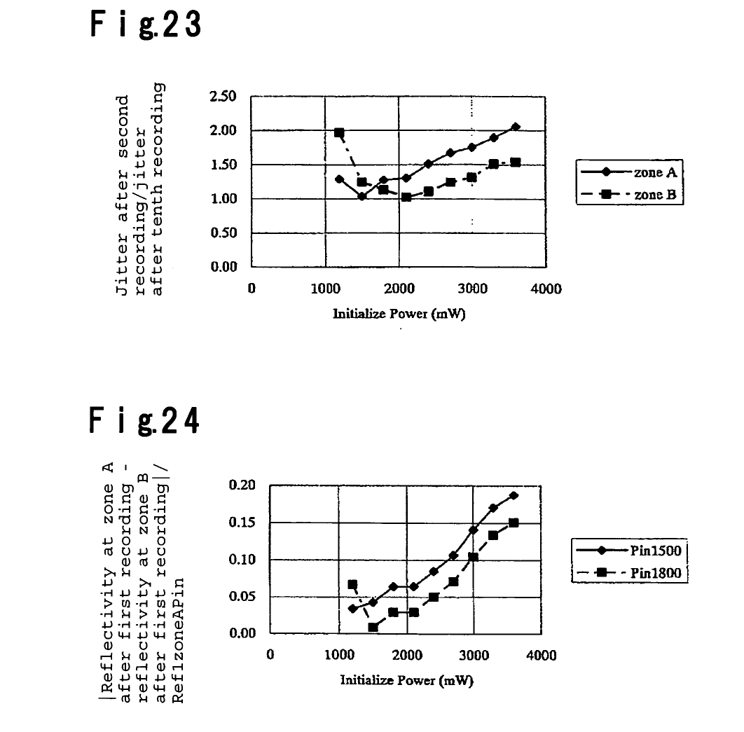

Then, with respect to each of the optical information recording media, {the jitter (hereinafter referred to as J2zoneA) after second recording at a portion in the vicinity of the center portion of the zone A when the laser intensity was changed}/J10zoneAPin, and {the jitter (hereinafter referred to as J2zoneB) after second recording at a portion in the vicinity of the center portion in the zone B when the laser intensity was changed}/J10zoneBPout, were calculated. As J10zoneAPin, the jitter after tenth recording in a case where the zone A was initialized at an initialize laser intensity of 1,500 mW (1,500 mW was taken as Pin′ as the tentative Pin) was employed. Further, as J10zoneBPout, the jitter after tenth recording in a case where the zone B was initialized at an initialize laser intensity of 2,100 mW (2,100 mW was taken as Pout′ as the tentative Pout) was employed. The relation between the calculation results thus obtained and the initialize laser intensity is shown in FIG. 23.

In the drawing, “zone A” represents “J2zoneA/J10zoneAPin”, and “zone B” represents “J2zoneB/J10zoneBPout”.

From the results shown in the drawing, the initialize laser intensity at which the following relations:
J2zoneA/J10zoneAPin≦1.6
J2zoneB/J10zoneBPout≦1.6
are securely satisfied is within a range of from 1,500 to 2,400 mW. Namely, the relations J2zoneA/J10zoneAPin≦1.6 and J2zoneB/J10zoneBPout≦1.6 can be achieved either when the zone A is initialized at Pout′ (2,100 mW) or when the zone B is initialized at Pin′ (1,500 mW). Further, from the results shown in the drawing, the initialize laser intensity at which the following relations:
J2zoneA/J10zoneAPin≦1.3
J2zoneB/J10zoneBPout≦1.3
are securely satisfied is within a range of from 1,500 to 1,800 mW. In this case, Pout′ (2,100 mW) is higher than 1,800 mW. Therefore, it may be considered that characteristics after initialization of the zones A and B are likely to be balanced when Pout is set at 1,800 mW.
(J) Setting of Initialize Laser Intensity in Zones in ZCLV (Setting by Reflectivity)

Further, with respect to each of the optical information recording media, the reflectivity (referred to as Ref1zoneA) after first recording at a portion in the vicinity of the center portion in the zone A when the laser intensity was changed, and the reflectivity (referred to as Ref1zoneB) after first recording at a portion in the vicinity of the center portion in the zone B when the laser intensity was changed, were measured, and |Ref1zoneA−Ref1zoneB|/Ref1zoneAPin was calculated.

The reflectivities after first recording in a case where the zone A was initialized at the above obtained 1,500 mW and 1,800 mW as Pin′ were taken as Ref1zoneAPin. The relation between the calculation results thus obtained and the initialize laser intensity is shown in FIG. 24. In the drawing “Pin1500” represents |Ref1zoneA−Ref1zoneB|/Ref1zoneAPin in a case where Ref1zoneAPin at Pin′=1,500 mW was employed. Likewise, in the drawing, “Pin1800” represents |Ref1zoneA−Ref1zoneB|/Ref1zoneAPin in a case where Ref1zoneAPin at Pin′=1,800 mW was employed. In the drawing, “|reflectivity at zone A after first recording−reflectivity at zone B after first recording|” represents |Ref1zoneA−Ref1zoneB|.

From the results shown in the drawing, it is understood that in a case where Pin′ is 1,500 mW, the initialize laser intensity at which the following relation:
|Ref1zoneA−Ref1zoneB|/Ref1zoneAPin≦0.05
is securely satisfied is within a range of from 1,200 to 1,500 mW. Namely, it is understood that in a case where the laser intensity for the zone A is 1,500 mW, the zone B should be initialized at from 1,200 to 1,500 mW.

On the other hand, it is understood that in a case where Pin′ is 1,800 mW, the initialize laser intensity at which the following relation:
|Ref1zoneA−Ref1zoneB|/Ref1zoneAPin≦0.05
is securely satisfied is within a range of from 1,500 to 2,400 mW. Namely, it is understood that in a case where the laser intensity for the zone A is 1,800 mW, the zone B should be initialized at from 1,500 to 2,400 mW.

Further, from the results shown in the drawing, it is understood that in a case where Pin′ is 1,500 mW, the initialize laser intensity at which the following relation:
|Ref1zoneA−Ref1zoneB|/Ref1zoneAPin≦0.03
is securely satisfied is 1,200 mW. Namely, it is understood that in a case where the laser intensity for the zone A is 1,500 mW, the zone B should be initialized at 1,200 mW.

On the other hand, it is understood that in a case where Pin′ is 1,800 mW, the initialize laser intensity at which the following relation:
|Ref1zoneA−Ref1zoneB|/Ref1zoneAPin≦0.03
is securely satisfied is within a range of from 1,500 to 2,100 mW. Namely, in a case where the laser intensity for the zone A is 1,800 mW, the zone B should be initialized at from 1,500 to 2,100 mW.

Here, in a case where the laser intensity for the zone A is 1,500 mW, zone A >zone B. Thus, it is estimated to be preferred to set the laser intensity for the zone A at 1,800 mW and the laser intensity for the zone B at from 1,800 to 2,100 mW.

### Example 2

(A) Step of Obtaining Recording Medium

As a substrate, a disk-shape polycarbonate substrate having the following shape was employed.

Track pitch: 0.74 μm

Groove width: 0.32 μm

Groove depth: 32 nm

Track shape: spiral

Thickness: 0.6 mm

On this substrate, by sputtering employing an Ar gas, a 60 nm (ZnS)₈₀(SiO₂)₂₀ protective layer, a 2 nm Y₂O₂S layer, a 12 nm Ge_{4.7}In_{10.1}Sb_{50.1}Sn_{21.2}Te_{13.9} recording layer, a 14 nm Y₂O₂S layer, a 2 nm Ta interfacial layer, a 200 nm Ag reflective layer and an about 4 μm ultraviolet-curable resin layer were formed in this order. The Ta layer is an interfacial layer to prevent S from being diffused into the Ag reflective layer.

For deposition of the respective layers, the layers were laminated in order by sputtering without releasing the vacuum. Here, the ultraviolet-curable resin layer was formed by spin coating. Then, the same substrate having a thickness of 0.6 mm having no layer formed thereon, was bonded to the above substrate by means of an adhesive so that the above recording layer side faced inside to obtain a disk (recording medium) having a thickness of 1.2 mm.

For the recording medium, the composition and the layer structure are selected so that overwriting is possible at from about 8× to about 10×speed of the standard linear velocity for DVD of 3.49 m/s (1× speed), in a case where it is used as a rewritable DVD after initial crystallization step. Namely, the upper limit of the linear velocity at which the erase ratio is at least 20 dB at the time of irradiation with an erasing power in a direct current fashion, is from 8× to 10× speed.

In the present Example, a plurality of such recording media were prepared, and initialization was carried out under various initialization conditions, and the performance of the obtained optical information recording media were evaluated.

(B) Initialization Step

The following initialization conditions and initialization method were employed.

(Initialization Conditions)

An elliptic laser beam having a wavelength of 810 nm, a major axis of about 75 μm and a minor axis of about 1 μm was employed as a focused beam. The laser beam intensity at the time of the initialization step was changed within a range of from 1,000 to 4,000 mW. The maximum rotational speed of the initialization device employed was 8,200 rpm.

(Initialization Method)

P-CAV Initialization

Initialization was carried out at a constant rotational speed (R0=8,200 rpm) in zones at inner circumferential side from the innermost circumference, and at a constant linear velocity in zones at outer circumferential side from the radius at which the linear velocity reached 30 m/s.

The scanning linear velocity V (m/s) at the time of initialization can be calculated from the formula:
V(m/s)=(R0/60)×2×3.14×(r/1,000)
where R0 (rpm) is the disk rotational speed, and r (mm) is the radial position for initialization.

Specific initialization linear velocities at the respective radii in the P-CAV initialization are as follows:
19.7 m/s at 23 mm at 8,200 rpm
25.7 m/s at 30 mm at 8,200 rpm
30.0 m/s at 35 mm at 8,200 rpm
30.0 m/s at 40 mm at 7,166 rpm
30.0 m/s at 50 mm at 5,732 rpm
30.0 m/s at 58 mm at 4,942 rpm

The relation between the radial position and the initialization scanning velocity is shown in FIG. 26. In FIG. 26, “CLV” represents the linear velocity at each radial position, and “CAV” represents the rotational speed per unit time at each radial position.

(C) Method of Evaluating Optical Information Recording Medium

(Evaluation Device)

Device: ODU1000 (manufactured by Pulstec Industrial Co., Ltd.)

Focused beam: Laser beam having a wavelength of 650 nm and NA=0.65.

(Evaluation Method)

At a standard linear velocity of 3.49 m/s which is the standard linear velocity for DVD, at a reference clock frequency of 26.2 MHz (reference clock period Tₛ=38.2 ns), recording of EFM+modulation signal was carried out at 6× and 8× speeds, and then the clock jitter was measured at the standard linear velocity.

Here, the clock jitter is a value determined as follows. Namely, retrieving signals are made to pass though an equalizer and an LPF, followed by conversion to binary signals by a slicer. A standard deviation (jitter) of the difference in time against PLL clock of the leading edge and the trailing edge of the binary signals is obtained. The standard deviation is normalized by the clock period T to obtain a clock jitter.

The reflectivity was determined as follows. Namely, the recording waveform recorded by the above method was output to an oscilloscope. The average of the maximum 14T signal amplitude at the standard linear velocity was directly read from the oscilloscope to determine the reflectivity.

(D) Determination of Initialization Conditions

Initialization conditions were determined as follows employing the same method as in Example 1.

Maximum rotational speed R0=8,200 rpm

Initialize power:
CAV area 1,300 to 1,900 mW
CLV area 1,900 mW

In the CAV area, the initialize power was changed to be substantially in proportion with the initialization linear velocity within a range of from 1,300 mW to 1,900 mW.

(E) Measurement of Jitter in P-CAV Initialization

Recording media were initialized under the above initialization conditions, and the jitters after second recording and tenth recording at the above radial positions of from 23 mm to 58 mm at 8× speed were measured, to determine J2/J10.

In a practical commercial drive (drive practically available in the market), 8× speed recording cannot be carried out at the innermost circumference of a recording medium due to the limit of the rotational speed. Accordingly, at positions at 23, 30 and 35 mm among the above radii, the jitters after second recording and tenth recording at 6× speed were measured to determine J2/J10.

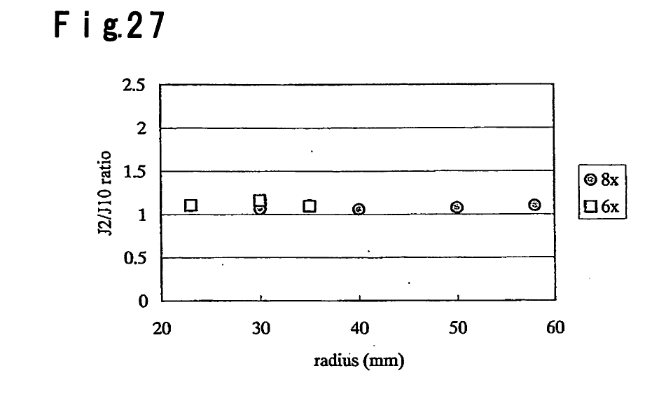

The relation between the radial position and J2/J10 is shown in FIG. 27. From the results shown in the drawing, it is understood that J2/J10≦1.3 at the time of 8× speed recording at all the radial positions and at the time of 6× speed recording at 23, 30 and 35 mm is satisfied under P-CAV initialization conditions set in this Example.

Industrial Applicability

According to the present invention, an advantage is obtained such that an optical information recording medium in a more favorable initially crystallized state can be obtained by an initial crystallization method different from conventional one. Further, the initial crystallization time can be remarkably shortened, whereby productivity of optical information recording media can be improved.

The present invention has been described in detail with reference to specific embodiments, but it should be apparent to those skilled in the art that various changes and modifications can be made without departing from the intention and the scope of the present invention.

The present application is based on a Japanese Patent Application No. 2004-128538 filed on Apr. 23, 2004 and a Japanese Patent Application No. 2004-149455 filed on May 19, 2004 and the entireties are referred by a citation.

What is claimed is:

1. A process for producing an optical information recording medium having a phase-change type recording layer on a disk-shape substrate, which comprises
a step of obtaining a recording medium having the recording layer formed thereon, and
an initial crystallization step of initially crystallizing the recording layer by scanning the recording medium in the circumferential direction with a beam spot formed by irradiating the recording layer with a focused beam,
wherein in the initial crystallization step, the scanning linear velocity when the recording medium is scanned in the circumferential direction with the beam spot, is increased toward the outer circumferential portion of the recording medium, and the intensity of the focused beam is increased as the scanning linear velocity is increased, so that the entire initial crystallization area is initially crystallized.

2. The process for producing an optical information recoding medium according to claim 1, wherein in the initial crystallization step, the rotational speed R0 per unit time of the recording medium is kept constant.

3. The process for producing an optical information recording medium according to claim 2, wherein in the initial crystallization step, the rotational speed R0 is set so as to satisfy the following requirement:
(i) a plurality of recording media are prepared, and one of them is rotated at an optional rotational speed to initially crystallize at least the recording layer formed on the innermost circumferential track in the recording area of the recording medium,
(ii) recording is carried out twice on the innermost circumferential track,
(iii) the jitter J2 of recording marks formed after the second recording is measured,
(iv) recording is further carried out 8 times, and the jitter J10 of recording marks formed after the eighth recording is measured,
(v) on another recording medium, initial crystallization is carried out at a rotational speed different from the rotational speed in the above (i), and then the above operations (ii) to (iv) are carried out,
(vi) the operation (v) is repeated on the other media, and
(vii) the relation between J2/J10 determined from the jitters J2 and J10 obtained from the recording media initially crystallized at the respective rotational speeds, and the rotational speed at the time of initial crystallization, is determined, and the rotational speed R0 is set so that J2/J10 will be at most 1.6.

4. The process for producing an optical information recording medium according to claim 1, wherein in the initial crystallization step, the initial crystallization area is divided into a plurality of zones along the radial direction of the recording medium, the intensity of the focused beam to be applied in each zone is kept constant, and the intensity of the focused beam is increased toward the outer circumferential zone of the recoding medium.

5. The process for producing an optical information recording medium according to claim 1, wherein in the initial crystallization step, the initial crystallization area is divided into a plurality of zones along the radial direction of the recording medium, the rotational speed at the innermost circumferential position in the respective zones is kept constant, and the scanning linear velocity is kept constant from the innermost circumference to the outermost circumference in each zone.

6. The process for producing an optical information recording medium according to claim 5, wherein with respect to adjacent two zones among the plurality of zones, the zone at the inner circumferential side is represented as zone A, the zone at the outer circumferential side is represented as zone B, the focused beam intensity for the zone A is represented as Pin, and the focused beam intensity for the zone B is represented as Pout,
the minimum value of the focused beam intensity Pin for the zone A is represented as Pinmin and the maximum value is represented as Pinmax, and the minimum value of the focused beam intensity Pout for the zone B is represented as Poutmin and the maximum value is represented as Poutmax,
in the zone A, the focused beam intensity Pin is gradually increased toward the outer circumferential side within a range of from Pinmin to Pinmax, and the value of the focused beam intensity Pin at the outermost circumference of the zone A is employed as PinzoneAout, and
in the zone B, the focused beam intensity Pout is gradually increased toward the outer circumferential side within a range of from Poutmin to Poutmax, and the value of the focused beam intensity Pout at the innermost circumference of the zone B is employed as PoutzoneBin, and in such a case, the relation between PoutzoneBin and PinzoneAout satisfies:
PoutzoneBin=PinzoneAout.

7. The process for producing an optical information recording medium according to claim 5, wherein with respect to adjacent two zones among the plurality of zones, the zone at the inner circumferential side is represented as zone A, the zone at the outer circumferential side is represented as zone B, the focused beam intensity for the zone A is represented as Pin, and the focused beam intensity for the zone B is represented as Pout,
the minimum value of the focused beam intensity Pin for the zone A is represented as Pinmin and the maximum value is represented as Pinmax, and the minimum value of the focused beam intensity Pout for the zone B is represented as Poutmin and the maximum value is represented as Poutmax,
in the zone A, the focused beam intensity Pin is gradually increased toward the outer circumferential side within a range of from Pinmin to Pinmax, and the value of the focused beam intensity Pin at the outermost circumference of the zone A is employed as PinzoneAout, and
in the zone B, the focused beam intensity Pout is gradually increased toward the outer circumferential side within a range of from Poutmin to Poutmax, and the value of the focused beam intensity Pout at the innermost circumference of the zone B is employed as PoutzoneBin,
and in such a case, the relation between PoutzoneBin and PinzoneAout satisfies:
PoutzoneBin>PinzoneAout
and the difference between PoutzoneBin and PinzoneAout is smallest.

8. The process for producing an optical information recording medium according to claim 1, wherein in the initial crystallization step, the rotational speed R0 per unit time of the recording medium is kept constant from the innermost circumferential position in the initial crystallization area of the recording medium toward the outer circumferential side of the recording medium to a predetermined radial direction position, and the scanning linear velocity is kept constant from the predetermined radial direction position to the outermost circumferential position in the initial crystallization area.

9. The process for producing an optical information recording medium according to claim 8, wherein in the initial crystallization step, the linear velocity at the predetermined radial direction position is the maximum linear velocity Vmax, and the maximum linear velocity Vmax is set so as to satisfy the following requirement:
(i) the recording layer formed on an optional track in the initial crystallization area is initially crystallized at an optional linear velocity,
(ii) recording is carried out twice on the above track,
(iii) the jitter J2 of recording marks formed after the second recording is measured,
(iv) recording is further carried out 8 times, and the jitter J10 of recording marks formed after the eighth recording is measured,
(v) the above operations (i) to (iv) are repeated by changing the linear velocity, and
(vi) the linear velocity at which J2/J10 determined from the jitters J2 and J10 obtained at the respective linear velocities will be at most 1.6, is taken as the maximum linear velocity Vmax.

10. The process for producing an optical information recording medium according to claim 1, wherein the focused beam is a laser beam.

11. The process for producing an optical information recording medium according to claim 1, wherein in the initial crystallization step, the maximum linear velocity employed for initial crystallization of the recording layer, is at least the maximum linear velocity at which amorphous recording marks to be formed on the optical information recording medium can be erased.

12. An initialization device for initially crystallizing a phase-change type recording layer of a recording medium having the recording layer formed on a disk-shape substrate, characterized in that it is equipped with a controller to scan the recording medium in the circumferential direction with a beam spot formed by irradiating the recording layer with a focused beam, and the controller is constituted in such a manner that the linear velocity when the recording medium is scanned in the circumferential direction with the beam spot is increased toward the outer circumferential portion of the recording medium, and the intensity of the focused beam is increased as the scanning linear velocity is increased, so that the entire initial crystallization area is initially crystallized.

13. The initialization device according to claim 12, wherein the controller is constituted so that the rotational speed R0 per unit time of the recording medium is kept constant.

14. The initialization device according to claim 13, wherein the controller is constituted to rotate the recoding medium based on the rotational speed R0 set to satisfy the following requirement:
(i) a plurality of recording media are prepared, and one of them is rotated at an optional rotational speed to initially crystallize at least the recording layer formed on the innermost circumferential track in the recording area of the recording medium,
(ii) recording is carried out twice on the innermost circumferential track,
(iii) the jitter J2 of recording marks formed after the second recording is measured,
(iv) recording is further carried out 8 times, and the jitter J10 of recording marks formed after the eighth recording is measured,
(v) on another recording medium, initial crystallization is carried out at a rotational speed different from the rotational speed in the above (i), and then the above operations (ii) to (iv) are carried out,
(vi) the operation (v) is repeated on the other media, and
(vii) the relation between J2/J10 determined from the jitters J2 and J10 obtained from the recording media initially crystallized at the respective rotational speeds, and the rotational speed at the time of initial crystallization, is determined, and the rotational speed R0 is set so that J2/J10 will be at most 1.6.

15. The initialization device according to claim 12, wherein the initial crystallization area is divided into a plurality of zones along the radial direction of the recording medium, and the controller is constituted so that the intensity of the focused beam to be applied in each zone is kept constant, and that the intensity of the focused beam is increased toward the outer circumferential zone of the recoding medium.

16. The initialization device according to claim 12, wherein the initial crystallization area is divided into a plurality of zones along the radial direction of the recording medium, and the controller is constituted so that the rotational speed at the innermost circumferential position in the respective zones is kept constant, and that the scanning linear velocity is kept constant from the innermost circumference to the outermost circumference in each zone.

17. The initialization device according to claim 16, wherein the controller is constituted so as to control the intensity of the focused beam based on the intensity of the focused beam set to satisfy the following requirement:
with respect to adjacent two zones among the plurality of zones, the zone at the inner circumferential side is represented as zone A, the zone at the outer circumferential side is represented as zone B, the focused beam intensity for the zone A is represented as Pin, and the focused beam intensity for the zone B is represented as Pout,
the minimum value of the focused beam intensity Pin for the zone A is represented as Pinmin and the maximum value is represented as Pinmax, and the minimum value of the focused beam intensity Pout for the zone B is represented as Poutmin and the maximum value is represented as Poutmax,
in the zone A, the focused beam intensity Pin is gradually increased toward the outer circumferential side within a range of from Pinmin to Pinmax, and the value of the focused beam intensity Pin at the outermost circumference of the zone A is employed as PinzoneAout, and
in the zone B, the focused beam intensity Pout is gradually increased toward the outer circumferential side within a range of from Poutmin to Poutmax, and the value of the focused beam intensity Pout at the innermost circumference of the zone B is employed as PoutzoneBin, and in such a case, the relation between PoutzoneBin and PinzoneAout satisfies:
PoutzoneBin=PinzoneAout.

18. The initialization device according to claim 16, wherein the controller is constituted so as to control the intensity of the focused beam based on the intensity of the focused beam set to satisfy the following requirement:
with respect to adjacent two zones among the plurality of zones, the zone at the inner circumferential side is represented as zone A, the zone at the outer circumferential side is represented as zone B, the focused beam intensity for the zone A is represented as Pin, and the focused beam intensity for the zone B is represented as Pout,
the minimum value of the focused beam intensity Pin for the zone A is represented as Pinmin and the maximum value is represented as Pinmax, and the minimum value of the focused beam intensity Pout for the zone B is represented as Poutmin and the maximum value is represented as Poutmax,
in the zone A, the focused beam intensity Pin is gradually increased toward the outer circumferential side within a range of from Pinmin to Pinmax, and the value of the focused beam intensity Pin at the outermost circumference of the zone A is employed as PinzoneAout, and
in the zone B, the focused beam intensity Pout is gradually increased toward the outer circumferential side within a range of from Poutmin to Poutmax, and the value of the focused beam intensity Pout at the innermost circumference of the zone B is employed as PoutzoneBin, and in such a case, the relation between PoutzoneBin and PinzoneAout satisfies:
PoutzoneBin>PinzoneAout
and the difference between PoutzoneBin and PinzoneAout is smallest.

19. The initialization device according to claim 12, wherein the controller is constituted so that the rotational speed R0 per unit time of the recording medium is kept constant from the innermost circumferential position in the initial crystallization area of the recording medium toward the outer circumferential side of the recording medium to a predetermined radial direction position, and the scanning linear velocity is kept constant from the predetermined radial direction position to the outermost circumferential position in the initial crystallization area.

20. The initialization device according to claim 19, wherein the maximum linear velocity Vmax at the predetermined radial direction position is set so as to satisfy the following requirement:
(i) the recording layer formed on an optional track in the initial crystallization area is initially crystallized at an optional linear velocity,
(ii) recording is carried out twice on the above track,
(iii) the jitter J2 of recording marks formed after the second recording is measured,
(iv) recording is further carried out 8 times, and the jitter J10 of recording marks formed after the eighth recording is measured,
(v) the above operations (i) to (iv) are repeated by changing the linear velocity, and
(vi) the linear velocity at which J2/J10 determined from the jitters J2 and J10 obtained at the respective linear velocities will be at most 1.6, is taken as the maximum linear velocity Vmax.

21. The initialization device according to claim 12, wherein the focused beam is a laser beam.
